(19) United States
(12) Patent Application Publication
(10) Pub. No.: US 2023/0211288 A1
(43) Pub. Date: Jul. 6, 2023

(54) ANTIMICROBIAL FILTRATION

(71) Applicant: The University of Toledo, Toledo, OH (US)

(72) Inventors: John A. Setlock, Toledo, OH (US); Brad Zmuda, Toledo, OH (US); Carley N. Pawliski, Toledo, OH (US); Skyla J. Gongaware, Toledo, OH (US); Krystal Nelson, Toledo, OH (US)

(73) Assignee: The University of Toledo, Toledo, OH (US)

(21) Appl. No.: 18/093,057

(22) Filed: Jan. 4, 2023

Related U.S. Application Data
(60) Provisional application No. 63/296,637, filed on Jan. 5, 2022.

(51) Int. Cl. B01D 53/94; B01J 23/42; B01J 35/10; B01J 37/02; B01J 37/08

(52) U.S. Cl. CPC B01D 53/94; B01J 23/42; B01J 35/1009; B01J 35/1014; B01J 37/0215; B01J 37/0236; B01J 37/088; B01D 2255/1021; B01D 2255/9207

(57) ABSTRACT

Antimicrobial metallic foams useful in filters, methods of making and using the same, and antimicrobial filters, systems, and articles are described.

### RELATED APPLICATIONS

This application claims priority to U.S. Provisional Application No. 63/296,637, filed under 35 U.S.C. § 111(b) on Jan. 5, 2022, the disclosure of which is incorporated herein by reference in its entirety for all purposes.

### STATEMENT REGARDING FEDERALLY SPONSORED RESEARCH

This invention was made with no government support. The government has no rights in this invention.

### BACKGROUND

Due to the global COVID-19 pandemic, public health safety has renewed importance. In particular, improved air filtration and personal protection equipment (PPE) have been widely desired due to the virus transmitting when people breathe in air contaminated by drops and small airborne particles. Other health safety concerns can include other harmful airborne microorganisms, such as bacteria, viruses, and fungi. Proposed solutions, such as air filtration systems and face masks, while effective, have several issues. For example, some filters and fabrics only “capture” harmful microorganisms. Undesirably, this can lead to a buildup of harmful microorganisms on filters for air filtration systems and fabrics for PPE. In addition, traditional solutions can be expensive due to requiring a large amount of expensive materials. Accordingly, there is a continuing need for new, improved, and cost efficient antimicrobial filtration applications and methods for capturing and deactivating harmful microorganisms.

### SUMMARY

Provided is a method of preparing a catalyst, the method comprising contacting a metal salt or a solution comprising the metal salt with a reducing agent comprising corn syrup to produce a reaction mixture, optionally boiling at least some liquid off the reaction mixture to alter the viscosity of the reaction mixture, applying the reaction mixture to a substrate to produce a coated or infiltrated substrate, heating the coated or infiltrated substrate to a temperature of at least about 200° C. for a period of time to produce a metal catalyst.

In certain embodiments, the metal salt comprises hexachloroplatinate or a nitrate salt. In certain embodiments, the solution is prepared by dissolving the metal in aqua regia. In certain embodiments, the solution comprises methanol. In particular embodiments, the metal is platinum. In certain embodiments, the metal comprises platinum, palladium, silver, gold, nickel, copper, or alloys or mixtures thereof. In certain embodiments, the metal consists essentially of platinum. In certain embodiments, the metal is not silver.

In certain embodiments, the metal catalyst comprises two or more metals. In certain embodiments, the metal catalyst further comprises at least one oxide. In particular embodiments, the oxide comprises cerium oxide, gadolinium oxide, or yttria stabilized zirconia. In certain embodiments, the metal catalyst comprises a mixture of two or more catalyst materials selected from the group consisting of platinum, palladium, nickel, silver, cerium oxide, gadolinium oxide, and yttria stabilized zirconia. In certain embodiments, the metal catalyst comprises Ni-doped yttria stabilized zirconia. In certain embodiments, the metal catalyst comprises a cermet.

In certain embodiments, the corn syrup is light corn syrup. In certain embodiments, the corn syrup is dark corn syrup. In certain embodiments, the corn syrup comprises a mixture of light corn syrup and dark corn syrup. In certain embodiments, the corn syrup further includes one or more of flavorings, salt, molasses, Refiner's syrup, colorings, and preservatives. In certain embodiments, the corn syrup does not consist of dextrose.

In certain embodiments, the period of time ranges from about 5 minutes to about 30 minutes. In certain embodiments, the period of time is about 15 minutes.

In certain embodiments, the coated or infiltrated substrate is allowed to dry for a second period of time prior to the heating. In particular embodiments, the coated or infiltrated substrate is allowed to dry for about 2 hours at a temperature of about 80° C.

In certain embodiments, the metal catalyst comprises a metal foam having a surface area of at least about 5 m²/g. In certain embodiments, the metal catalyst comprises a metal foam having a surface area of at least about 8 m²/g. In certain embodiments, the metal catalyst comprises a metal foam having a surface area of at least about 10 m²/g.

In certain embodiments, the metal catalyst is allowed to cool.

In certain embodiments, the substrate comprises a metal, an alloy, a plastic, or a ceramic. In certain embodiments, the substrate comprises a solid electrolyte. In certain embodiments, the substrate comprises a ceramic material having a honeycomb structure. In certain embodiments, the substrate is porous, and the precursor solution infiltrate the pores of the substrate.

In certain embodiments, the method further comprises using the metal catalyst in a fuel cell or a catalytic converter. In particular embodiments, the fuel cell is a polymer electrolyte membrane fuel cell (PEMFC). In particular embodiments, the fuel cell is a solid oxide fuel cell (SOFC). In particular embodiments, the fuel cell is a solid oxide electrolyzer cell (SOEC).

In certain embodiments, the method further comprises heating the metal catalyst in a reducing atmosphere in order to reduce oxides to metal. In particular embodiments, the reducing atmosphere comprises about 5% hydrogen and about 95% nitrogen.

Further provided is a metal catalyst made by the method described herein. Further provided are fuels cells comprising the metal catalyst, and catalytic converters comprising the metal catalyst.

Further provided is a kit for making a catalyst, the kit comprising a first container housing corn syrup, and a second container housing a source of metal. In certain embodiments, the kit further comprises a substrate. In certain embodiments, the kit comprises a metal precursor solution.

Further provided is a method of preparing a catalyst, the method comprising contacting a metal salt or a solution comprising the metal salt with a reducing agent comprising a mixture of two or more sugars to produce a reaction mixture, optionally boiling at least some liquid off the reaction mixture to alter the viscosity of the reaction mixture, applying the reaction mixture to a substrate to produce a coated or infiltrated substrate, and heating the coated or infiltrated substrate to a temperature of at least about 300° C. for a period of time to produce a metal catalyst. In certain embodiments, the mixture of two or more sugars comprises a mixture of dextrose and cane sugar. In particular embodiments, the mixture comprises about 20% dextrose. In particular embodiments, the mixture comprises about 50% dextrose.

Further provided is a filter comprising an antimicrobial metallic foam on a substrate, wherein the antimicrobial metallic foam is capable of deactivating microorganisms.

In certain embodiments, the antimicrobial metallic foam comprises silver. In certain embodiments, the antimicrobial metallic foam includes a metal selected from the group consisting of copper, silver, and a combination thereof. In certain embodiments, the antimicrobial metallic foam includes a metal selected from the group consisting of cadmium, cobalt, iron, manganese, platinum, titanium, aluminum, antimony, arsenic, barium, bismuth, boron, copper, gold, lead, mercury, nickel, silver, thallium, tin, zinc, and combinations thereof. In certain embodiments, the antimicrobial metallic foam includes a metal alloy. In particular embodiments, the metal alloy is selected from a group consisting of brass, bronze, and a combination thereof.

In certain embodiments, the antimicrobial metallic foam includes a metal oxide. In particular embodiments, the metal oxide comprises a copper oxide or a silver oxide.

In certain embodiments, the substrate is a fluid permeable substrate. In particular embodiments, the fluid permeable substrate is configured to allow at least 50% of fluid to pass through the fluid permeable substrate. In particular embodiments, the fluid permeable substrate is configured to allow at least 75% of fluid to pass through the fluid permeable substrate. In particular embodiments, the fluid permeable substrate is configured to allow at least 85% of fluid to pass through the fluid permeable substrate. In particular embodiments, the fluid permeable substrate is configured to allow at least 95% of fluid to pass through the fluid permeable substrate.

In certain embodiments, the substrate comprises fiberglass. In certain embodiments, the substrate comprises a fabric. In certain embodiments, the substrate comprises activated carbon. In certain embodiments, the substrate is coated or infiltrated with the antimicrobial metallic foam.

In certain embodiments, the filter is an air filter configured for use in an air filtration system. In certain embodiments, the filter is a cassette configured to use in personal protection equipment. In certain embodiments, the filter is a layer in a multilayer cassette filter. In certain embodiments, the filter is in a facemask.

Further provided is a method of preparing an antimicrobial filter, the method comprising applying a metallic precursor to a fluid permeable substrate to produce a coated or infiltrated substrate; and heating the coated or infiltrated substrate to transform the metallic precursor into an antimicrobial metallic foam, thereby forming an antimicrobial filter.

In certain embodiments, the metallic precursor comprises silver nitrate. In certain embodiments, the metallic precursor comprises copper nitrate.

In certain embodiments, the method further comprises diluting the metallic precursor with a diluting agent. In particular embodiments, the diluting agent comprises methanol.

In certain embodiments, the fluid permeable substrate comprises a fabric, fiberglass, or activated carbon.

Further provided is an antimicrobial filter comprising an antimicrobial metallic foam on a fluid permeable substrate, wherein the antimicrobial metallic foam comprises silver or copper. In certain embodiments, the antimicrobial metallic foam consists essentially of silver or copper.

Further provided is an antimicrobial metallic foam comprising silver foam made by a process of reacting a silver nitrate precursor with a reducing agent comprising corn syrup.

Further provided is an antimicrobial metallic foam comprising copper foam made by a process of reacting a copper nitrate precursor with a reducing agent comprising corn syrup.

Further provided is a facemask comprising a cassette filter with an antimicrobial metallic foam, wherein the cassette filter comprises an activated carbon layer configured to filter volatile organic compounds and having a coating of the antimicrobial metallic foam thereon; and a plurality of other layers. In certain embodiments, the coating is homogeneously applied on the activated carbon layer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1B: Flow chart (FIG. 1A) and pictorial flow chart (FIG. 1B) of non-limiting example embodiments of a method for making a metal catalyst.

FIG. 2: Photograph of a foaming reaction mixture.

FIGS. 3A-3E: SEM images of platinum foam at 275× (FIGS. 3A-3B), 200× (FIG. 3C), 840× (FIG. 3D), and 800× (FIG. 3E) magnification.

FIGS. 4A-4B: Photographs of platinum foam at 20× (FIG. 4A) and no (FIG. 4B) magnification, clearly showing the porous structure of the foam.

FIGS. 5A-5B: SEM images at higher magnification (4900× (FIG. 5A) and 6600× (FIG. 5A) magnification), showing the porous nanostructure of the platinum foam.

FIGS. 6A-6G: SEM image of a freeze-cast structure infiltrated with a platinum precursor solution; 200× (FIG. 6B); 500× (FIG. 6C); 1000× (FIG. 6D); 1000× (FIG. 6E); 5000× (FIG. 6F); and 10,000× (FIG. 6G).

FIGS. 7A-7B: Schematic illustrations of non-limiting example devices that the catalyst material can be used in, namely a proton-exchange membrane fuel cell (FIG. 7A) and a catalytic converter (FIG. 7B).

FIGS. 8A-8B: Photographs, after being heated but prior to full conversion (FIG. 8A) and after full conversion (FIG. 8B), of reaction mixtures made with corn syrup (left in each photograph) and reactions mixtures made with dextrose alone as the reducing agent (right in each photograph).

FIGS. 9A-9B: Isotherm linear plot (FIG. 9A) and isotherm tabular report (FIG. 9B) from a first sample of platinum foam.

FIGS. 10A-10B: BET surface area plot (FIG. 10A) of a sample of platinum foam having a BET surface area of 9.5076 m²/g, and BET data from the sample in table form (FIG. 10B).

FIGS. 11A-11B: Isotherm linear plot (FIG. 11A) and isotherm tabular report (FIG. 11B) from a first sample of platinum foam.

FIGS. 12A-12B: BET surface area plot (FIG. 12A) of a sample of platinum foam having a BET surface area of 10.1806 m²/g, and BET data from the sample in table form (FIG. 12B).

FIGS. 13A-13B: SEM image of platinum foam created from reaction with corn syrup as the reducing agent, at 5300× magnification (FIG. 13A), and optical image of the same (FIG. 13B), showing the bright and shiny appearance of the platinum foam.

FIGS. 14A-14B: SEM image of platinum foam created from reaction with a mixture of 20% dextrose 80% cane sugar as the reducing agent, at 4700× magnification (FIG. 14A), and optical image of the same (FIG. 14B), showing the dull grey appearance of the product.

FIGS. 15A-15B: SEM image of platinum foam created from reaction with a mixture of 50% dextrose and 50% cane sugar as the reducing agent, at 4700× magnification (FIG. 15A), and optical image of the same (FIG. 15B), showing the dull grey appearance of the product.

FIG. 16: Photograph showing different metals that are easily converted to porous metal.

FIG. 17: Photograph showing metal foams supported by substrates.

FIGS. 18A-18B: An example of a facemask having a cassette filter (FIG. 18A), and an example of a cassette filter composed of multiple layers that include an activated carbon layer with a coating of an antimicrobial metallic foam thereon (FIG. 18B).

FIGS. 19A-19B: Illustration of a non-limiting example HVAC system having an air filter (FIG. 19A), and an illustration of a non-limiting example substrate coated with the antimicrobial metallic foam for the air filter (FIG. 19B).

FIGS. 20A-20C: Photographs showing copper precursors (FIG. 20A), the copper precursors actively decomposing into copper foams (FIG. 20B), and the copper foams after examination of strength (FIG. 20C) employed in a copper mix test.

FIGS. 21A-21D: Photographs showing silver precursors (FIG. 21A), the silver precursors during evaporation (FIG. 21B), the silver precursors actively decomposing into silver foams (FIG. 21C), and the silver foams with their approximate autoignition temperature (FIG. 21D) employed in a silver mix test.

FIG. 22A-22C: Photographs showing copper and silver foams (FIG. 22A), 24-hour growth rate of plates (from left to right, top row, Control 1, Cu1.5, Ag1.5, Control 2, Cu2, and Ag3) (FIG. 22B), and 48-hour growth rate of the plates (from left to right, top row, Control 1, Cu1.5, Ag1.5, Control 2, Cu2, and Ag3) (FIG. 22C) employed in a first zone of inhibition (ZOI) experiment.

FIGS. 23A-23C: Photographs showing new silver foams (FIG. 23A), 24-hour growth rate of plates (from left to right, top row, Ag3 #1 (first batch), Ag3 #1 (second batch), Control 1, Ag3 #2 (first batch), Ag3 #2 (second batch), and Control 2) (FIG. 23B), and 48-hour growth rate of plates (from left to right, top row, Ag3 #1 (first batch), Ag3 #1 (second batch), Control 1, Ag3 #2 (first batch), Ag3 #2 (second batch), and Control 2 (FIG. 23C) employed in a second ZOI experiment.

FIGS. 24A-24C: Tables showing silver concentration mixes (FIG. 24A), corn syrup mixes (FIG. 24B), and methanol mixes (FIG. 24C), employed in a micro recipe testing and fiberglass infiltration experiment.

FIGS. 25A-25G: Photographs showing silver foam mixes on a plate (FIG. 25A) and fiberglass samples (approximately 1 inch, square) infiltrated with 200 μL of precursor mix, including M1 (FIG. 25B), M2 (FIG. 25C), M3 (FIG. 25D), MS (FIG. 25E), M7 (FIG. 25F), and M9 (FIG. 25G), employed in the micro recipe testing and fiberglass infiltration experiment.

FIGS. 26A-26C: SEM images showing silver foam at 8300× magnification (FIG. 26A), at 1150× magnification (FIG. 26B), and 310× magnification (FIG. 26C) employed in the micro recipe testing and fiberglass infiltration experiment.

FIGS. 27A-27C: SEM images showing infiltrated fiberglass at 5000× magnification (FIG. 27A), 830× magnification (FIG. 27B), and 280× magnification (FIG. 27C) employed in the micro recipe testing and fiberglass infiltration experiment.

FIGS. 28A-28B: Photographs showing 24-hour growth rate of plates (from left to right, top row, 1, 3, 5, 7, 9, 10, 2, 4, 6, 8, 11) (FIG. 28A) and 48-hour growth rate of plates (from left to right, top row, 1, 3, 5, 7, 10, 2, 4, 6, 8, 9, 11) (FIG. 28B) employed in a third ZOI experiment.

FIGS. 29A-29E: Photographs showing 48-hour growth rate of a M3 mix (from left to right, top row, 1, 2, 3, and 4) (FIG. 29A), the 48-hour growth rate of the M3 mix (from left to right, top row, 5, 6, 7, and 8) (FIG. 29B), the 48-hour growth rate of a M9 mix (from left to right, top row, 9, 10, 11, and 12) (FIG. 29C), the 48-hour growth rate of the M9 mix (from left to right, top row, 13, 14, 15, and 16) (FIG. 29D), and the 48-hour growth rate of the M9 mix (from top to bottom, 17 and 18) (FIG. 29E) employed in a contact stamping experiment.

FIGS. 30A-30C: Photographs showing an HVAC simulation system in a chemical fume hood (FIG. 30A), 24-hour growth rate of plates (from left to right, top row, 1, 2, 3, 4, 5, 6, 7, 8C, 9C, 10C, 11C, 12C, and 13C) (FIG. 30B), and 48-hour growth rate of plates (from left to right, top row, 1, 2, 3, 4, 5, 6, 7, 8C, 9C, 10C, 11C, 12C, and 13C) (FIG. 30C) employed in a first airflow experiment.

FIGS. 31A-31F: Photographs showing an HVAC simulation system in a biosafety cabinet (FIG. 31A), the HVAC simulation system with a filter intake cartridge disconnected and showing a dual layer silver filter within (FIG. 31B), 24-hour growth rate of plates (from left to right, top row, 1, 2, 3, 4, 5, 6, 7, 8C, 9C, 10C, 11C, 12C, 13C, and 14C) (FIG. 31C), 48-hour growth rate of plates (from left to right, top row, 1, 2, 3, 4, 5, 6, 7, 8C, 9C, 10C, 11C, 12C, 13C, and 14C) (FIG. 31D), 48-hour growth rate of plates (from left to right, 10C and 14C) (FIG. 31E), and 48-growth rate of plates (from left to right, 10C and 14C) (FIG. 31F) employed in a second airflow experiment.

FIGS. 32A-32F: Photographs showing 24-hour growth rate of SW plate (FIG. 32A), 24-hour growth rate of SK plate (FIG. 32B), 24-hour growth rate of C plate (FIG. 32C), 48-hour growth rate of SW plate (FIG. 32D), 48-hour growth rate of SK plate (FIG. 32E), and 48-hour growth rate of C plate (FIG. 32F) employed in a swab method testing experiment.

FIGS. 33A-33G: Photographs showing the HVAC simulation system in the biosafety cabinet (FIG. 33A), a diluted M9 (1:4) silver precursor (FIG. 33B), a single layer of a silver-infiltrated fiberglass filter (FIG. 33C), 24-hour growth rate of plates (from left to right, top row, 1A, 1B, 2, 3, 4, 5, 6, 7, 8C, 9C, 10C, 11C, 12C, 13C, and 14C) (FIG. 33D), 48-hour growth rate of plates (from left to right, top row, 1A, 1B, 2, 3, 4, 5, 6, 7, 8C, 9C, 10C, 11C, 12C, 13C, and 14C) (FIG. 33E), 48-growth rate of plates (from left to right, 10C and 14C) (FIG. 33F), and 48-growth rate of plates (from left to right 10C and 14C) (FIG. 33G) employed in a third airflow experiment.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Described herein is a method for preparing a high surface-area metal foam, such as a platinum catalyst or an antimicrobial metallic foam, and the catalysts and foams made thereby. Very porous, high surface area metal foams can be created and used as catalysts or in filters, among other things. In general, the metal starts out in a liquid solution containing metal salts such as hexachloroplatinate or a nitrate salt. Then, a reducing agent, such as corn syrup, is added to the solution. Alternatively, the reducing agent is added to a solid metal precursor to create a solution. Optionally, excess liquids are boiled off to produce the desired viscosity. The resulting solution is then painted, dipped, or infiltrated onto or into a surface or other substrate which is to be coated with a high surface area metal foam. The coated and/or infiltrated substrate can be left to dry for a period of time before heating or, alternatively, immediately heated. It is to be understood that in some embodiments, the substrate will have an external coating, while in other embodiments, the substrate can have an at least partial internal coating, or infiltration, of the substrate. As used herein, the term “coating” is understood to include the external coating, the internal/infiltrate coating, or both the external and internal/infiltrate coating.

As the substrate is heated, the viscous coating/infiltrate starts to foam, and then decomposes to a metal at a temperature generally between about 200° C. and about 250° C., depending on the makeup of the metal. The resulting metal is a foam with a high surface area that is useful, for example, as a catalyst or for antimicrobial filtration purposes.

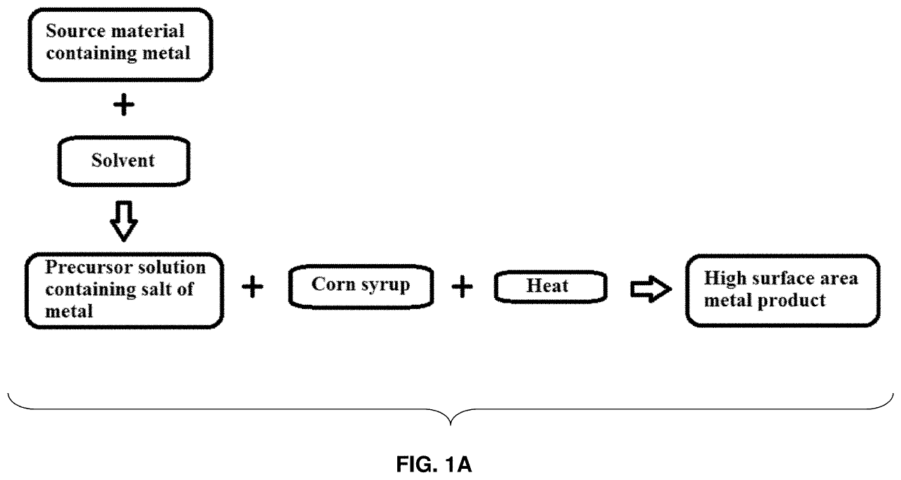

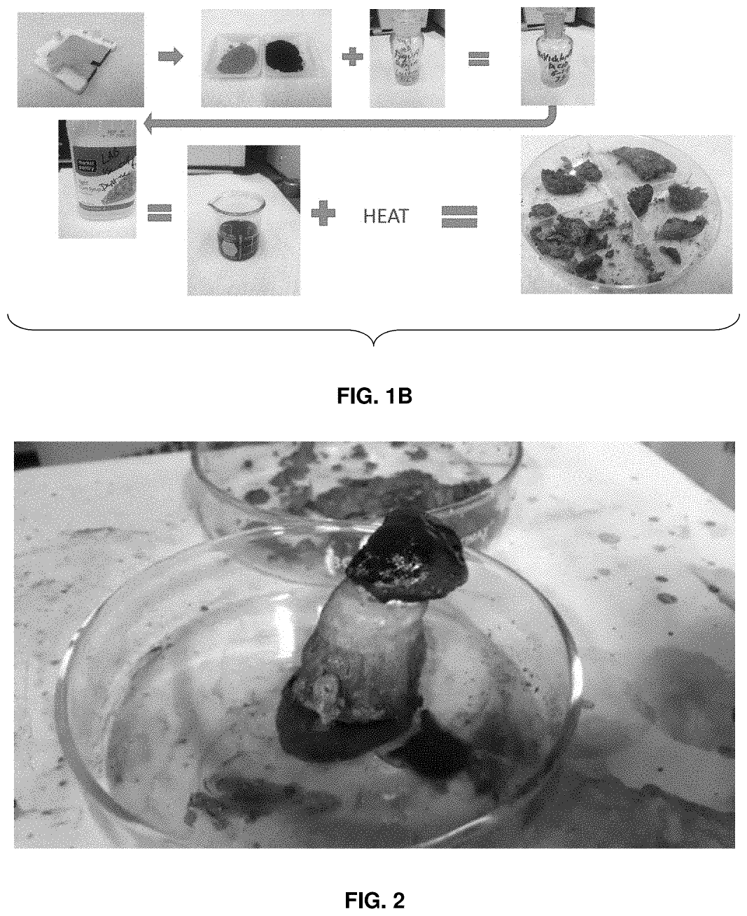

A pictorial flow chart of a non-limiting embodiment of a method for making a metal foam is shown in FIG. 1A, and FIG. 1B shows a flowchart with photographs. As shown in FIG. 1B, the source material can be recycled material containing the metal, such as a mixture of the metal with other compounds. This recycled material can be dissolved in a suitable solvent, such as aqua regia, to create a precursor solution that contains a salt of the metal. For example, the metal may be platinum, and the solution may contain hexachloroplatinate. Though aqua regia is mentioned for exemplary purposes, a wide variety of combinations or other solvents can be used to tailor the process to the desired outcome. The reducing agent is added to the precursor solution, and the resulting reaction mixture is applied to a substrate and then heated to produce a metal foam, such as platinum foam or silver foam. Alternatively, the reducing agent is added directly to a solid metal precursor, such as dihydrogen hexachloroplatinate hexahydrate, to form a reaction mixture which is applied to a substrate and then foams upon heating to produce a high surface area metal foam.

FIG. 2 is a photograph showing an example of the foaming reaction mixture prior to auto ignition.

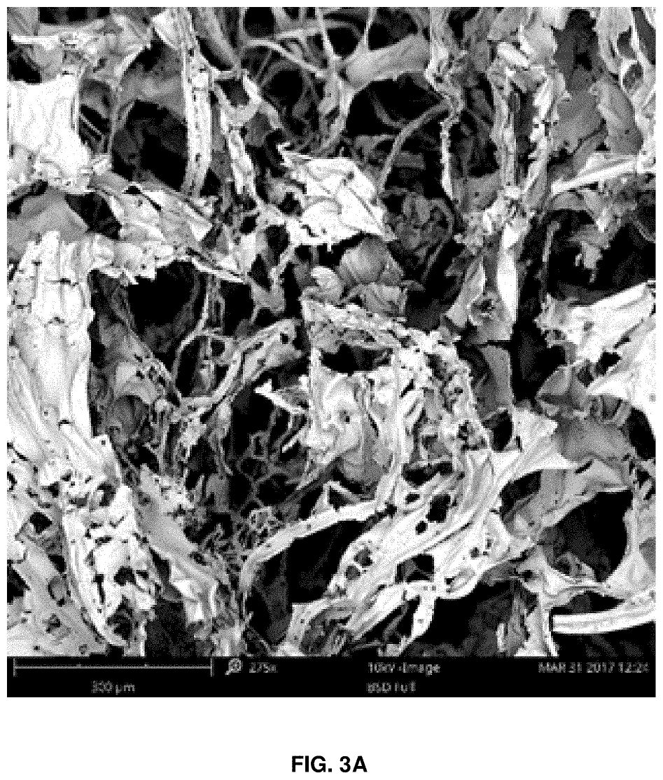

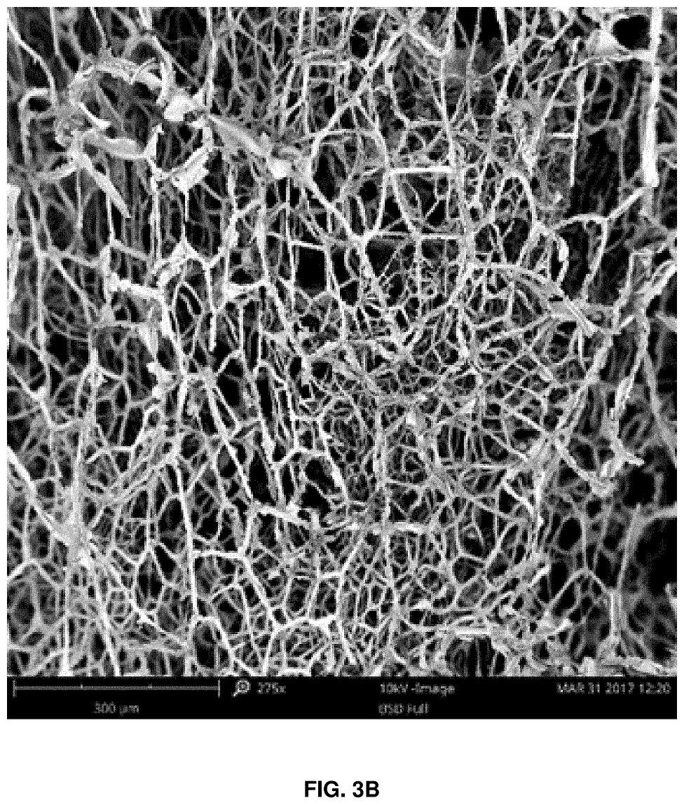

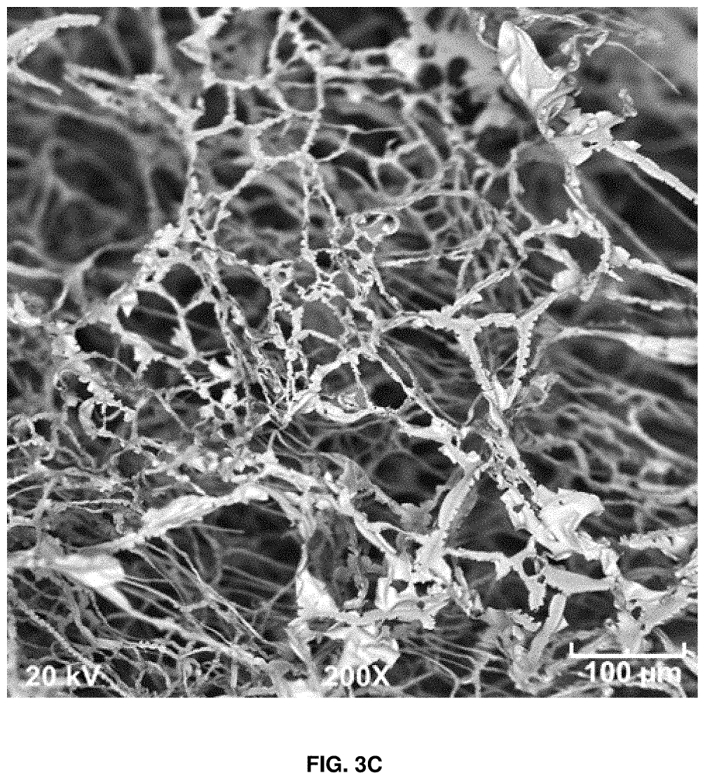

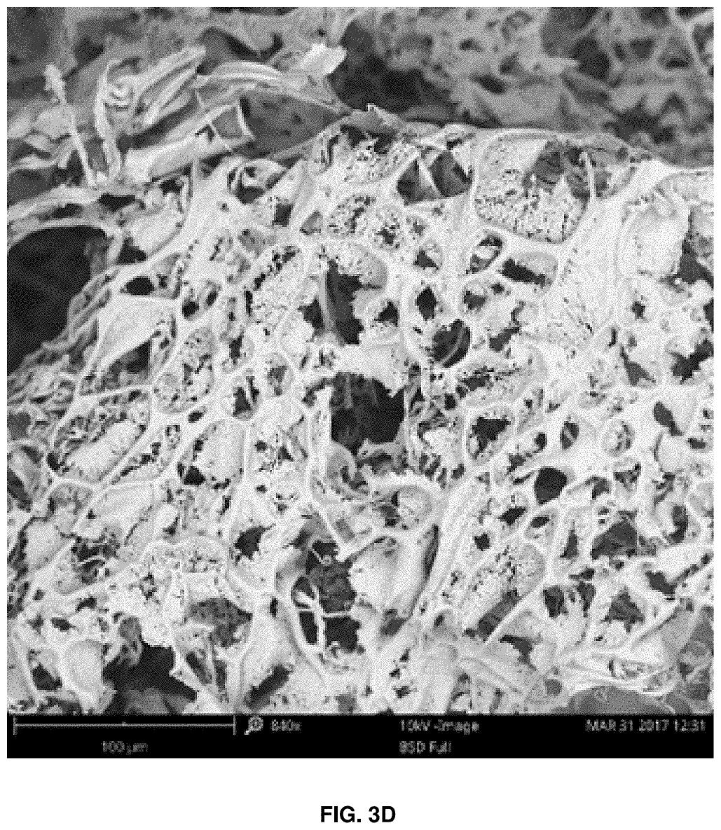

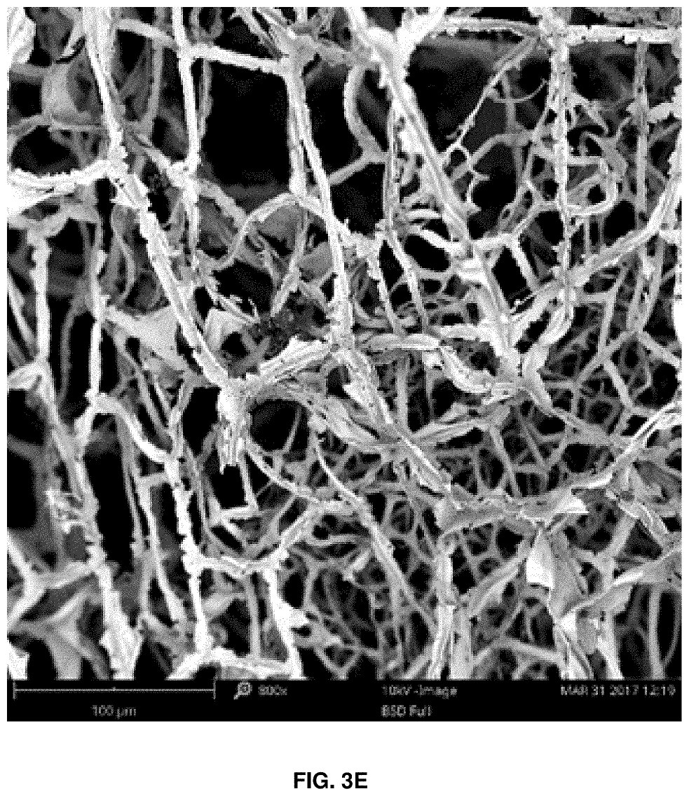

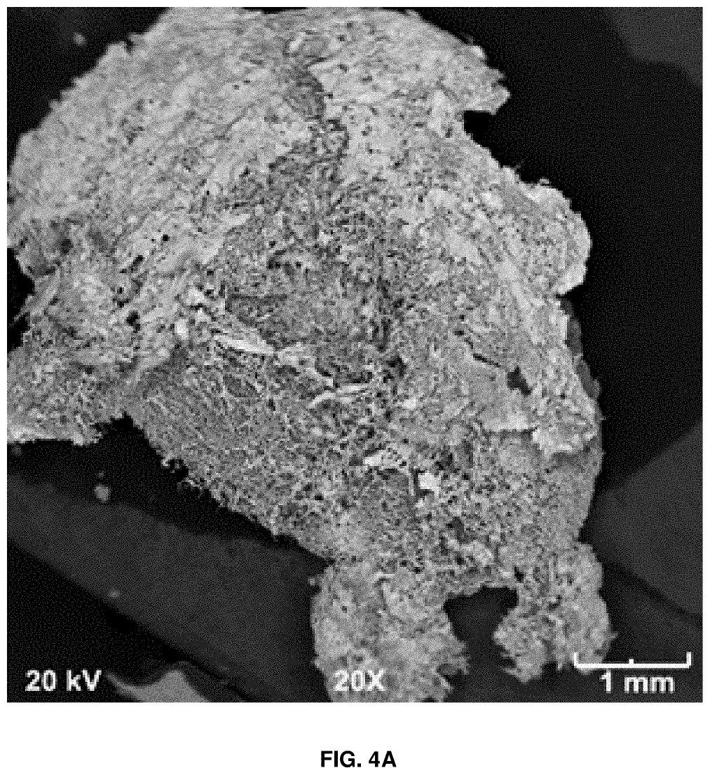

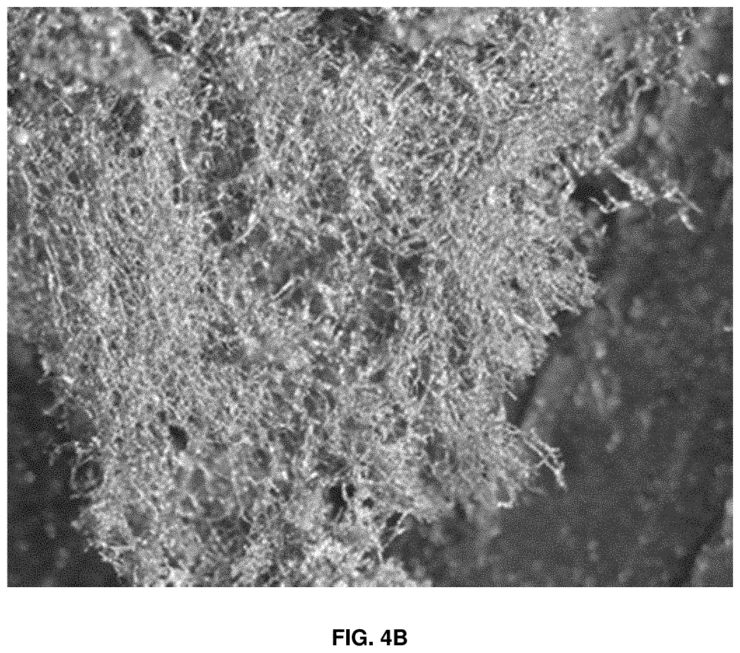

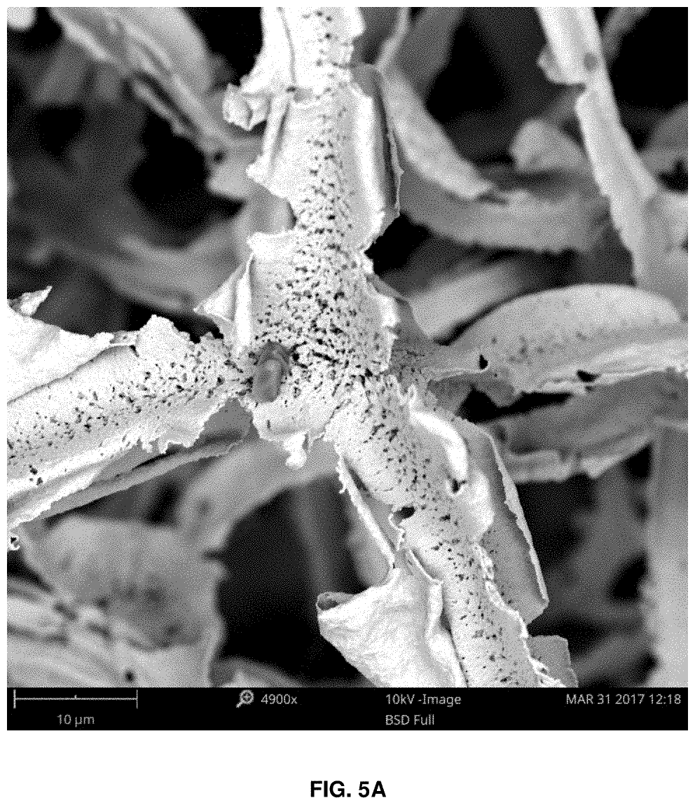

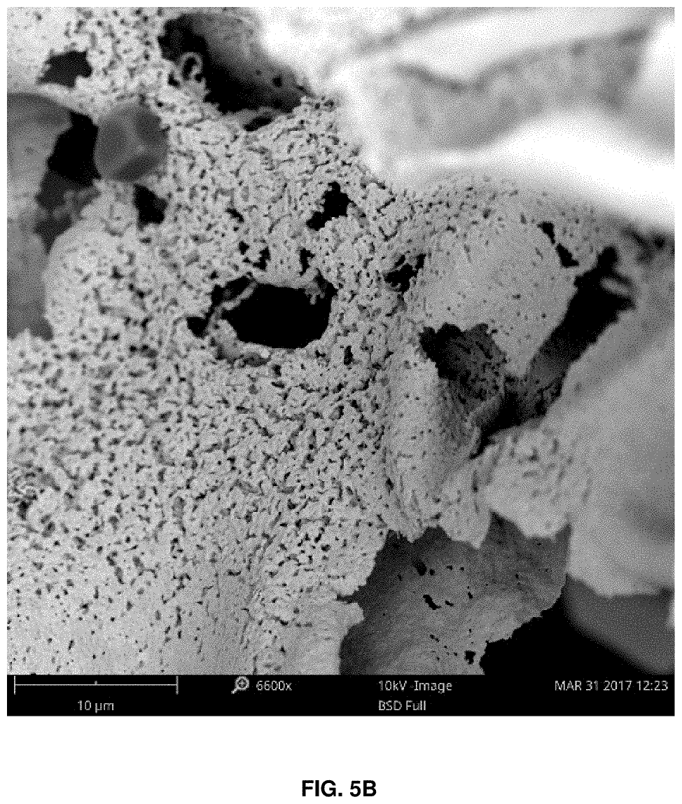

FIGS. 3A-3E are SEM images of platinum foam created by the method, at varying levels of magnification, illustrating the high surface area of the metal product. FIGS. 4A-4B show photographs of the platinum foam at 20× (FIG. 4A) and no (FIG. 4B) magnification, clearly showing the porous structure of the foam. FIGS. 5A-5B are SEM images at higher magnification (namely, 4900× and 6600× magnification), showing the porous nanostructure of the platinum foam. As clearly seen in these images, the method can be used to make very high surface area metal products.

As noted, in some embodiments, the reducing agent is corn syrup. Corn syrup generally contains varying amounts of maltose and higher oligosaccharides. Corn syrup can be made by, for instance, boiling cornstarch, or may be purchased commercially. Most commercial corn syrups have about ⅓ glucose by weight. A non-limiting corn syrup may contain from about 20% to about 98% glucose. Commercially available corn syrups may also contain additional additives such as flavorings. For example, light corn syrup may be seasoned with vanilla flavor and salt. Dark corn syrup may be a combination of corn syrup and molasses (or Refiner's syrup), caramel color and flavor, salt, and the preservative sodium benzoate. As described in the examples herein, both commercially available light corn syrup and commercially available dark corn syrup work well to prepare a high surface area metal foams. Thus, the particular type/brand of corn syrup reducing agent used is not especially limited. For clarity, the term “corn syrup” as used herein refers to any form of syrup containing a significant amount of dissolved sugars, provided that the dissolved sugars include more sugars than only dextrose. Dextrose is one of the two stereoisomers of glucose, also known as D-glucose.

The sugars in corn syrup cause the reaction mixture containing a metal salt to foam until the auto ignition temperature is reached. Surprisingly, it has been found that, while corn syrup creates a foaming effect to produce the high surface area metal foam, dextrose alone does not. As seen in the examples herein, when the method is attempted with dextrose alone as the reducing agent instead of corn syrup, dextrose alone does not result in a high surface area platinum foam, but, rather, results in a smear on the substrate that decomposes instead of foams upon heating. Thus, while the method can be practiced with any corn syrup as the reducing agent, the method cannot be practiced using dextrose alone as the reducing agent to still produce a high surface area metal foam.

In other embodiments, when the method is attempted with cane sugar as the reducing agent, the reaction requires a higher temperature to ignite (>300° C.), and the product is not pure metal. Rather, in one example, the use of cane sugar as a reducing agent with a platinum precursor results in a product that includes platinum oxide, platinum chloride, and carbon. However, the reaction does still foam to create a high surface area product. Thus, the use of cane sugar alone as the reducing agent is not optimal, but nonetheless also creates a high surface area metal foam.

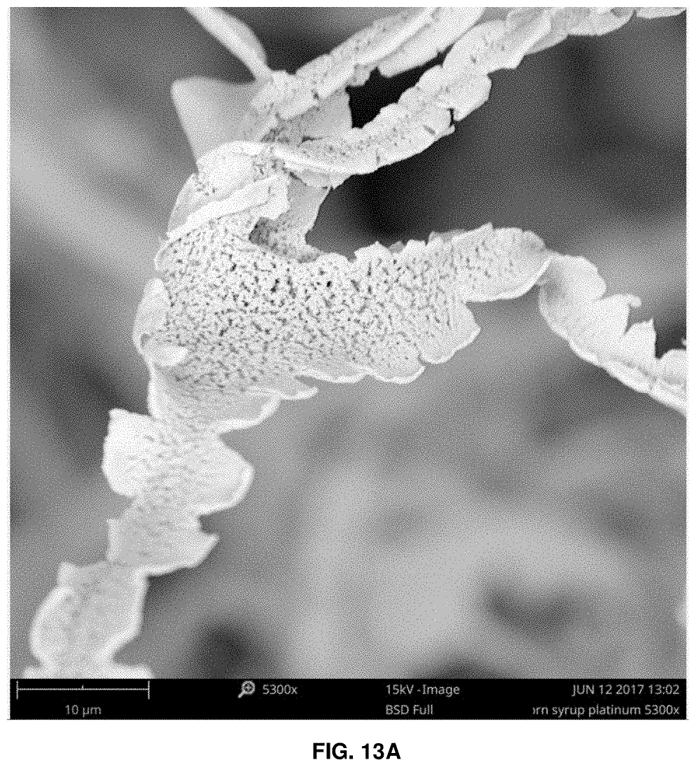

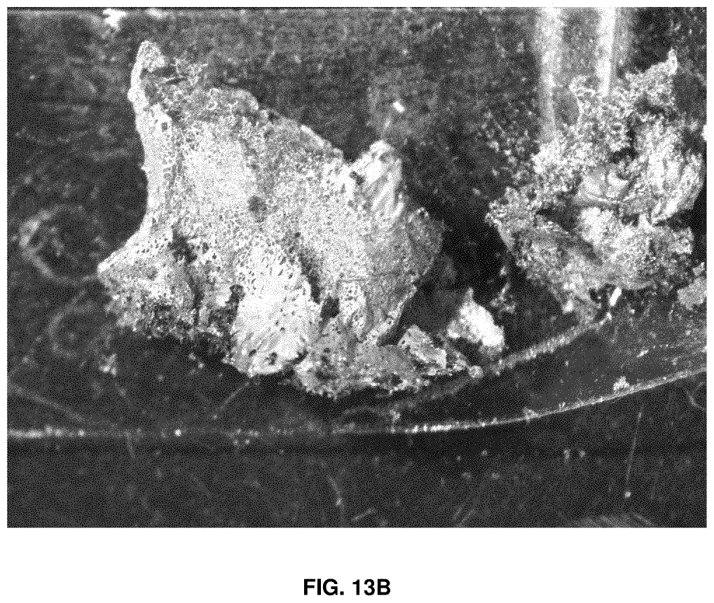

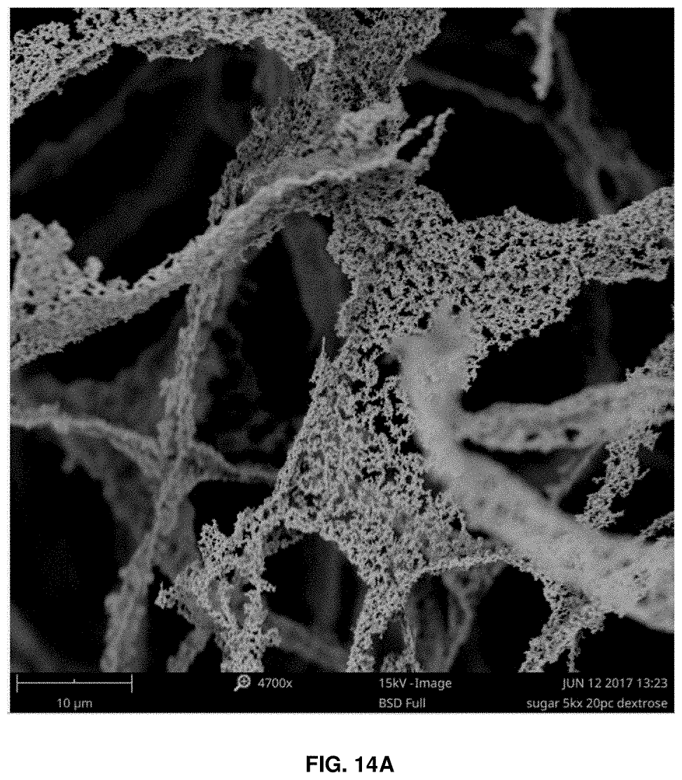

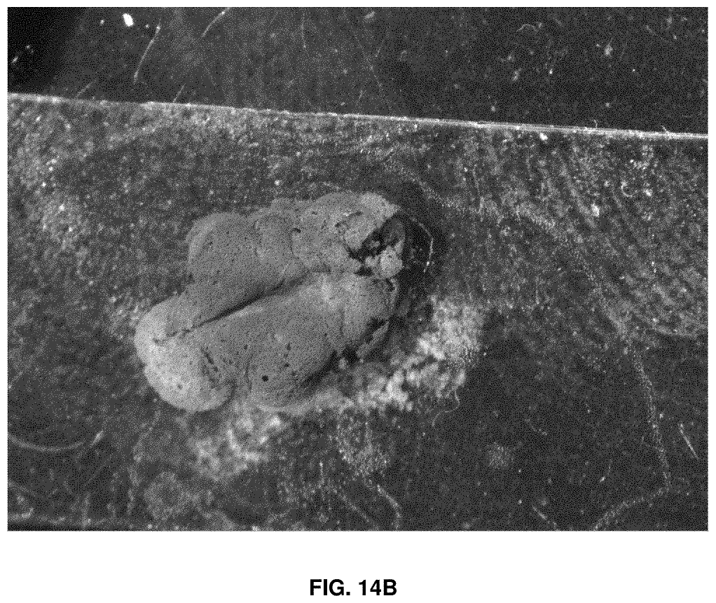

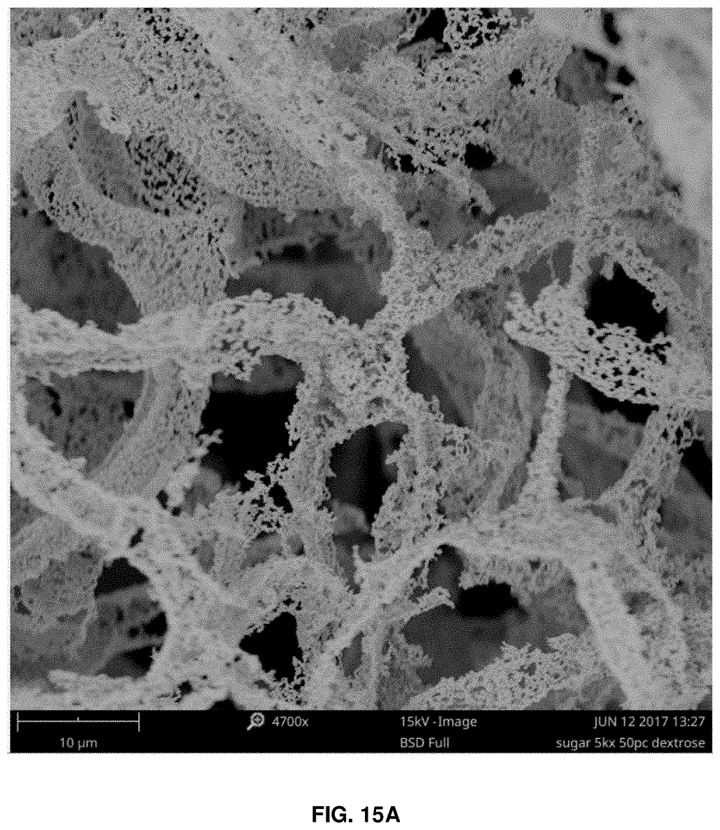

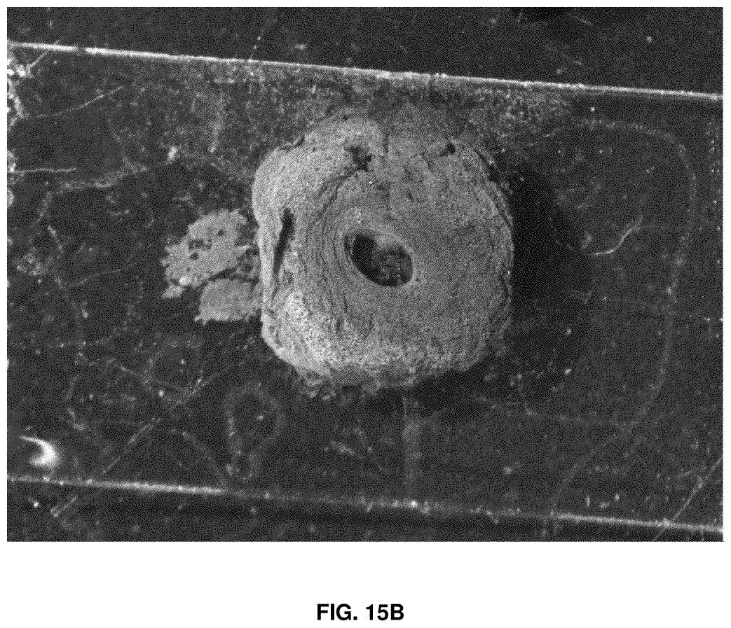

In some embodiments, a mixture of cane sugar and dextrose is used as the reducing agent. As demonstrated in the examples herein, a mixture of cane sugar and dextrose still produces a high surface area product, albeit at a higher temperature for the reaction to ignite. For example, a mixture of dextrose and cane sugar used as the reducing agent with a platinum precursor produces a reaction that starts around 300° C., and results in a high surface area platinum product with substantially no oxides or chlorides present. Some carbon may be present in the product, but not at the same level produced when pure cane sugar is used as the reducing agent. Furthermore, a mixture of cane sugar and dextrose produces a dull grey platinum product (FIGS. 14-15), as opposed to the bright and shiny platinum product produced by a corn syrup reducing agent (FIGS. 13A-13B). While not wishing to be bound by theory, it is believed that this is due to the residual carbon as well as a different microstructure. In particular, the dextrose/cane sugar platinum product shows severe porosity in the veins compared to the corn syrup product, which affects light reflection. Thus, while mixtures of two or more sugars, such as mixtures of cane sugar and dextrose, may produce useful metal foam products, the products are nonetheless distinct from the high surface area metal foams produced from the use of corn syrup as the reducing agent. Furthermore, any amount of sugar additive may be mixed with a corn syrup reducing agent.

The reaction mixture (also referred to herein as the precursor solution) can be applied in a single step of painting, spraying, dipping, etc., the liquid solution into/onto the substrate. The method of application of the precursor solution to the substrate is not limited. Once applied to the substrate, the viscosity of the precursor solution can be adjusted to accommodate the desired process environment. However, the viscosity does not need to be adjusted in order to create a high surface area metal foam. In general, as the viscosity is reduced, the surface area of the metal product is increased. Furthermore, the ratio (by weight) of metal salt-to-corn syrup can be adjusted to tailor the pore and grain size. In general, as the weight ratio of metal salt-to-corn syrup decreases, the pore size increases. Without wishing to be bound by theory, it is believed that this increases surface area of the metal product. The viscosity and the weight ratio of metal salt to corn syrup are two variables which can be adjusted in order to control the surface area of the resulting metal product. In any event, without wishing to be bound by theory, it is believed that the water or methanol (if present) evaporates off before combustion, causing the reaction mixture to become more viscous before converting to the high surface area product.

The coating (i.e., the reaction mixture applied to the substrate) may be dried in air at approximately 80° C. for 2 hours, but this drying step is also not strictly necessary and may be omitted. Then, the coated substrate is heated to a temperature as low as about 200° C., or about 250° C., for a time period of about 15 minutes or more. The exact temperature is dependent on the identity of the metal precursor. Heating to about 200° C. or about 250° C. results in a metal foam that has a very high surface area. The size of the structure can be altered depending on the process. Advantageously, this method creates a metal foam in one step from a liquid to metal, whereas other processes need a reduction process to create metal from a liquid or solid precursor.

In other embodiments, the method is utilized with metals which oxidize or have oxidized surfaces, and the method may further include an additional reduction step in order to reduce oxides to metals. For example, for metals that oxidize, or metals that may have an oxidized surface such as Ni or Cu, the high surface area metal foam can be subjected to a separate reduction process whereby the high surface area metal foam is heated in an atmosphere such as 5% hydrogen 95% nitrogen (forming gas) to reduce any oxide to metal. Heating in a reducing atmosphere, such as a hydrogen/inert gas mix, is also possible to rejuvenate such a high surface area metal foam.

As mentioned, the method creates an open porosity high surface area metal foam. Moreover, though platinum is described for exemplary purposes, the metal can be other metals such as, but not limited to, palladium, silver, gold, nickel, copper, or oxides, alloys, or mixtures thereof. For example, corn syrup can be added to a solution containing salts of gold, silver, and nickel. The precursor solution can then be coated onto a substrate and heated to about 250° C. for a period of time at which point the precursor solution decomposes to reduced metals. Optionally, the product can be allowed to cool, but such cooling is not necessary.

As another example, the method can be used to produce a high surface area foam from an intimate mixture of metal(s) and oxides. As one non-limiting example, the high surface area foam can include a mixture of one or more metals selected from platinum, palladium, nickel, or silver and one or more oxides selected from cerium oxide, gadolinium oxide, or yttria stabilized zirconia (YSZ). For example, the metal foam may be a Ni-doped YSZ. In certain embodiments, the metal foam comprises a cermet, which is a heat-resistant material made of ceramics and sintered metal. In such embodiments, the reaction mixture may include one or more soluble oxides in addition to the metal salt. Alternatively, the reaction mixture may include multiple metals and be subjected to an oxidation step before or after heating to produce one or more metal oxides. A wide variety of mixed ionic electronic conductors having a high surface area may be produced in accordance with the method described herein.

The substrate used in the method described herein can be any suitable material on or in which a high surface area metal foam is desired. Non-limiting example substrate materials are metals, alloys, plastics, ceramics, fabrics, activated carbon, or fiberglass. The identity of the substrate may depend on the desired application for the product. For example, if the metal foam is to be used in a catalytic converter, then the substrate may be a ceramic monolith with a honeycomb structure. As another example, if the metal foam is to be used for antimicrobial filtration in a mask, then the substrate may be a fabric or activated carbon. The composition of the substrate is not particularly limited.

The metal foams created by the method described herein can have very high surface areas. For example, the platinum foams created by the method described herein can have a surface area of at least about 8 m²/g. In some embodiments, the platinum foams have a surface area of at least about 10 m²/g. Typically, a surface area above 5 m²/g results in desirable catalytic activity. Thus, the method described herein advantageously provides a simple approach for producing metal products with desirable catalytic activity.

There are numerous advantages to the method described herein. For example, the method is a simple, one-step process. It uses a low temperature to decompose the constituents to metal and produces a very high surface area foam. The viscosity is easily adjustable by boiling the excess liquids. The foam can be formed within the pores of a porous substrate. The method can easily be tailored to change pore size and viscosity for specific applications. The method produces an easy-to-apply, high surface area foam useable in a wide variety of applications. For example, the foam described herein can be used as an anode/cathode in a battery/fuel cell/electrolyzer, or in a wide variety of batteries, membranes, sensors, electrodes, fuel cells, filters, or the like.

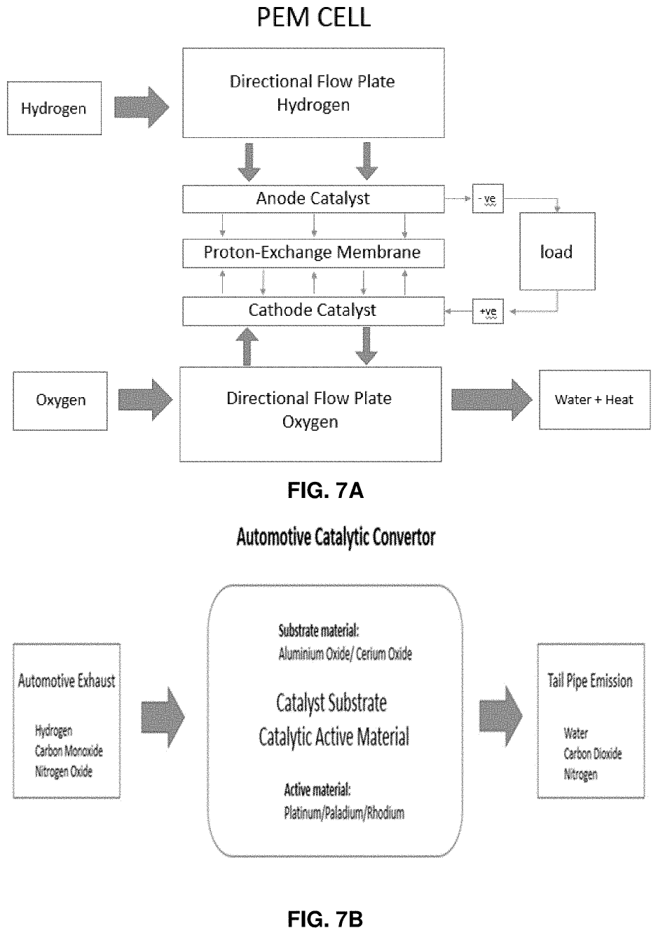

For example, a catalyst can be prepared to infiltrate a solid oxide fuel cell (SOFC) or a solid oxide electrolyzer cell (SOEC). A SOEC is a fuel cell which basically runs similar to a SOFC in reverse, running in regenerative mode to achieve electrolysis of water using a solid oxide, ceramic, or electrolyte to produce hydrogen gas and oxygen. Additional non-limiting example uses of the foams as catalysts include to produce methane, to reduce pollutants from automobiles, to oxidize CO, or to hydrogenate unsaturated compounds. FIGS. 7A-7B illustrate two non-limiting example devices that the catalyst material can be used in, namely a proton-exchange membrane fuel cell and a catalytic converter.

A proton-exchange membrane fuel cell, depicted in FIG. 7A, also known as a polymer electrolyte membrane fuel cell (PEMFC), is a type of fuel cell in which lower temperature/pressure ranges (e.g., 50 to 100° C.) and a proton-conducting polymer electrolyte membrane are utilized. PEMFCs generate electricity in a manner opposite to PEM electrolysis, which is the electrolysis of water in a cell equipped with a solid polymer electrolyte which conducts protons, separates product gases, and electrically insulates the electrodes. PEMFCs typically include membrane electrode assemblies which are composed of the electrodes, electrolyte, catalyst, and gas diffusion layers. Thus, PEMFCs transform the chemical energy liberated during the electrochemical reaction of hydrogen and oxygen to electrical energy. Hydrogen is delivered to an anode side of the membrane electrode assembly, where it is catalytically split into protons and electrons. The protons permeate through the polymer electrolyte membrane to the cathode side, while the electrons travel along an external load circuit to the cathode side, thereby creating the current output of the PEMFC. Oxygen is delivered to the cathode side, where the oxygen molecules react with the protons permeating through the polymer electrolyte membrane and the electrons arriving through the external circuit to form water molecules. The catalyst for such a fuel cell is generally sprayed or painted onto the solid electrolyte. Thus, in some embodiments of the method described herein, the substrate is a solid electrolyte.

A catalytic converter, depicted in FIG. 7B, converts byproducts of combustion to fewer toxic substances by performing catalyzed chemical reactions. In particular, a catalytic converter catalyzes a redox reaction, for instance to convert carbon dioxide into water vapor. In a typical catalytic converter, the catalyst-coated substrate is a catalytic core providing a high surface area. A catalyst washcoat acts as a carrier for the catalytic substrate that disperses the materials over the high surface area. The catalytic materials are suspended in the washcoat prior to applying to the core. In some embodiments, the core is a ceramic monolith with a honeycomb structure. The platinum catalyst acts as a reduction catalyst and as an oxidation catalyst. Thus, in some embodiments of the method described herein, the substrate is a ceramic monolith with a honeycomb structure.

The metal foams described herein may be useful for antimicrobial applications, such as antimicrobial filtration applications. When the metal used to create the high surface area metal foam has antimicrobial properties, such as silver, the resulting high surface area metal foam can be used as an antimicrobial air filter in, for example, a mask or an HVAC system, or an antimicrobial liquid filter in, for example, a water purifier or humidifier.

An antimicrobial metallic foam produced from an antimicrobial metallic precursor, in accordance with the present disclosure, can be adapted into different types of filters for antimicrobial purposes. For example, the antimicrobial metallic foam can include metals capable of producing what is known as the “oligodynamic effect.” The oligodynamic effect can permit certain metals to have inherent biocidal effects, which can be used to deactivate harmful microorganisms. Desirably, small amounts of the metal ions can have detrimental effects to microorganisms by causing damage to enzymes and proteins found in the microorganisms. In addition, due to the conductive nature of metal, the antimicrobial metallic foam can also be capable of producing electrostatic effects, which can further increase antimicrobial effects of the metal foam.

Non-limiting examples of metals having an oligodynamic effect include cadmium, cobalt, iron, manganese, platinum, titanium, aluminum, antimony, arsenic, barium, bismuth, boron, copper, gold, lead, mercury, nickel, silver, thallium, tin, and zinc. Also, metal alloys such as brass and bronze may also be capable of producing the oligodynamic effect. In addition, some oxides may also be employed for similar purposes. However, it should be appreciated that a skilled artisan can select other metals capable of producing biocidal effects, within the scope of the present disclosure.

As discussed above, the antimicrobial metallic foams can be made using a reducing agent, such as, but not limited to corn syrup. The antimicrobial metallic foams may be made with or without a diluting agent to enhance the spreadability of a metal precursor on a substrate to be covered with the foam. A non-limiting example of the diluting agent can include methanol. However, it should be appreciated that one skilled in the art can employ different reducing agents and diluting agents, as desired.

In particular examples, the antimicrobial metallic foam can include a silver foam produced from a silver precursor solution. Desirably, the silver precursor solution can yield a strong foam, which can also be malleable and flexible. A stronger foam may be preferable for use in an HVAC system in order to allow the foam to withstand the airflow found in a typical HVAC system. In addition, as shown in the examples herein, the silver foam has shown to have potent antimicrobial activity at relatively low amounts (less than 20 g/m²) alone and while coating the substrate material.

A copper precursor solution may also be used to create an antimicrobial metallic foam. In the examples herein, a copper precursor solution yielded a foam that was fragile. It is believed that the fragility was due to the foam being in an oxide form. However, the copper foam may be strengthened through post-processing to return it to a metallic form.

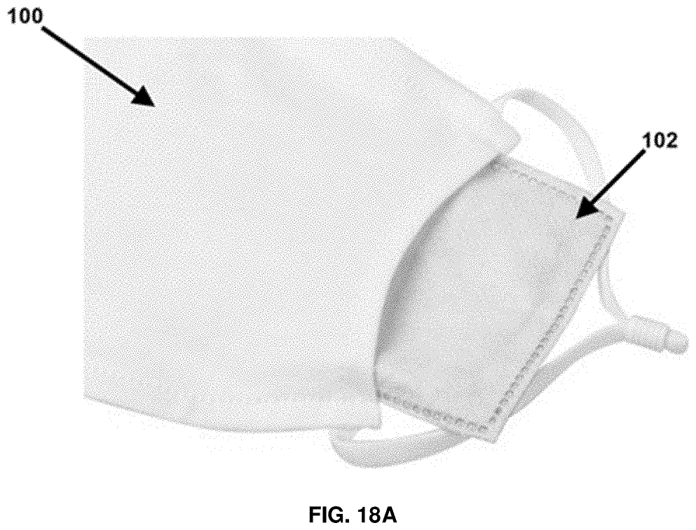

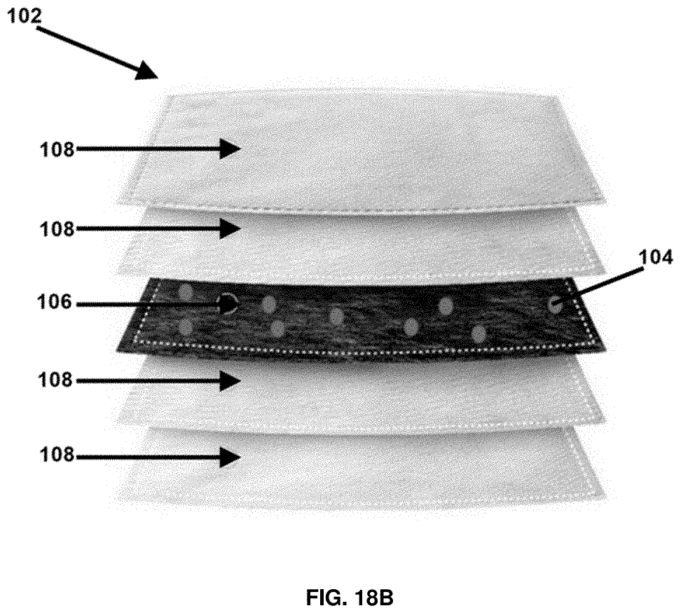

Referring now to FIGS. 18A-18B, an example of a facemask 100 having a cassette (or cartridge) filter 102 with an antimicrobial metallic foam 104 is shown. Advantageously, the cassette filter 102 can capture microorganisms from the air before the microorganisms enter the respiratory system of a user. In addition, since the antimicrobial metallic foam 104 has inherent biocidal effects, the microorganisms can be deactivated by the cassette filter 102. Desirably, this can militate against a buildup of harmful captured microorganisms, which can occur with traditional filters that do not deactivate the microorganisms. The cassette filter 102 may have an activated carbon layer 106, as shown in FIG. 18B. The activated carbon layer 106 can be configured to filter volatile organic compounds (VOCs), odors, and fine particles out of the air before they enter the respiratory system of the user. The activated carbon layer 106 can include a coating of the antimicrobial metallic foam 104 (represented by circular elements in FIG. 18B). The coating of the antimicrobial metallic foam 104 may be evenly applied or homogeneous on the activated carbon layer 106, but does not need to be evenly applied or homogeneous on the activated carbon layer 106. The activated carbon layer 106 acts as the substrate for the antimicrobial metallic foam 104. The coating of the antimicrobial metallic foam 104 on the activated carbon layer 106 can add antimicrobial attributes to the activated carbon layer 106. Advantageously, this can permit for the capture and deactivation of microorganisms. The cassette filter 102 can also include a plurality of other layers 108. Non-limiting examples of the other layers 108 can include nonwoven materials, melt blown materials, and/or additional filter layers. It should be appreciated that a skilled artisan can employ other configurations for a face mask 100 and the cassette filter 102, within the scope of the present disclosure.

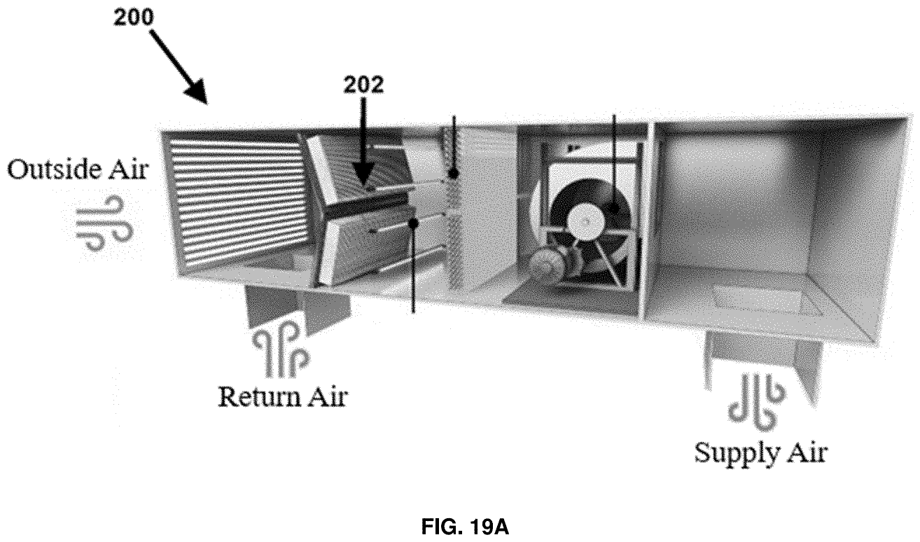

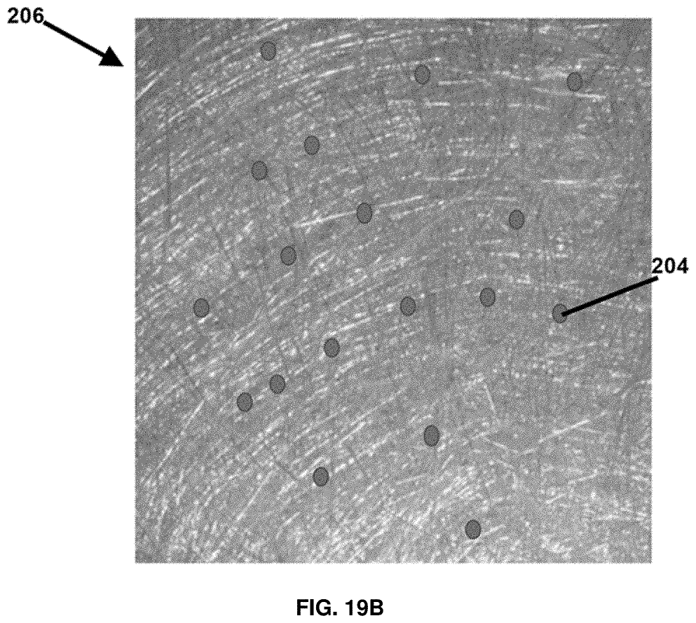

Referring now to FIGS. 19A-19B, an example of an air filtration system 200 having an air filter 202 with an antimicrobial metallic foam 204 is shown. The air filter 202 can include a substrate material 206, as shown in FIG. 19B. The substrate material 206 can be fluid permeable, which can permit air and/or liquid to flow through the substrate material 206. Non-limiting examples of the substrate material 206 include fiberglass and activated carbon. Other materials can also be used. The substrate material 206 can be configured to be infiltrated and/or coated by an antimicrobial precursor solution. The substrate material 206 can then be baked at a high temperature to produce a coating of the antimicrobial metallic foam 204 (represented by circular elements in FIG. 19B). In certain instances, the substrate material 206 is baked at roughly 500° C. Advantageously, the substrate material 206 with the coating of the antimicrobial metallic foam 204 can capture and deactivate microorganisms as air is circulated through the air filtration system 200. This can be particularly beneficial for commercial and residential buildings. Other applications such as vehicles, public transport, hospitals, and other enclosed spaces are also possible. It should be appreciated that a person skilled in the art can select different types of air filtration technologies for the air filter 202, as desired.

The compositions and methods described herein can be embodied as parts of a kit or kits. A non-limiting example of such a kit is a kit for making a catalyst, the kit comprising corn syrup and a source of metal in separate containers, where the containers may or may not be present in a combined configuration. Many other kits are possible, such as kits comprising a metal precursor solution, or kits further comprising a substrate such as a fabric, activated carbon, or fiberglass. The kits may further include instructions for using the components of the kit to practice the subject methods. The instructions for practicing the subject methods are generally recorded on a suitable recording medium. For example, the instructions may be present in the kits as a package insert or in the labeling of the container of the kit or components thereof. In other embodiments, the instructions are present as an electronic storage data file present on a suitable computer readable storage medium, such as a flash drive. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

### EXAMPLES

### Example I

Production of High Surface Area Platinum Catalysts

Platinum powder (1.5 g) was dissolved in aqua regia (3 parts hydrochloric acid: 1-part nitric acid) to create a solution containing H₂PtCl₆. Dihydrogen hexachloroplatinate hexahydrate (dried granule H₂PtCl₆·6H₂O) was purchased from Alpha Aesar (stock number 11051). The method was conducted using the solution containing H₂PtCl₆ and separately using the dried dihydrogen hexachloroplatinate hexahydrate, each producing good results. Two different kinds of corn syrup were tried: Karo dark corn syrup and Market Pantry® light corn syrup (Target brand). Each type of corn syrup worked equally well in the process.

Four different recipes were used to make the precursor solution, each resulting in a different viscosity.

Recipe 1 used dried dihydrogen hexachloroplatinate hexahydrate (dried granule H₂PtCl₆·6H₂O) purchased from Alpha Aesar (stock number 11051) without water. 5 gm corn syrup was added to 3 gm Alpha #11051. The solution was heated on a hotplate to remove excess water until it foamed. The product was allowed to cool. The result was a high surface area platinum foam.

Recipe 2 used hexochloroplatinic acid in liquid form. 5 gm liquid platinic acid was added to 5 gm corn syrup. The solution was heated on a hotplate to remove excess water until it foamed. The product was allowed to cool. The result was a high surface area platinum foam.

Recipe 3 used dried dihydrogen hexachloroplatinate hexahydrate (Alpha #11051). 5 gm Alpha #11051 was added to 5 mL water and 6 g corn syrup. The solution was heated on a hotplate to remove excess water until it foamed. The product was allowed to cool. The result was a high surface area platinum foam.

Of the above three recipes, recipe 1 resulted in the highest viscosity solution and the largest pore size. FIGS. 3A-3E show SEM images of platinum foam created by recipes 1-3, at varying levels of magnification, illustrating the high surface area. FIGS. 4A-4B show photographs of the platinum foam at 20× (FIG. 4A) and no (FIG. 4B) magnification, clearly showing the porous structure of the foam. FIGS. 5A-5B show SEM images at higher magnification (namely, 4900× and 6600× magnification), showing the porous nanostructure of the platinum foam.

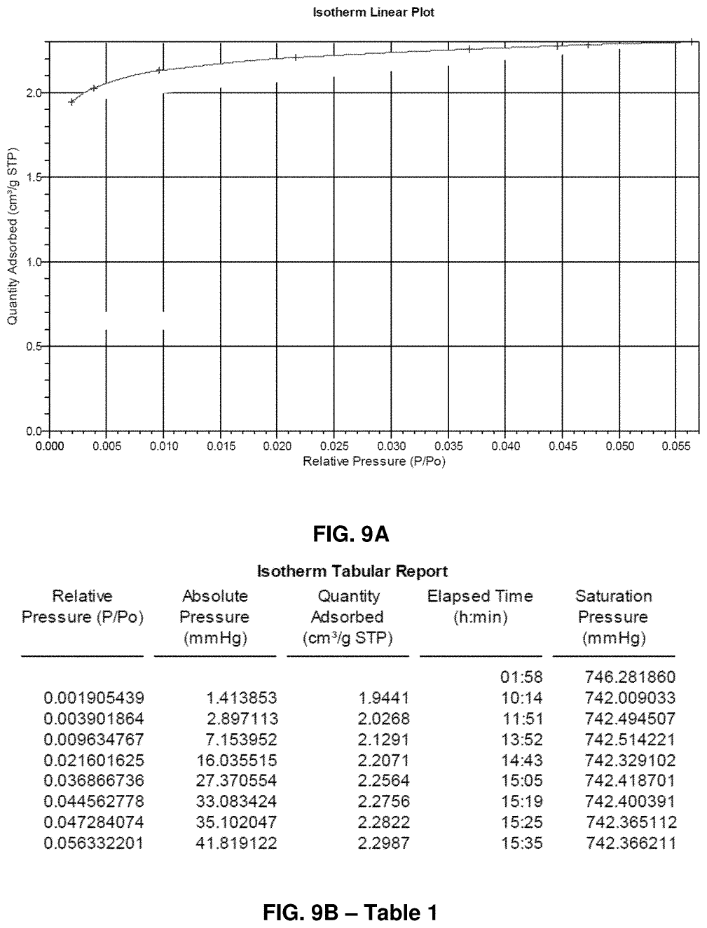

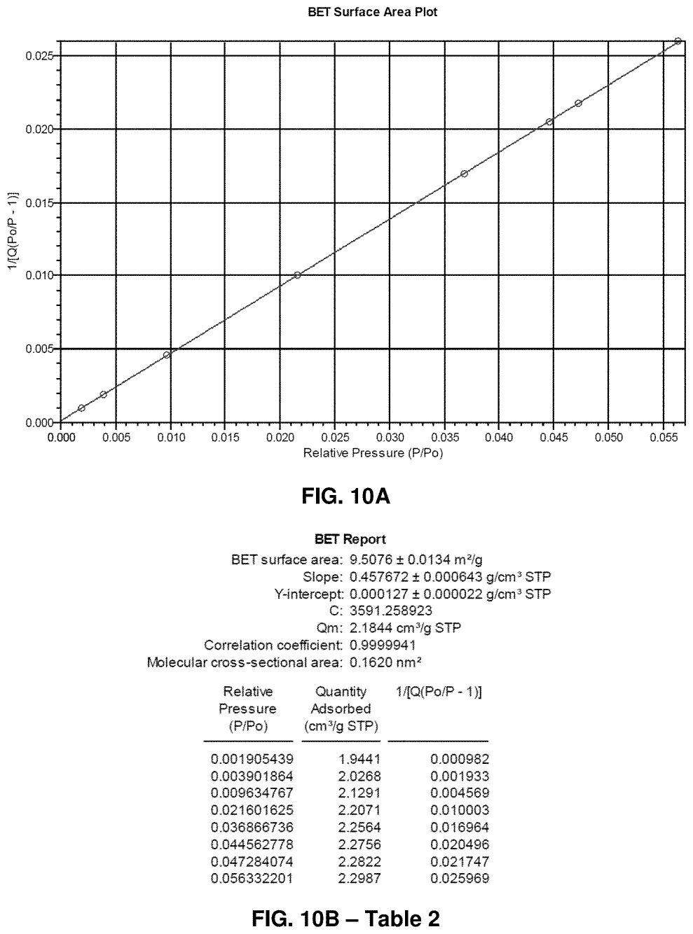

Two samples of platinum foam made from the above recipes were characterized for surface area. The first sample had a BET surface area of 9.5076 m²/g, and an average particle size of about 631 nm. The single point surface area at P/Po was 9.4416 m²/g. The micropore surface area was measured to be 10.3112 m²/g. The cumulative surface area of pores was measured to be between 2.2539 angstroms and 3.400 angstroms with a hydraulic radius of 11.9561 m²/g. FIG. 9A shows an isotherm linear plot from the first sample, and FIG. 9B shows Table 1, depicting the isotherm results in table form. FIG. 10A shows the BET surface area plot from the first sample, and FIG. 10B shows Table 2, depicting the BET data in table form.

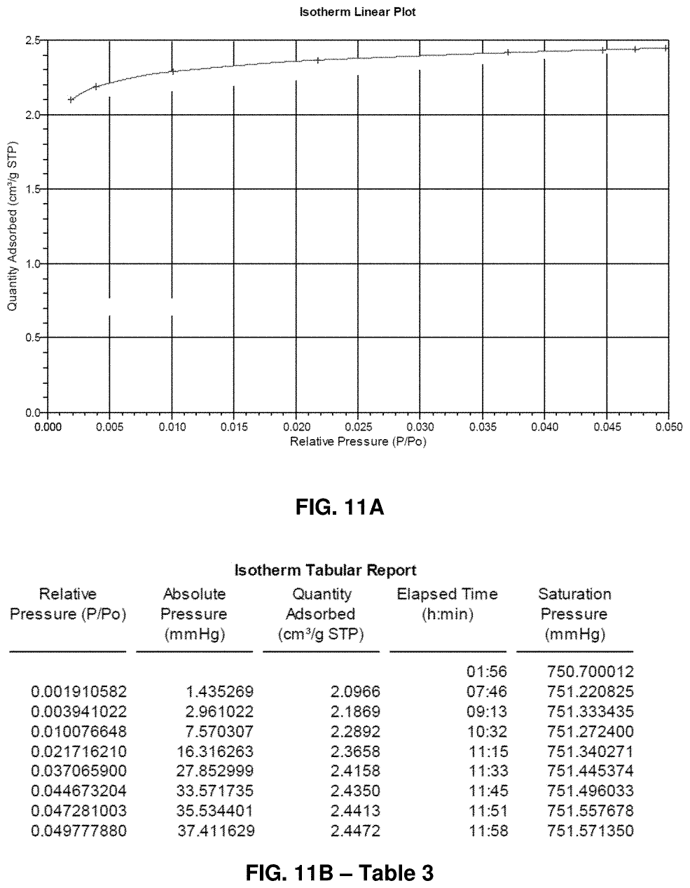

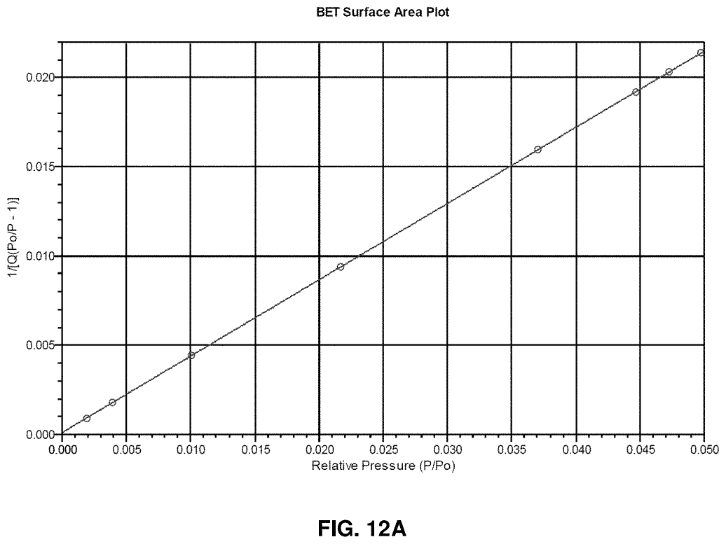

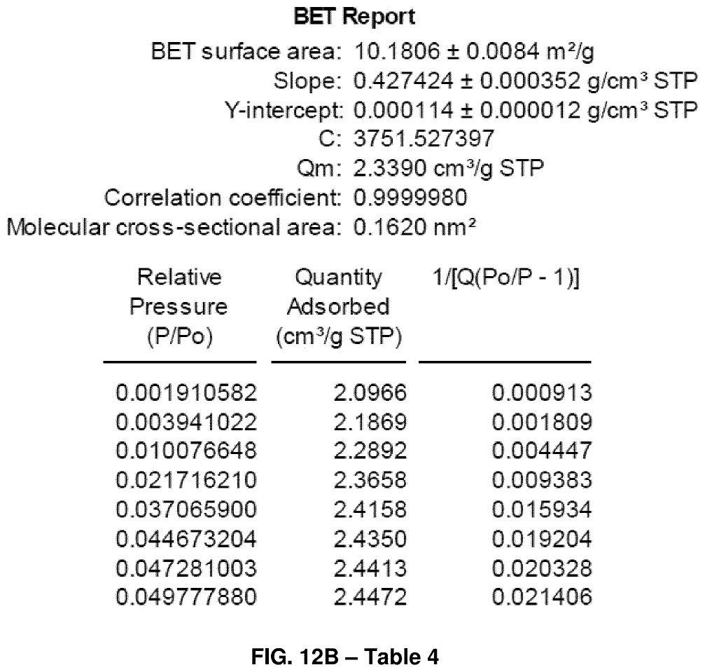

The second sample had a BET surface area of 10.1806 m²/g, and an average particle size of about 589 nm. The single point surface area at P/Po was 10.1214 m²/g. The micropore surface area was measured to be 11.1237 m²/g. The cumulative surface area of the pores was measured to be between 2.2543 angstroms and 3.2000 angstroms with a hydraulic radius of 10.9949 m²/g. FIG. 11A shows an isotherm linear plot from the second sample, and FIG. 11B shows Table 3, depicting the isotherm results in table form. FIG. 12A shows the BET surface area plot from the second sample, and FIG. 12B shows Table 4, depicting the BET data in table form.

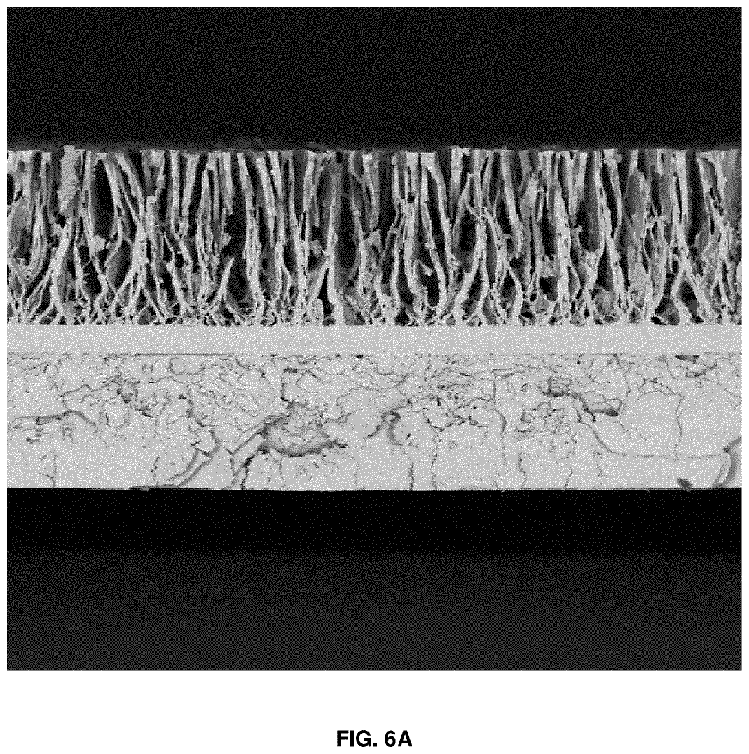

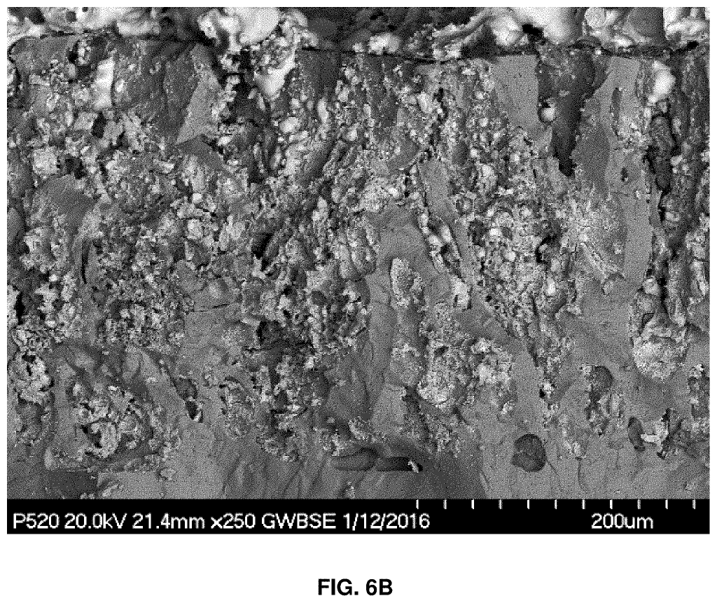

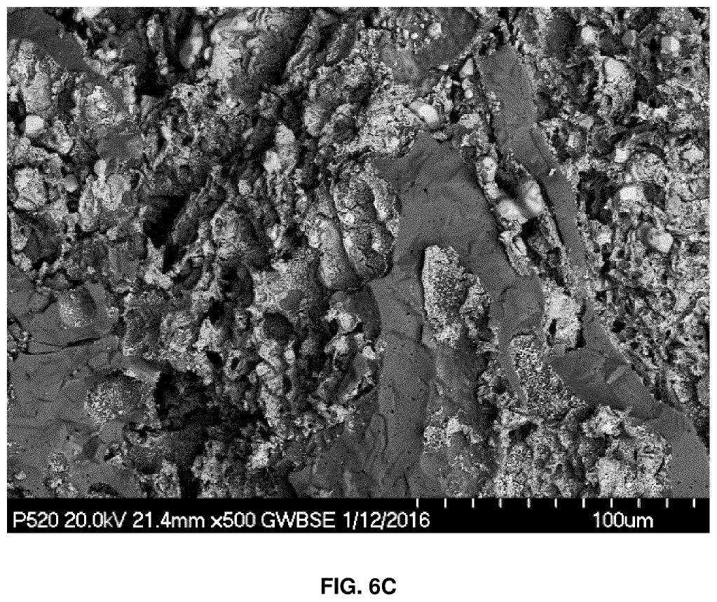

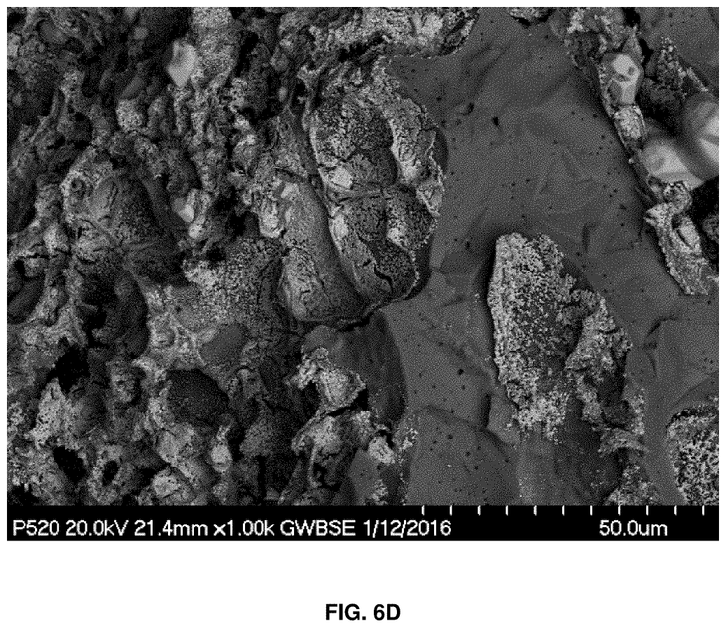

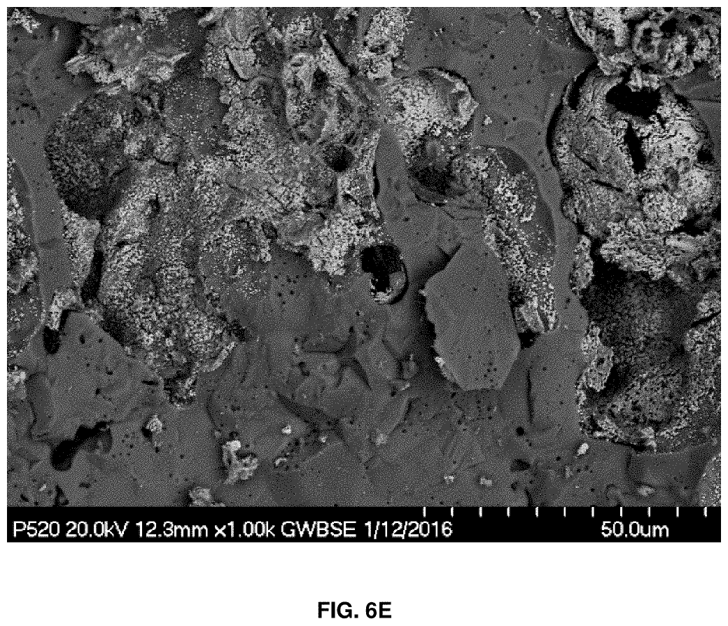

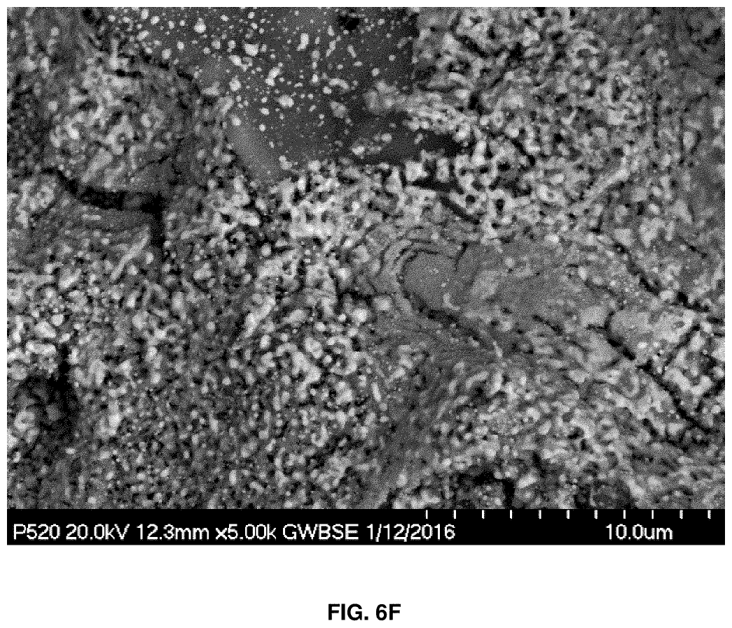

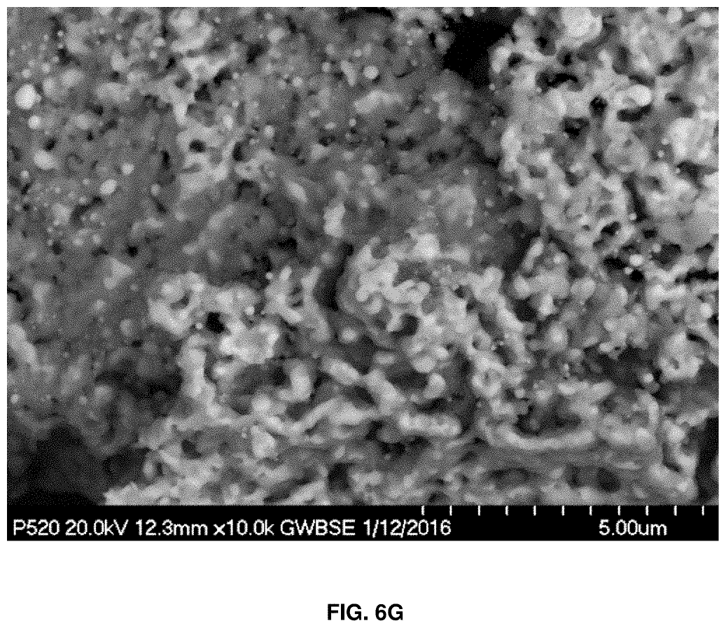

Recipe 4 was made to thin down (i.e., reduce the viscosity of) the reaction mixture further in order to infiltrate the reaction mixture into a porous body. 0.75 g platinum precursor from the above processes was added to 0.75 g methanol to produce a platinum-containing precursor solution. FIGS. 6A-6G show SEM images of a freezecast structure infiltrated with the platinum-containing precursor solution. As seen in these images, the precursor solution infiltrated the substrate. The infiltrated substrate was heated to produce a high surface area platinum catalyst in the pores of the substrate.

Comparison with Dextrose Alone

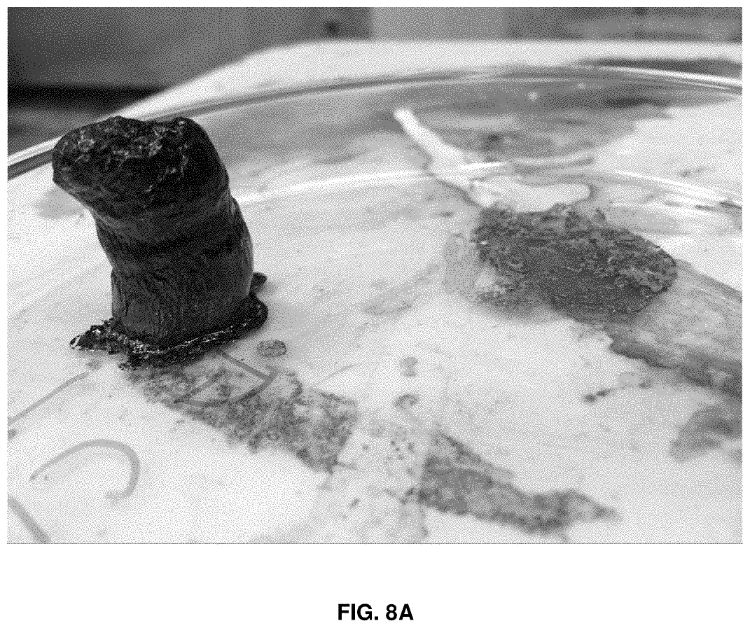

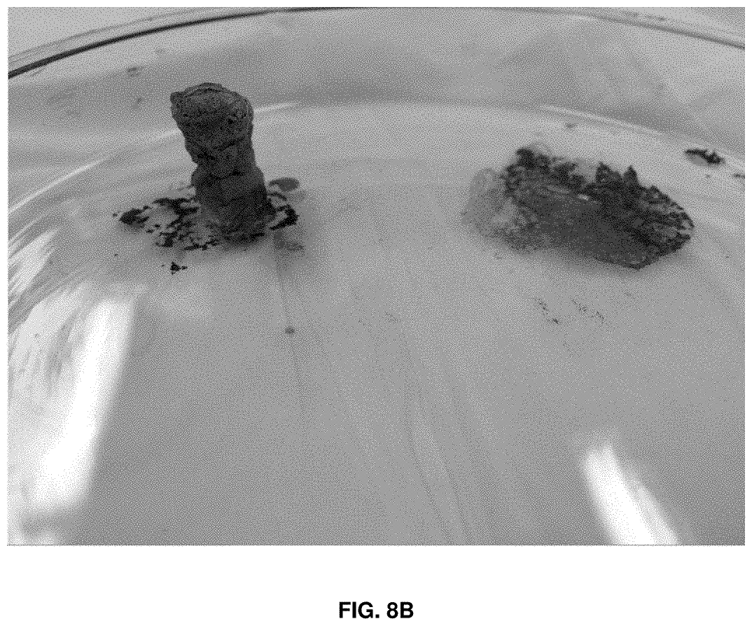

Recipe 2 from above was used for a comparison with dextrose alone instead of corn syrup as the reducing agent. For the dextrose alone sample, the corn syrup was replaced with an equal amount of dextrose. FIG. 8A shows a photograph of the reaction mixtures after being heated but prior to full conversion, where the reaction mixture made with corn syrup is on the left in the photograph and the reaction mixture made with dextrose is on the right in the photograph. The photograph in FIG. 8A shows a black ‘tower’ which is the corn syrup platinum that has been heated but has not completely converted to platinum metal. The smear that is next to the black ‘tower’ is the dextrose sample, but it has already decomposed from being heated. FIG. 8B shows the same two reaction mixtures following full conversion, again with the corn syrup mixture on the left and the dextrose mixture on the right. The photograph in FIG. 8B shows the grey ‘tower’ after full conversion, and a smear representing what remained of the dextrose sample after full conversion. Because the dextrose sample peeled up from the glass surface during heating, it lifted during decomposition of the dextrose, and there was not sufficient material to further characterize the dextrose product. This comparison clearly shows that dextrose by itself does not cause the same foaming action, which creates a high surface area product, caused by corn syrup. Thus, dextrose alone as the reducing agent does not produce the same result as corn syrup.

Comparison with Cane Sugar

Cane sugar alone was used as the reducing agent instead of corn syrup. Although the platinum did foam, it ignited at a much higher temperature compared to corn syrup alone (>300° C.), and the resulting product was not pure platinum. EDS analysis showed the resulting product included platinum oxide, platinum chloride, and about 20% carbon.

Comparison with Cane Sugar Mixed with Dextrose

20% and 50% dextrose were added to the cane sugar, and these mixtures were used as the reducing agent in the reaction. The reaction started around 300° C. (as opposed to around 200° C. for the corn syrup). EDS analysis did not reveal any oxides or chlorides in the product. Carbon was still present at about 5%, which is lower than the level of carbon in the product following the use of pure cane sugar as the reducing agent.

When using corn syrup, the resulting platinum product is bright and shiny. (FIGS. 13A-13B.) In contrast, the products produced from the mixtures of cane sugar and dextrose are dull grey. (FIGS. 14-15.) Without wishing to be bound by theory, this is believed to be because of the residual carbon and the microstructure. As seen from the micrographs of the products (FIGS. 14A, 15A), the cane sugar platinum is weakly bonded with each grain and shows severe porosity in the veins (see higher magnification images in FIGS. 14A, 15A compared to FIG. 13A). While this may be beneficial for some applications, it causes light to not reflect back and results in the platinum product being not as bright and shiny as the corn syrup product. Thus, corn syrup produces a product having a microstructure distinct from that produced from dextrose/cane sugar mixtures. However, the dextrose/cane sugar mixture still resulted in a foaming reaction that produced a high surface area product.

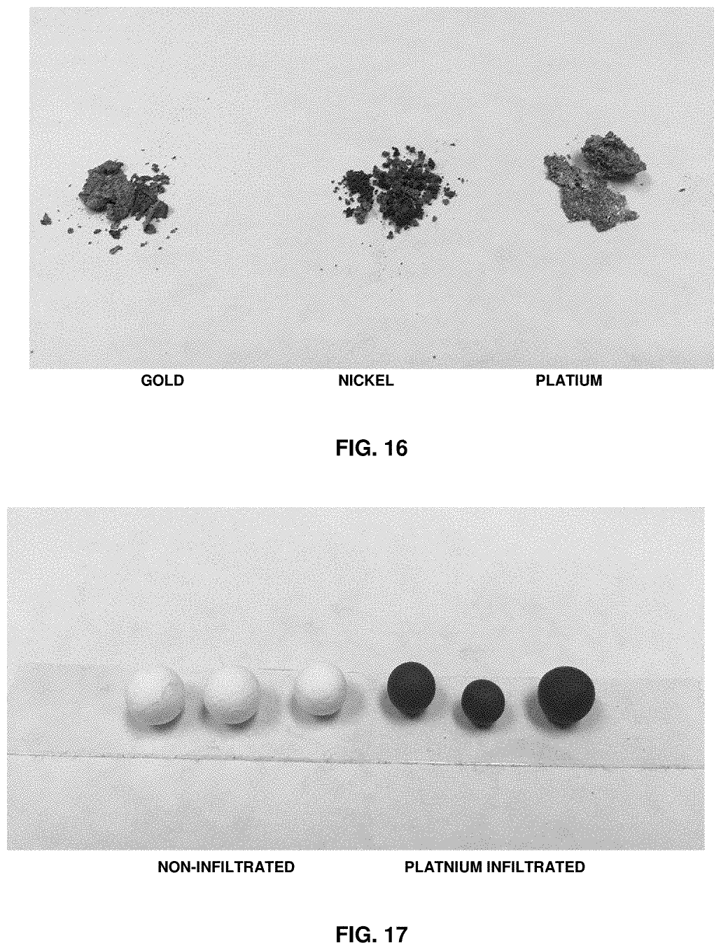

FIG. 16 shows a photograph showing that different metals are easily converted to porous metal. From left to right, are gold, nickel, and platinum are shown.

FIG. 17 shows a photograph showing how the presently described process is supported by a substrate. The platinum foam holds up to high flow rates of gas (or water); this image shows that a substrate can be used to support the porous structure while still benefiting from the high surface area. It also shows the uniformity that is easily achieved and the ease of infiltration of the platinum (or other) metal into such a substrate.

### Example II

A series of experiments was conducted to evaluate different mixes and combinations for antimicrobial precursors to create antimicrobial metallic foams. The mixes were adjusted to include different ratios of water, corn syrup, metal, and dilutions. For example, the amount of silver nitrate was adjusted to determine acceptable tolerances. In addition, the mixes were diluted to allow the antimicrobial precursors to spread more evenly across surfaces, like the substrate. Certain examples used methanol to dilute the mixes.

Copper Precursor and Foam Experiment

The following mixes were tested to create copper precursors and copper foams.

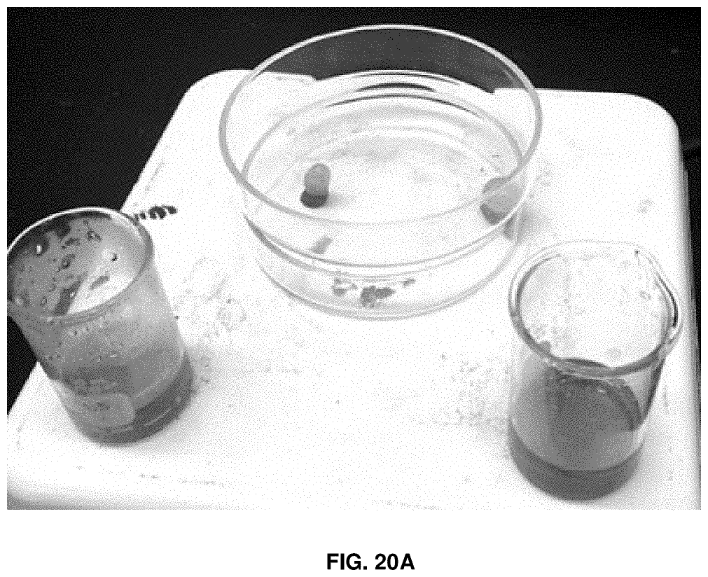

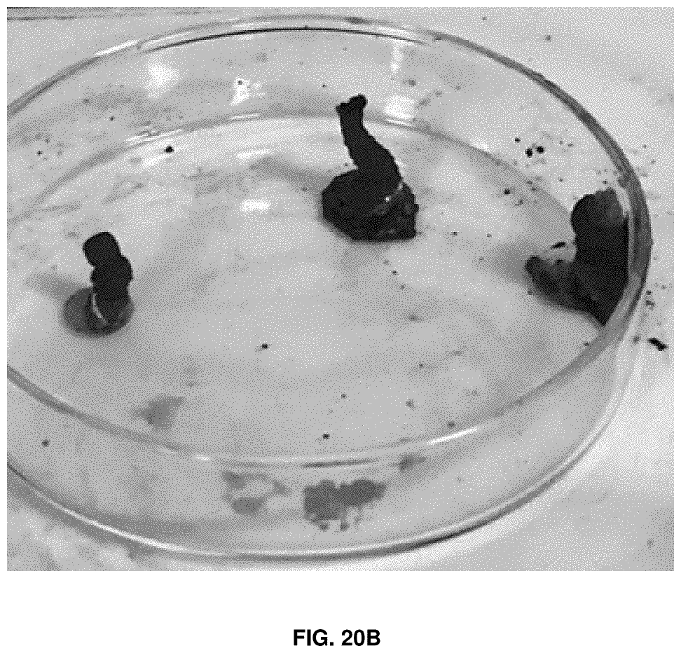

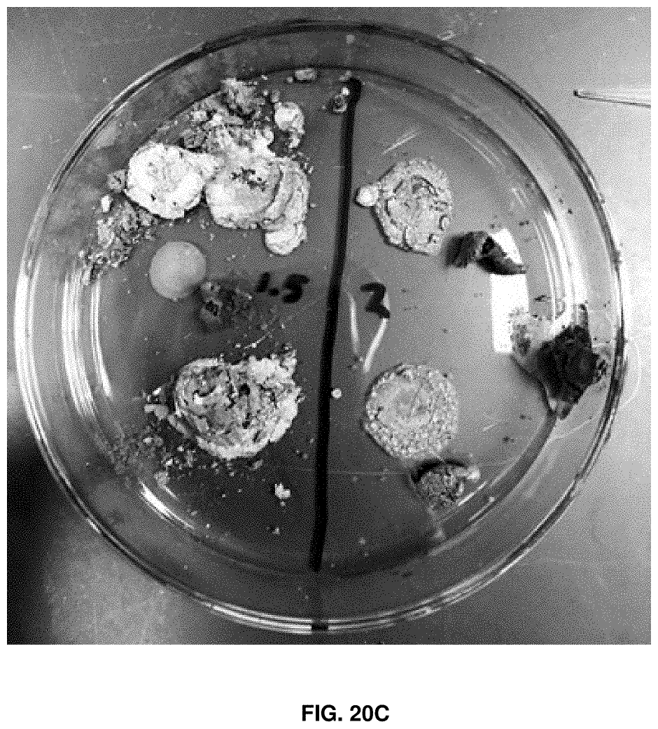

Recipe C1.15 included 1.5 g copper nitrate, 5 g corn syrup, and 5 g micropure water (reverse osmosis and deionized). Copper solution was mixed in a small beaker using heat as needed until dissolved. Then, the resultant mixture was heated on a hot plate until a high viscosity rolling boil was achieved, or a color change was noted. Next, the copper precursor was decomposed into the copper foam (FIG. 20B).

Recipe C2 included 2 g copper nitrate, 5 g corn syrup, and 5 g micropure water (reverse osmosis and deionized). Copper solution was mixed and dissolved in a small beaker using heat as needed. Then, the resultant mixture was heated on a hot plate until a high viscosity rolling boil was achieved, or a color change was noted. Next, the copper precursor was decomposed into the copper foam (FIG. 20B).

These copper foams were observed to be light and delicate (FIG. 20C), possibly from being in an oxidized form. These foams could be strengthened through post-processing to return the copper to a metallic form. Certain copper precursors created in this experiment are shown in FIG. 20A.

Silver Precursor and Foam Experiment

The following mixes were tested to create silver precursors and silver foams.

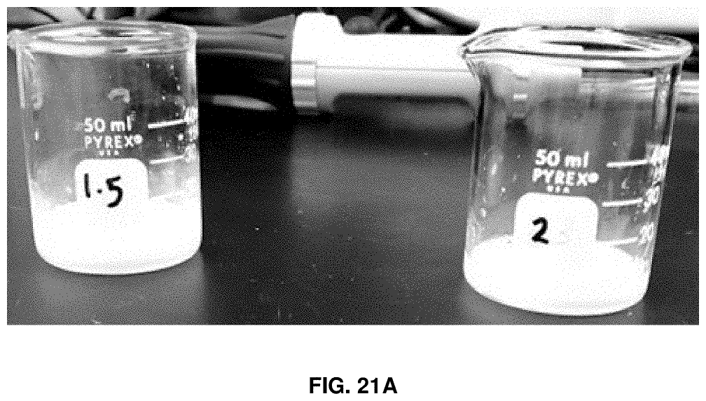

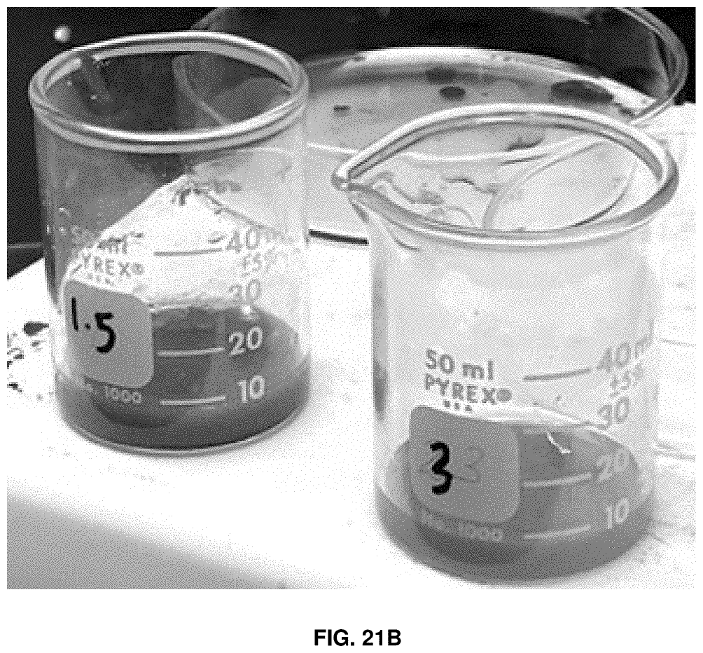

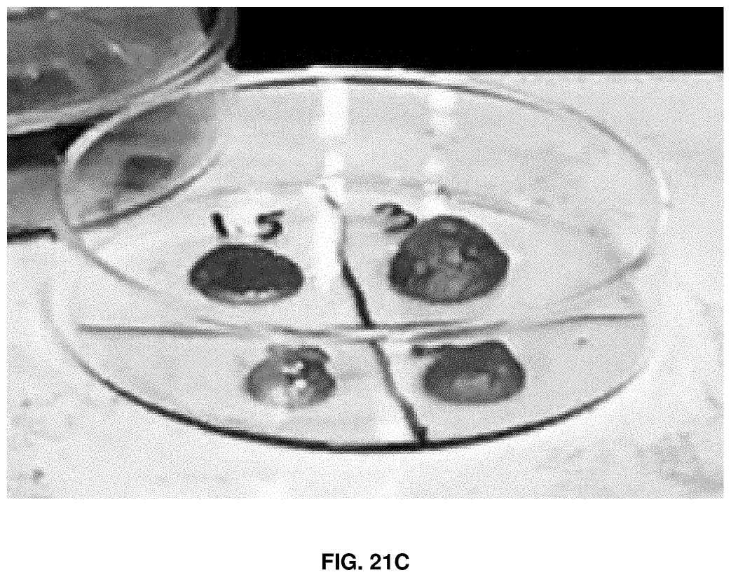

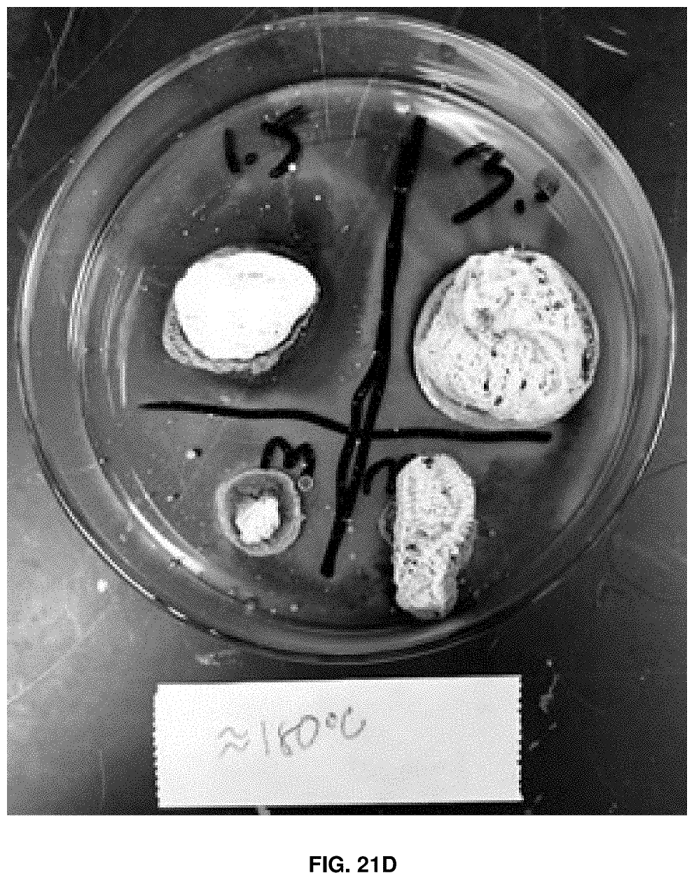

Recipe Ag1.15 included 1.5 g silver nitrate, 5 g corn syrup, and 1.5 g micropure water (reverse osmosis and deionized). The silver solution was mixed and dissolved in a small beaker using heat as needed. Then, the resultant mixture was heated on a hot plate until a high viscosity rolling boil was achieved, or a color change was noted. Next, the silver precursor was decomposed into the silver foam (FIG. 21C).

Recipe Ag3 included 2 g copper nitrate, 5 g corn syrup, and 5 g micropure water (reverse osmosis and deionized). The silver solution was mixed and dissolved in a small beaker using heat as needed. Then, the resultant mixture was heated on a hot plate until a high viscosity rolling boil was achieved, or a color change was noted. Next, the silver precursor was decomposed into the silver foam (FIG. 21C).

These silver foams were found to be sturdy and in their metallic form. Certain silver precursors made in this experiment are shown in FIG. 21A. The silver precursors are shown during evaporation in FIG. 21B. Also, it was determined that an approximate autoignition temperature of the silver foams was about 180° C. (FIG. 21D).

First Zone of Inhibition Experiment—Copper and Silver Foams

Zone of inhibition (ZOI), also known as disk fusion, experiments were conducted to measure the susceptibility of the bacteria to the manufactured foams. These experiments were conducted by applying bacteria to an agar plate. This was accomplished by pipetting the bacteria onto the agar using a micropipette. The bacteria were evenly dispersed on the agar plate by using glass beads. Then, the material, such as the foam, was disposed in the center of the agar plate. Next, the agar plate was incubated for 24 to 48 hours. Afterwards, whether a zone of inhibition formed a ring around the material was observed. If a ring formed around the material then bacteria was unable to form/grow on or near the material.

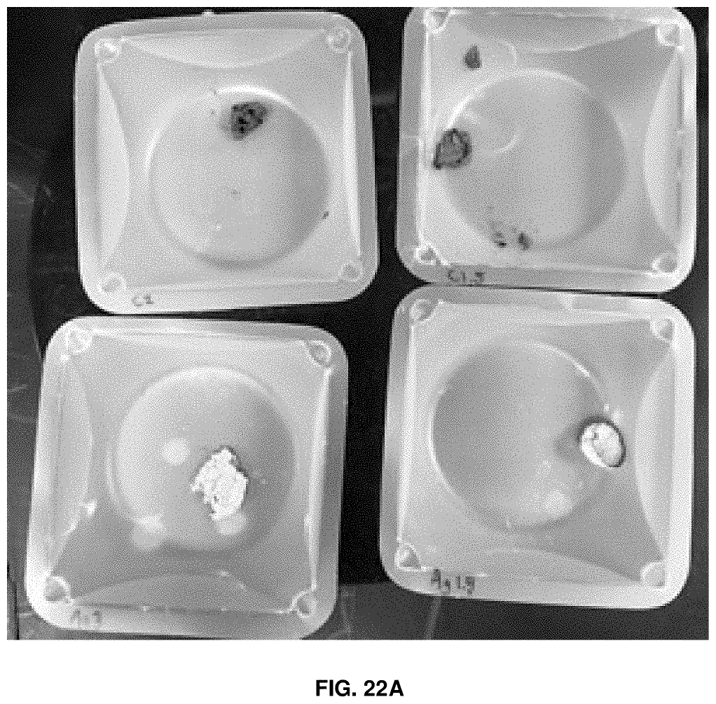

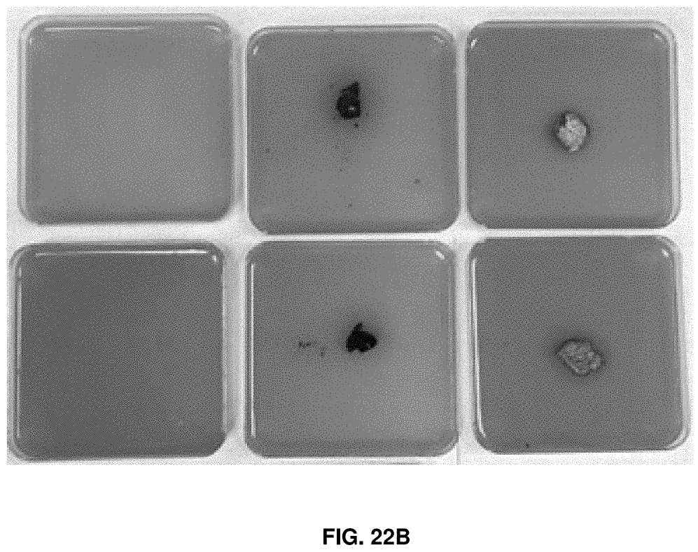

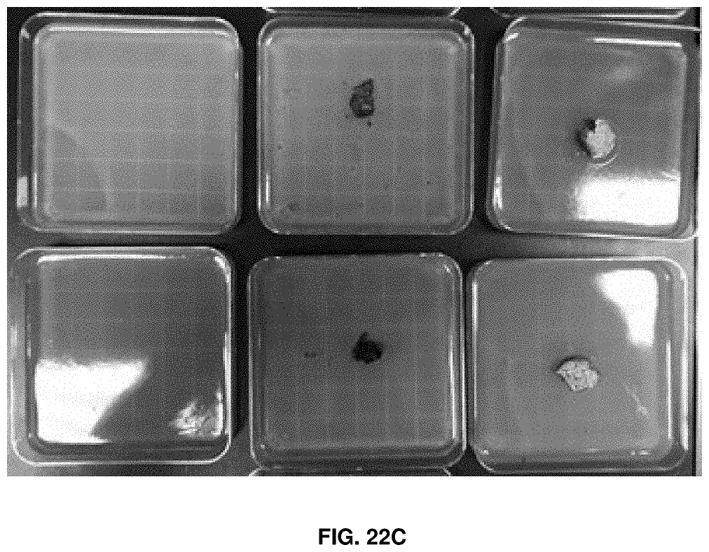

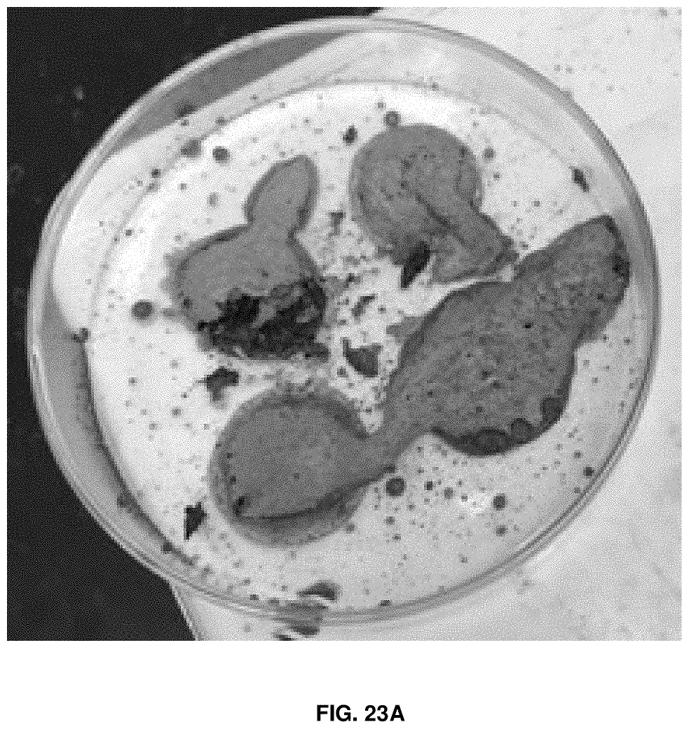

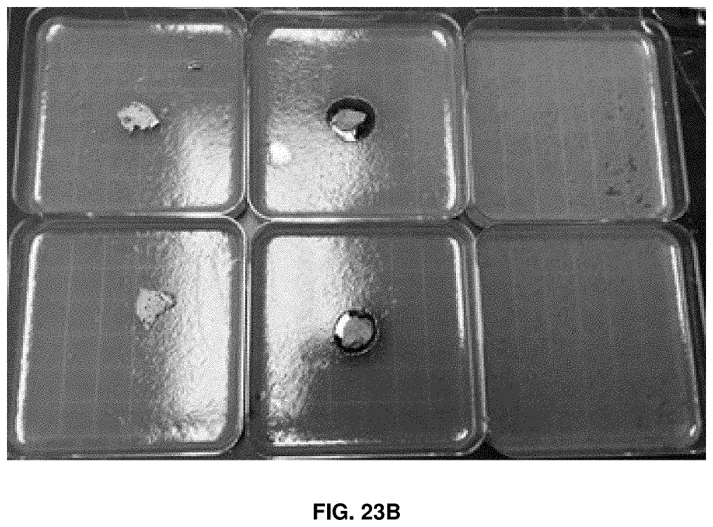

A total of six plates were used with the initial foams made during the precursor and foam experiments (FIG. 22A), including: C1.5-1.5 g copper nitrate foam; C2-2 g copper nitrate foam; Ag1.5-1.5 g silver nitrate foam; Ag3-3 g silver nitrate foam; Control 1—bacteria only; and Control 2—bacteria only. Each plate was filled with standard Sabouraud (SB) agar and plated with 100 μL of SBTop10 E. coli bacterial culture, which was distributed using beads. Samples were then carefully placed onto plates, which were transferred to an incubator at 37° C. Growth was checked at 24 hours (FIG. 22B) and 48 hours (FIG. 22C) post-plating.

As seen in FIGS. 22B-22C, there was a zone around the foams, which demonstrates that the foams deactivated and resisted the bacteria on the plates. The silver foam had a larger zone of inhibition present compared to the copper foam.

Second ZOI Experiment—Silver Foams

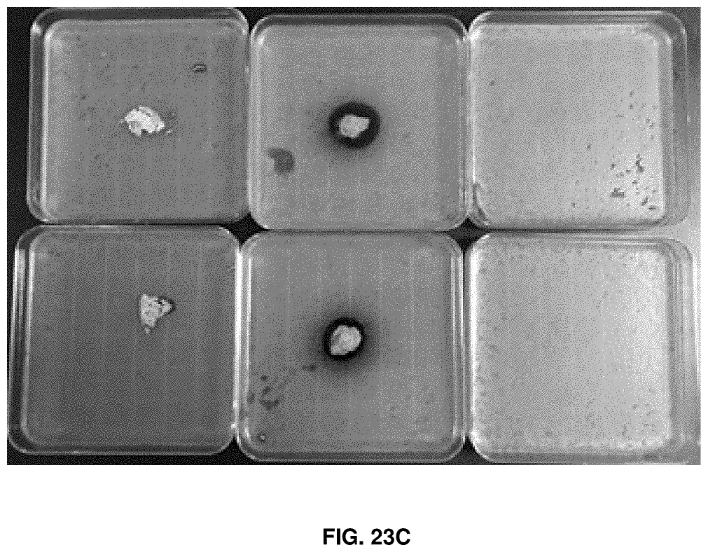

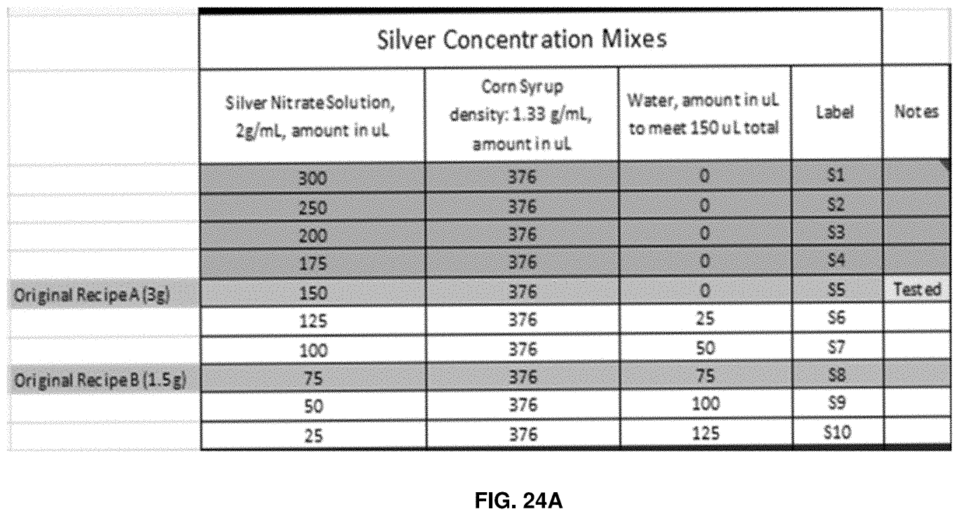

For the second ZOI experiment, a second batch of silver foams (FIG. 23A) was made and plated with bacteria to compare alongside the foams made about four months earlier (referred to as the first batch of silver foams). A total of six plates were used with both the second batch and the first batch foams including: Ag3—#1 (second batch) foam; Ag3—#2 (second batch) foam; Ag3—#1 (first batch) foam; Ag3—#2 (first batch) foam; Control 1—bacteria only; and Control 2—bacteria only. Each plate was filled with standard SB agar and plated with 100 μL of E. coli bacterial culture which was bead distributed. Samples were then carefully placed onto plates, which were transferred to an incubator at 37° C. Growth was checked at 24-hours (FIG. 23B) and 48-hours (FIG. 23C) post-plating.

As seen in FIGS. 23B-23C, the second ZOI experiment included the first batch foams and the second batch foams. The second batch foams (being newer) had more corn syrup compared to the first batch (i.e., older) foams, which were more pure silver. The sugar from the remaining corn syrup in the second batch foams was able to dissolve into the agar on the plates. This can be seen by the dark rings surrounding the foams. It is believed that this helped bring the foams closer and more intact with the agar plates, which, in turn, allowed them to fight off the bacteria more effectively. The first batch foams were very light and had minimal (if any) corn syrup left, so they remained resting on top of the agar and were not sucked into the plate. This can be observed by a smaller zone of inhibition around these foams. It is believed that this is because less silver was contacting the bacteria. When plating the foams onto the plates, they were dropped in areas not directly in the center of the plates and then were immediately moved to the centers. This also proves how effective the silver works to fight off the bacteria (in both the first batch foams and the second batch foams), because small sections where no bacteria grew can be seen on the plates where the foam was dropped in addition to the zone of inhibition around the foam. (FIG. 23C.)

Micro Recipe Testing and Fiberglass Infiltration

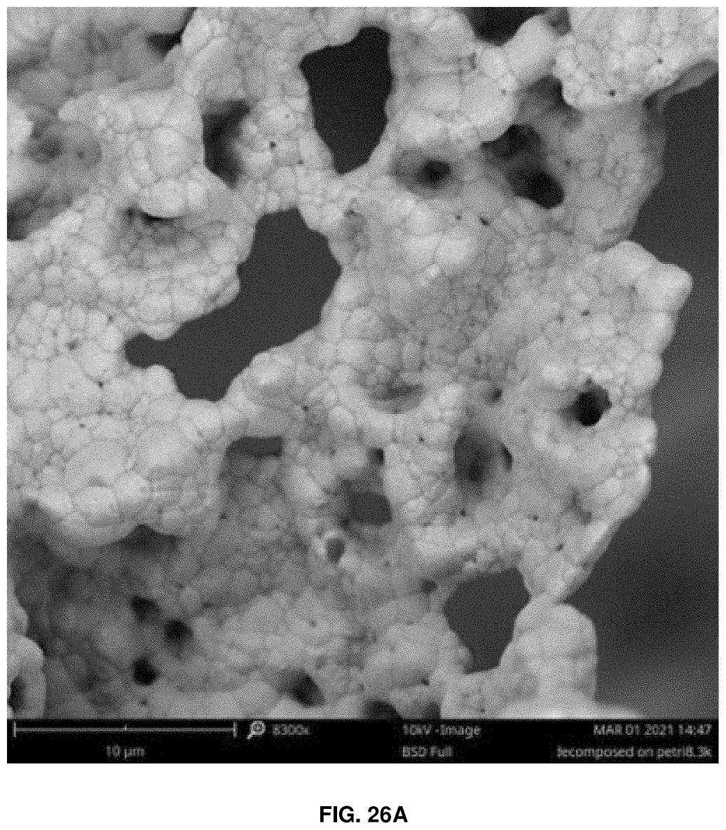

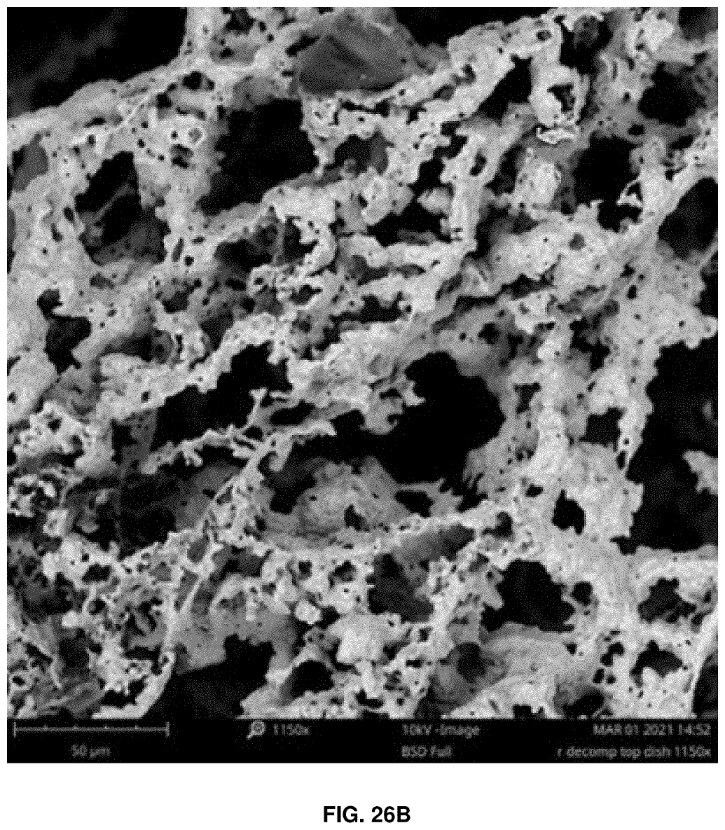

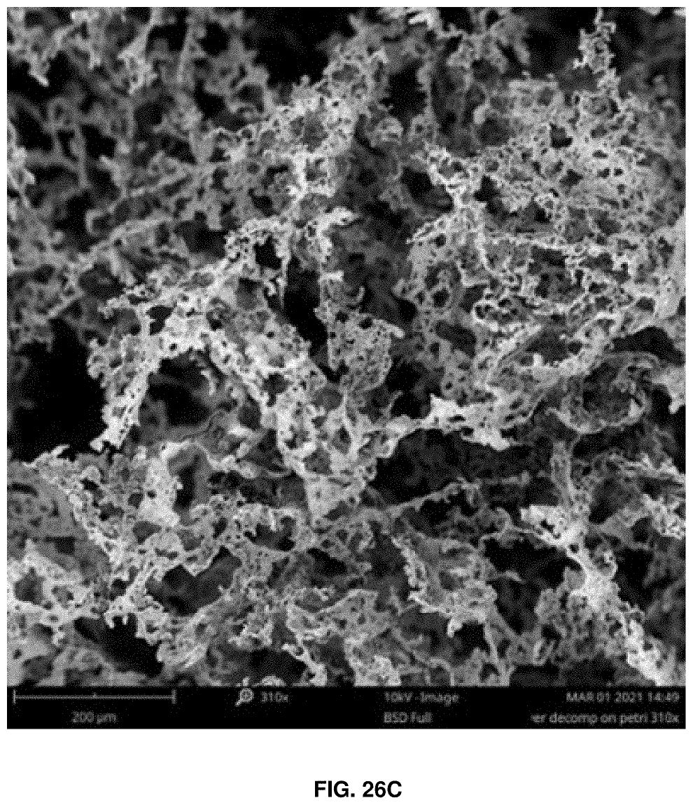

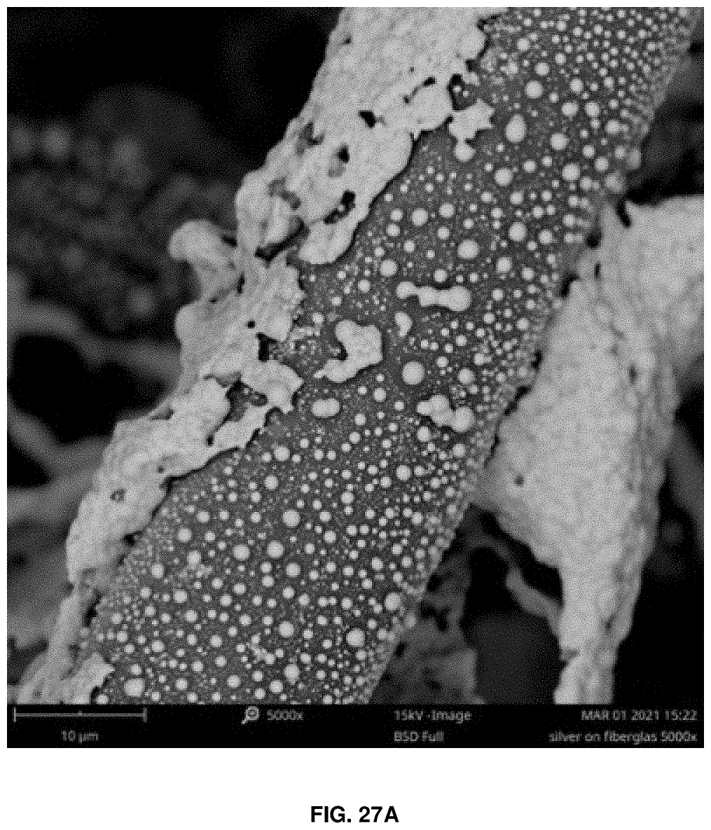

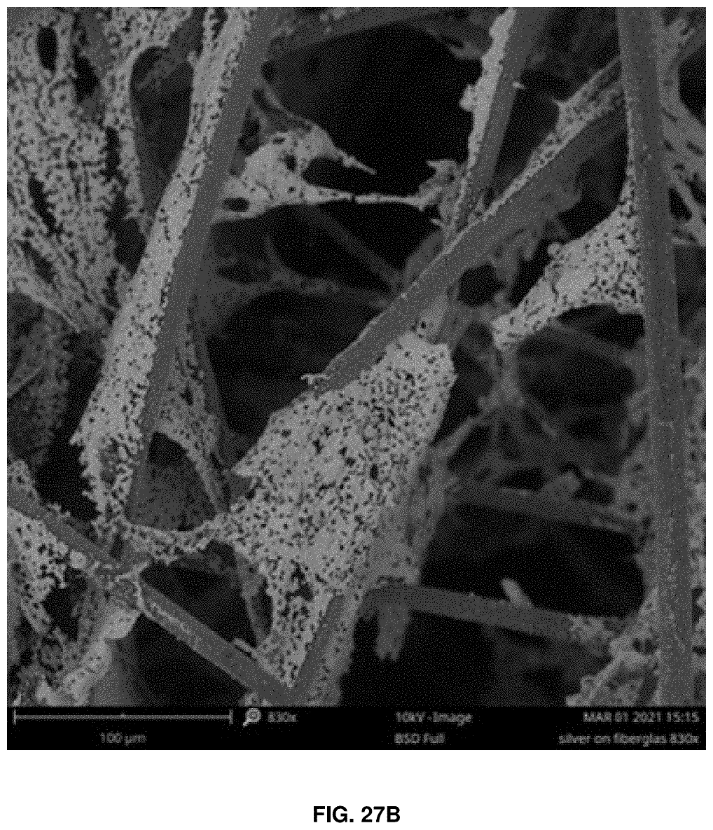

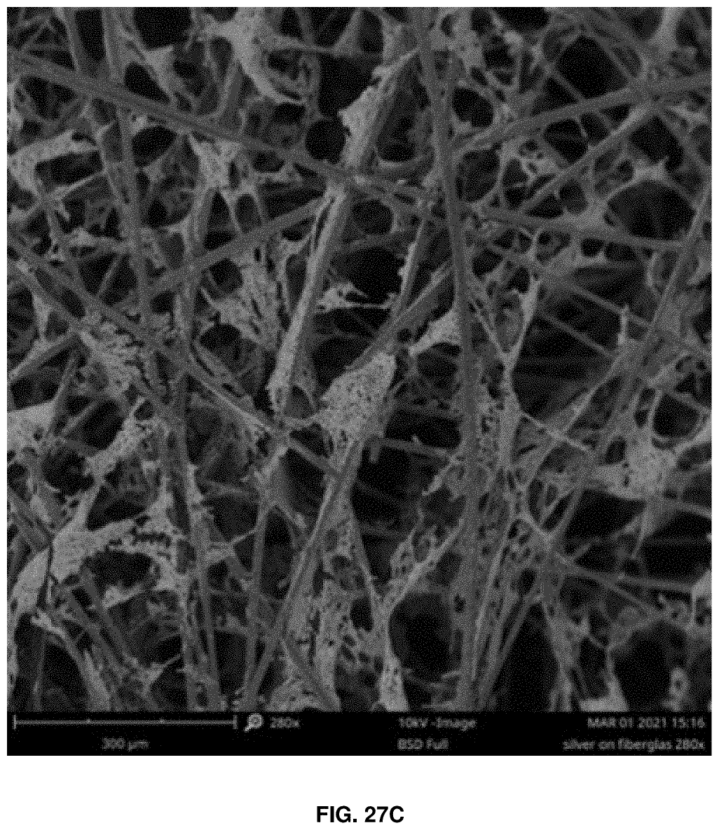

Micro recipe testing and fiberglass infiltration tests were performed to see the effects of changing the silver nitrate and corn syrup concentration without using significant amounts of reagents. In addition, these tests were conducted to quantitatively study methanol dilution. Some of the methanol dilutions were used to infiltrate two weights of non-woven fiberglass: 1.5 oz and 0.75 oz. Some foam (FIGS. 26A-26C) and fiberglass samples (FIGS. 27A-27C) were also scanned using an electron microscope.

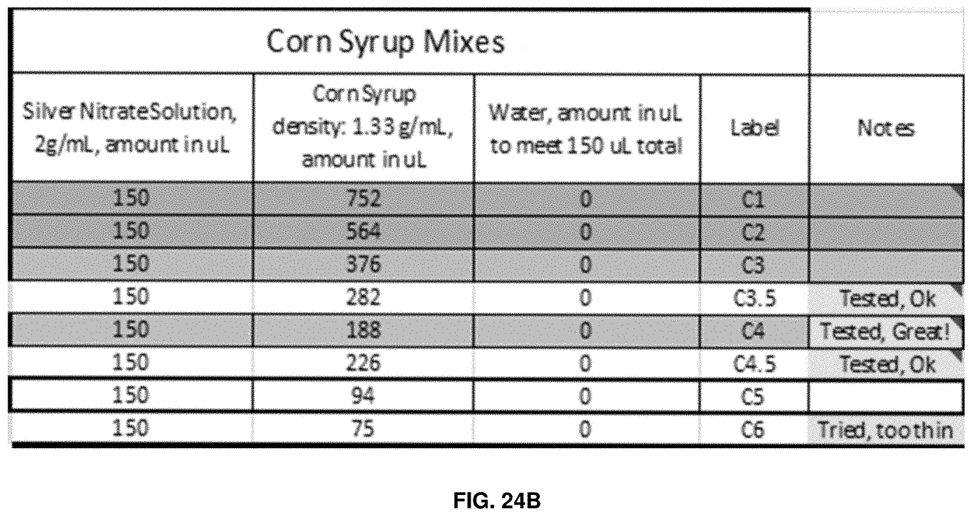

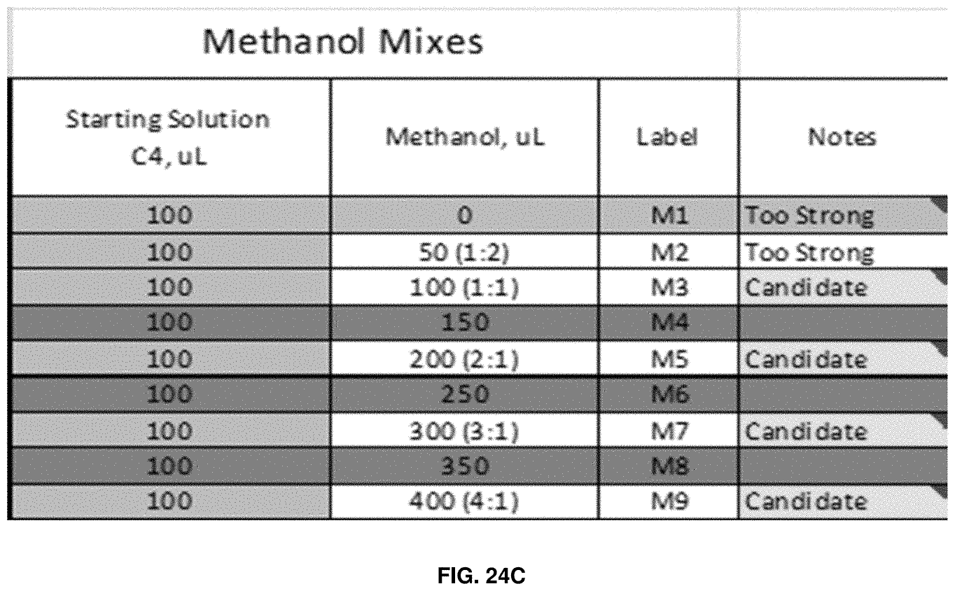

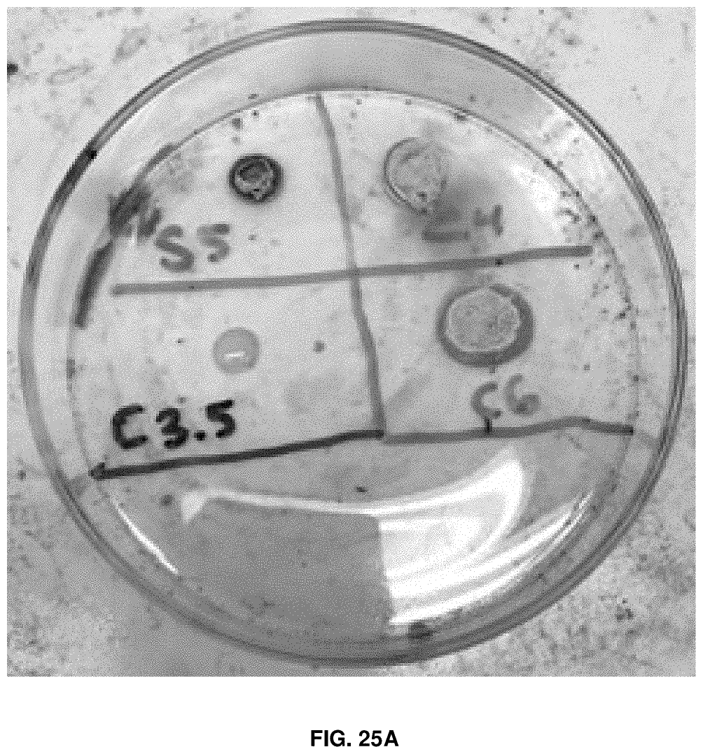

The density of corn syrup (1.33 g/mL) and solubility of silver nitrate in water (2.22 g/mL at 20° C.) were used to make a conversion factor to a tenth of the size for the micro recipes. 2 g/mL of silver nitrate was used to ensure the silver nitrate would fully dissolve at room temperature. All water that was used in this test and subsequent testing for precursor manufacturing was filtered via reverse osmosis and deionized. The different mixes employed during this test are shown in FIGS. 24A-24C. Ratios of the reagents were varied using the following calculations:

$$Recipe A :$$

$$3 g {AgNO}_{3} : 150 μ L \times 2 \frac{g}{m L} {AgNO}_{3} = 0.3 g {AgNO}_{3}$$

$$5 g corn syrup : 0.5 g corn syrup \div 1.33 \frac{g}{m L} = 376 μ L corn syrup$$

$$1.5 g water : 150 μ L water - 150 μ L water in {AgNO}_{3} solution = 0 μ L water$$

$$Recipe B$$

$$1.5 g {AgNO}_{3} : 75 μ L \times 2 \frac{g}{m L} {AgNO}_{3} = 0.15 g {AgNO}_{3}$$

$$5 g corn syrup : 0.5 g corn syrup \div 1.33 \frac{g}{m L} = 376 μ L corn syrup$$

$$1.5 g water : 150 μ L water - 75 μ L water in {AgNO}_{3} solution = 75 μ L water$$

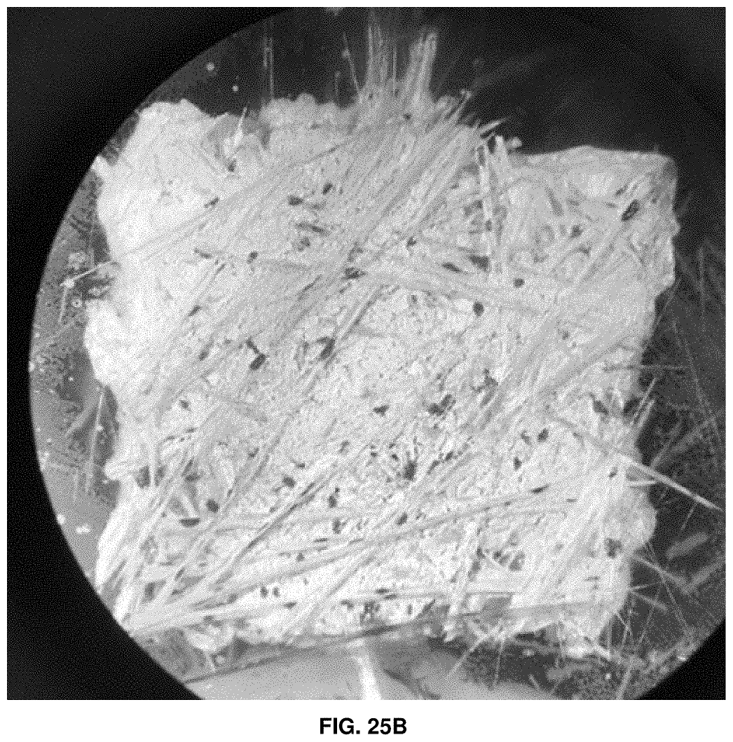

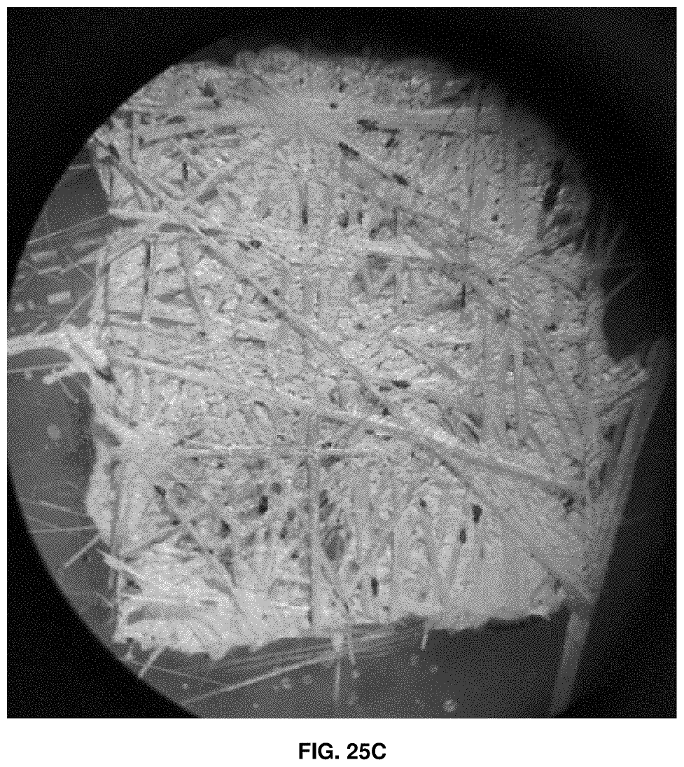

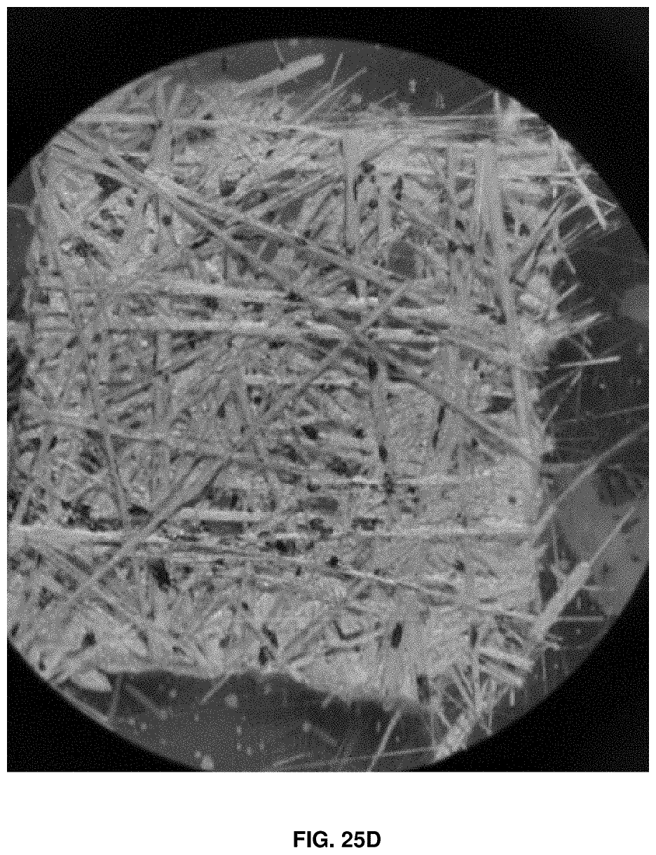

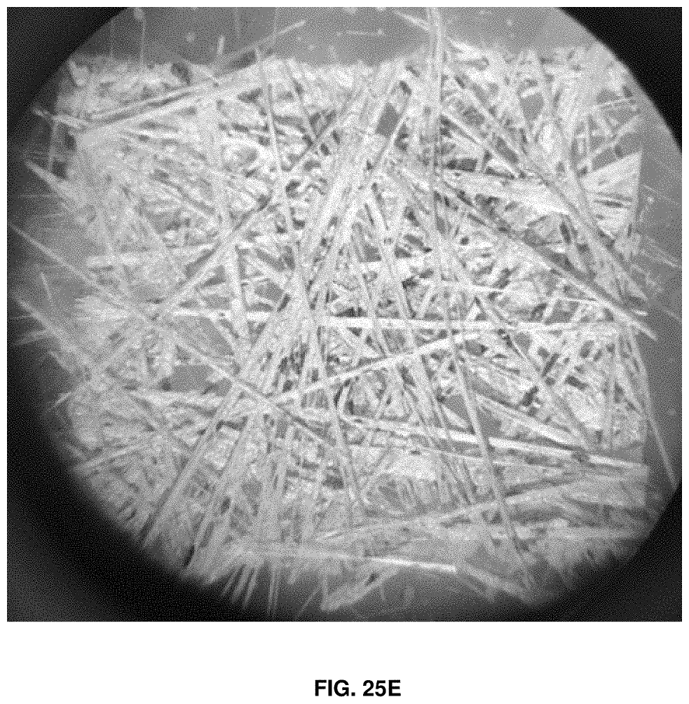

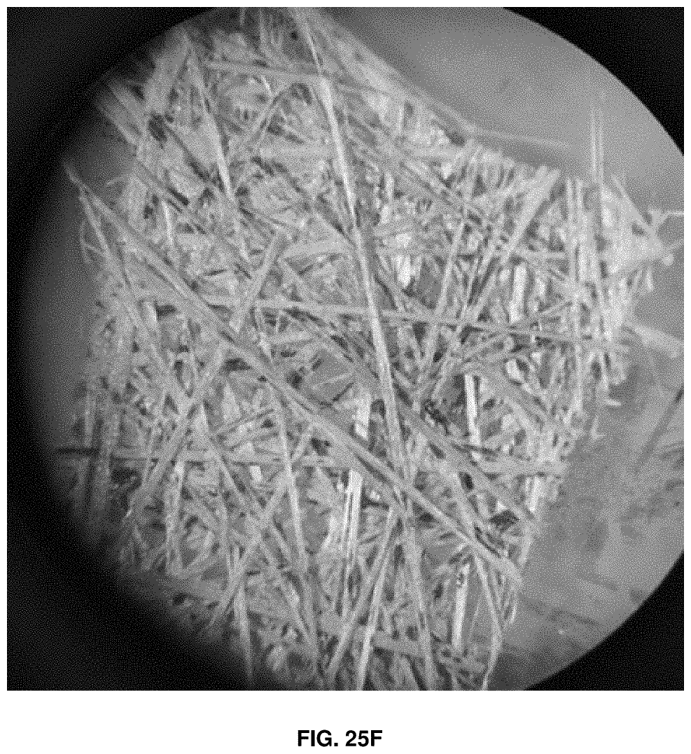

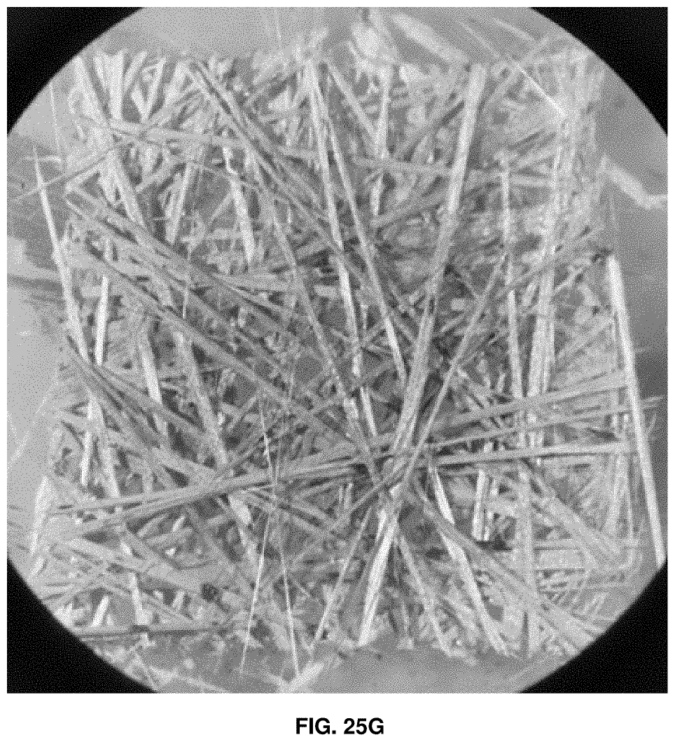

The precursors were tested by making foams on a hot plate and by infiltrating fiberglass pieces to compare them with each other. The fiberglass pieces were infiltrated with six different precursor dilutions. All of these dilutions were made with the C4 recipe and then different amounts of methanol for dilution. FIGS. 25A-25G show different fiberglass pieces with foam having different dilution values. Desirably, this experiment demonstrated that all methanol dilutions worked in producing silver foam on mat pieces. Based on these results, the M9 (1:4) mixture is highly advantageous for use in a filter for antimicrobial purposes. The M9 mixture is diluted to an extent sufficient to permit satisfactory airflow through the filter, whereas a more potent mixture may saturate the fiberglass too much and plug up the open areas in between the fibers.

Third ZOI Experiment—Silver Foams and Fiberglass

For the third ZOI experiment, bacteria were plated with silver foams made using the C4 mix from the previous experiment, as well as infiltrated fiberglass using diluted C4 mix precursor. A total of eleven plates were used with both the silver foam and the infiltrated fiberglass to compare alongside older samples from the previous experiment (shown in the below Table 5).

TABLE 5
ZOI experiment 3 plates

| Plates | # | Notes |
|---|---|---|
| Control | 1 | Bacteria only |
| Control | 2 | Bacteria only |
| C4 Foam (second batch) | 3 | Second batch foam (C4), hotplate around 240° C. |
| C4 Foam (second batch) | 4 | Second batch foam (C4), hotplate around 240° C. |
| M3 Fiber (second batch) | 5 | Second batch M3 mix fiberglass, |
| | | 15 minutes in furnace @ 500° C. |
| M3 Fiber (second batch) | 6 | Second batch M3 mix fiberglass, |
| | | 15 minutes in furnace @ 500° C. |
| C4 Foam (first batch) | 7 | First batch foam (C4), hotplate around 240° C. |
| C4 Foam (first batch) | 8 | First batch foam (C4), hotplate around 240° C. |
| M3 Fiber (first batch) | 9 | First batch M3 mix fiberglass, |
| | | 15 minutes in furnace @ 500° C. |
| Fiber Control | 10 | Fiberglass control, 15 minutes in furnace @ |
| | | 500° C. baked separate from silver samples |
| Fiber Control | 11 | Fiberglass control, 15 minutes in furnace @ |
| | | 500° C. baked separate from silver samples |

The third ZOI experiment was conducted to determine if the infiltrated fiberglass kept the properties previously seen on the silver foams by themselves. The silver foam by itself was also created with the same precursor mix to be plated for a comparison. The precursor was diluted with methanol to make it more spreadable across the fiberglass surface. The fiberglass was baked in the furnace at 500° C. by itself and with the precursor infiltrated. The fiberglass was baked at this temperature to remove any sizing or binding materials that may have been added to it (since it was a nonwoven mat). This was done to remove all other materials in the precursor from the foam so as to make the foam as pure (silver) as possible.

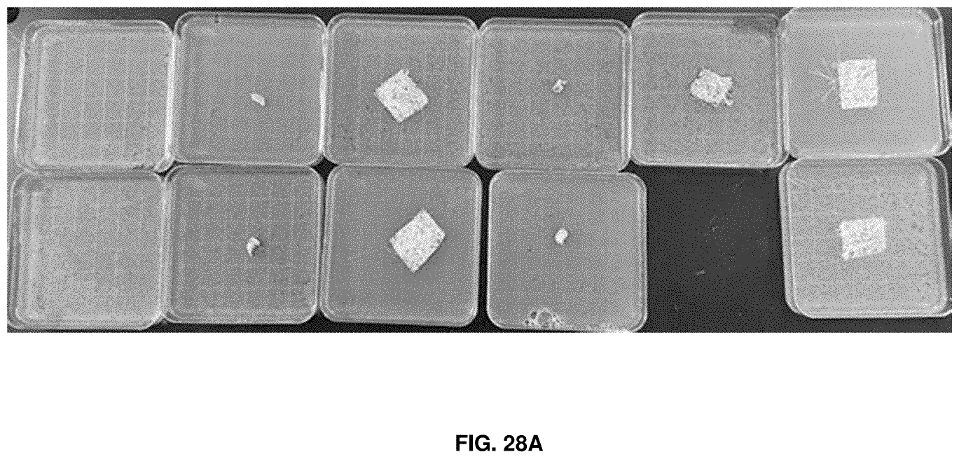

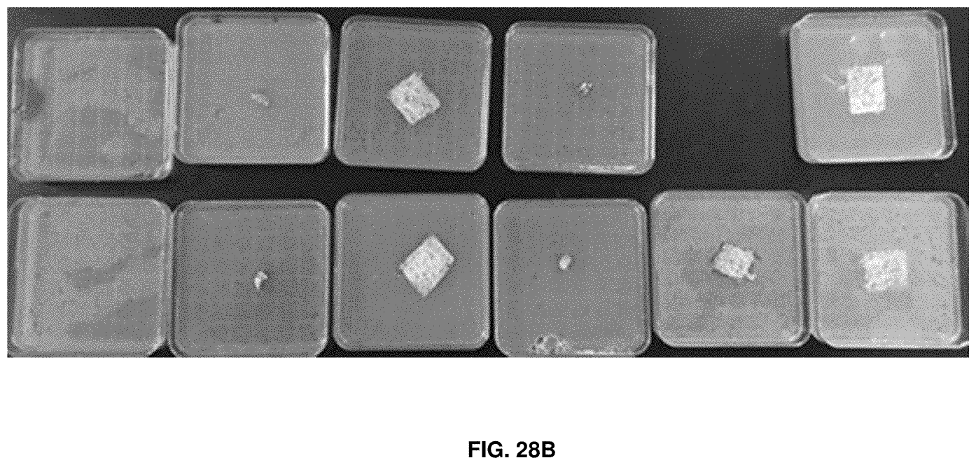

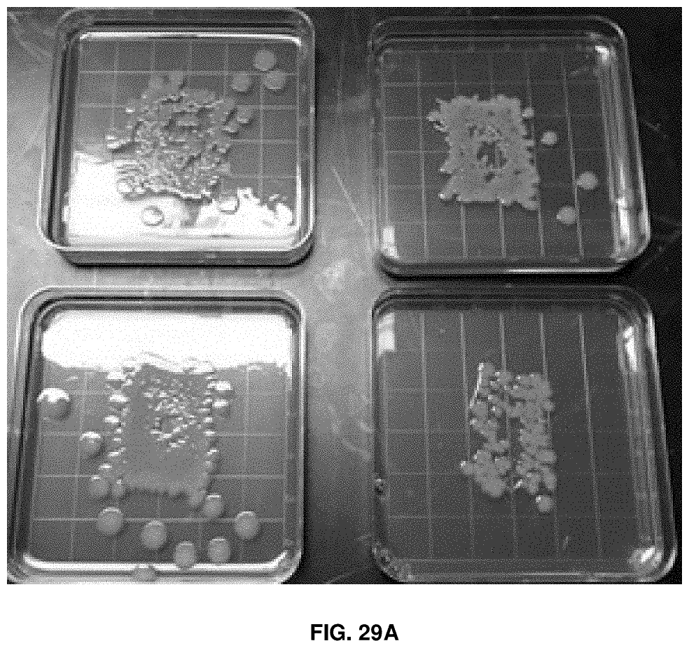

Once the second batch samples were made, they were plated along with first batch foams, a first batch infiltrated fiberglass piece, and fiberglass pieces that were baked but not infiltrated with precursor. These plates were checked at 24 hours (FIG. 28A) and 48 hours (FIG. 28B) post-plating. As shown in FIGS. 28A-28B, there was a small ZOI because of minimal contact. The second batch and first batch infiltrated fiberglass pieces had a small zone around the outside edges, but it was also clear that no bacteria were growing between the fibers and/or on the fibers. The pieces of fiberglass that were baked but not infiltrated showed bacteria growth in and around the fibers. Desirably, this demonstrated that the silver foam is contributing to deactivating and resisting the bacteria. In addition, the properties of the foam were not affected when introduced to a new material and baking technique.

Contact Stamping Experiment

Contact stamping, similar to ZOI, was used to show that bacterial growth was not occurring within a specimen. Bacteria were sprayed on the material and then stamped onto an agar plate immediately, and then 1 minute after, 5 minutes after, and 30 minutes after. If a decrease in bacterial growth is observed when the bacterial remained on the material longer, then the material was deactivating the bacteria. In the contact stamping experiment, a bacteria culture of STAR (Jul. 21, 2015) E. coli was prepared using 25 mL of refrigerated culture to 75 mL SB media mix. This was set in a stirring water bath to incubate for approximately 3.5 hours before being used for plating. Two infiltrated fiberglass sample dilutions (M3 and M9) were baked on to the base of 4 beakers in order to stamp agar plates akin to a paper stamp. All samples of fiberglass were about 0.75 oz in weight and approximately 2×4 cm in size. Each sample of fiberglass received 200 μL of their respective precursor dilution before being baked at 500° C. for 15 minutes in order to produce the foam and adhere the sample to the base of each beaker.

One of each sample dilution was either dried and stamped onto agar plates inoculated with 100 μL of culture, or saturated with 100 μL of culture and stamped onto a bare plate. Each contact stamp was performed gently for 1-2 seconds, where the material was pressed to the plate and then removed. All agar plates (including controls) that received 100 μL of culture were bead distributed. See Table 6 for listings:

TABLE 6
Contact stamping plates

| | M3 (1:1) | M3 (1:1) | M9 (1:4) | M9 (1:4) | |
|---|---|---|---|---|---|
| | Wet | Dry | Wet | Dry | |
| Time | Stamp | Stamp | Stamp | Stamp | Controls |
| Immediately | 1 | 5 | 9 | 13 | 17, 18 (Timing |
| 1 minute | 2 | 6 | 10 | 14 | N/A, bacteria |
| 5 minutes | 3 | 7 | 11 | 15 | only) |
| 30 minutes | 4 | 8 | 12 | 16 | |

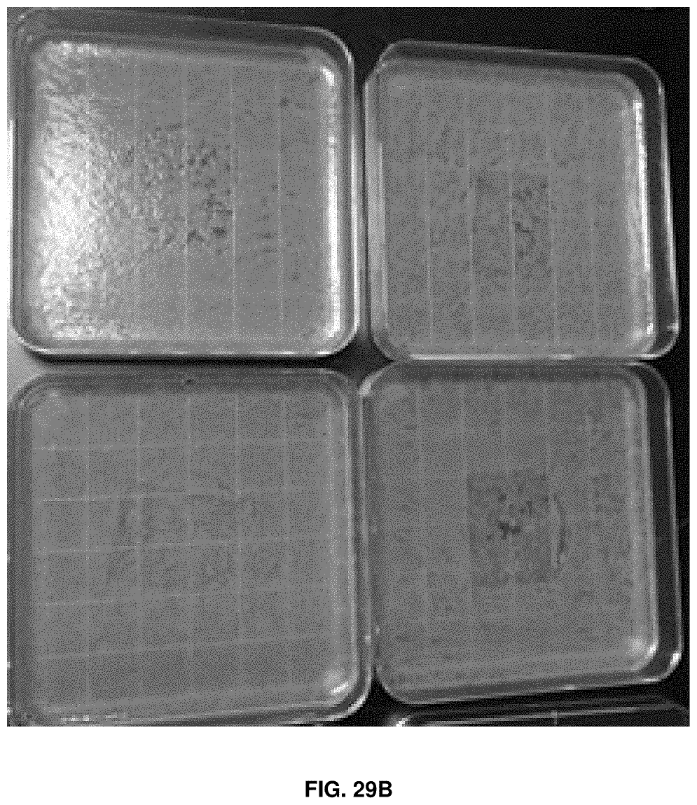

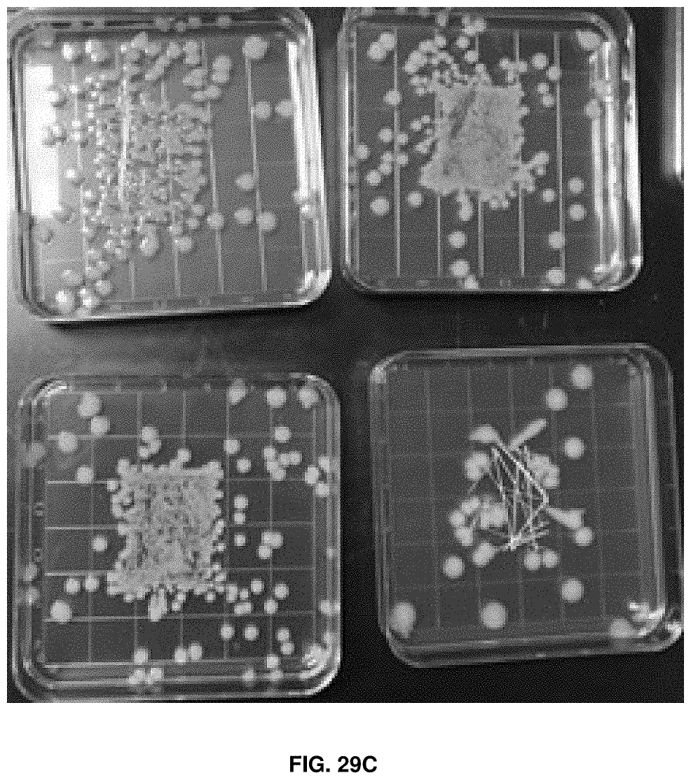

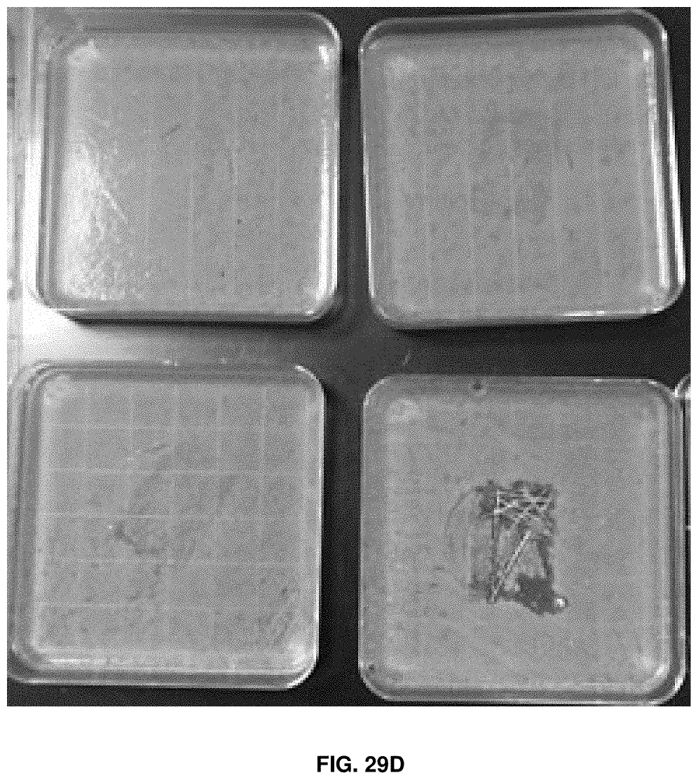

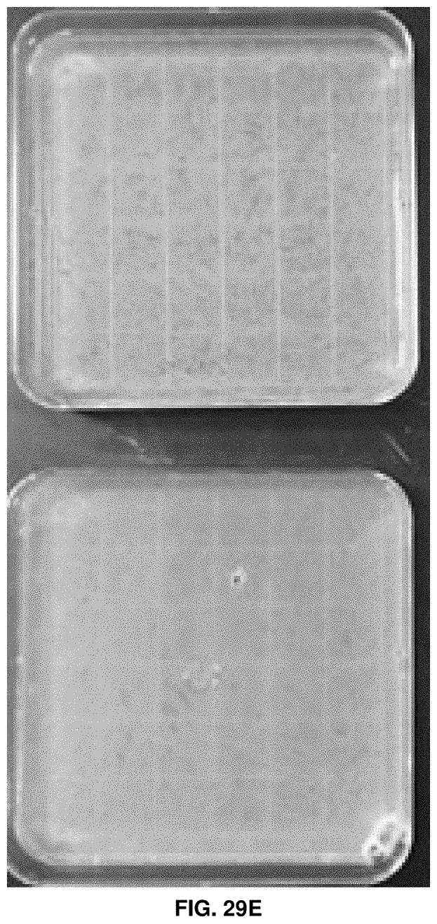

Two different methods were utilized in the contact stamping experiment. For the first method, bacteria were pipetted directly onto an infiltrated piece of fiberglass. Then, the infiltrated piece of fiberglass was stamped onto bacteria-free agar plates. For the second method, bacteria were pipetted onto an agar plate. Next the bacteria-free infiltrated piece of fiberglass was stamped onto the plate. FIGS. 29A and 29C detail the results from the first method. Desirably, as time progressed, there were fewer colonies of bacteria present. FIGS. 29B and 29D illustrate the results from the second method. There was a faint outline from the stamp in each of the plates but nothing too significantly different between them as time went on. The control plates are shown in FIG. 29E. The infiltrated pieces on the plate assisted in deactivating bacteria when compared to the other plates.

First Airflow Experiment—Chemical Fume Hood

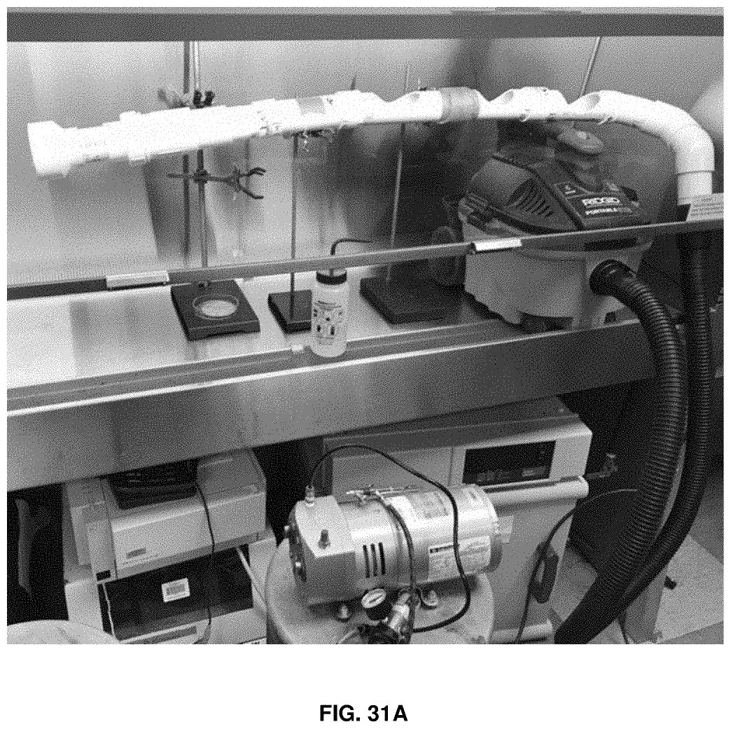

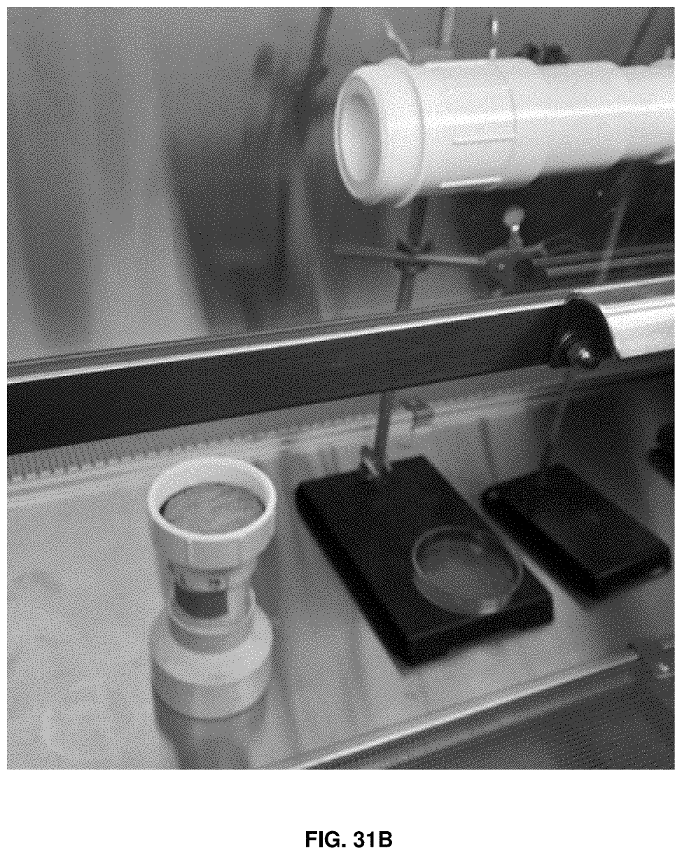

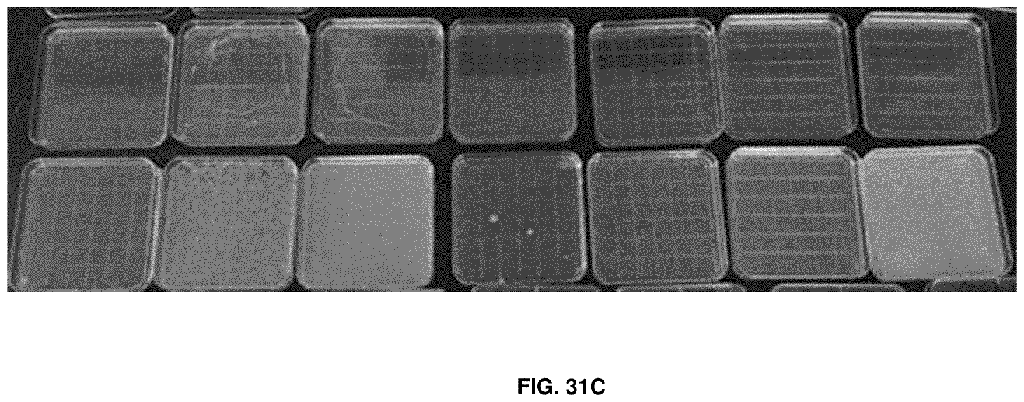

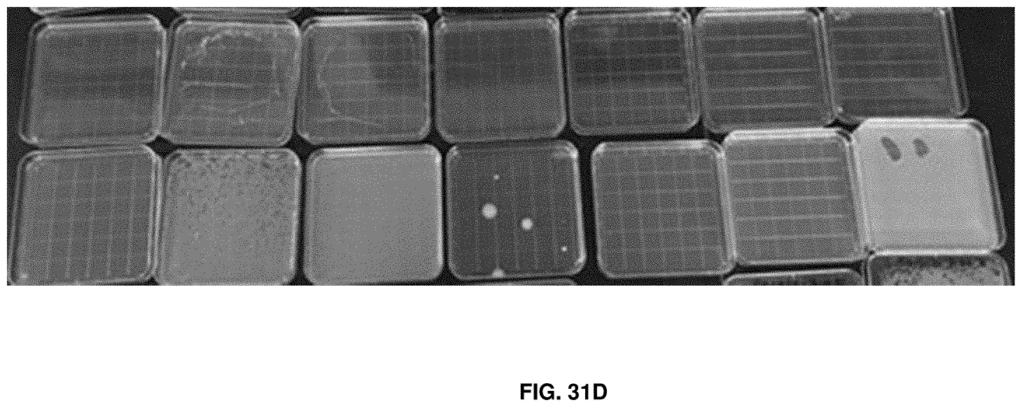

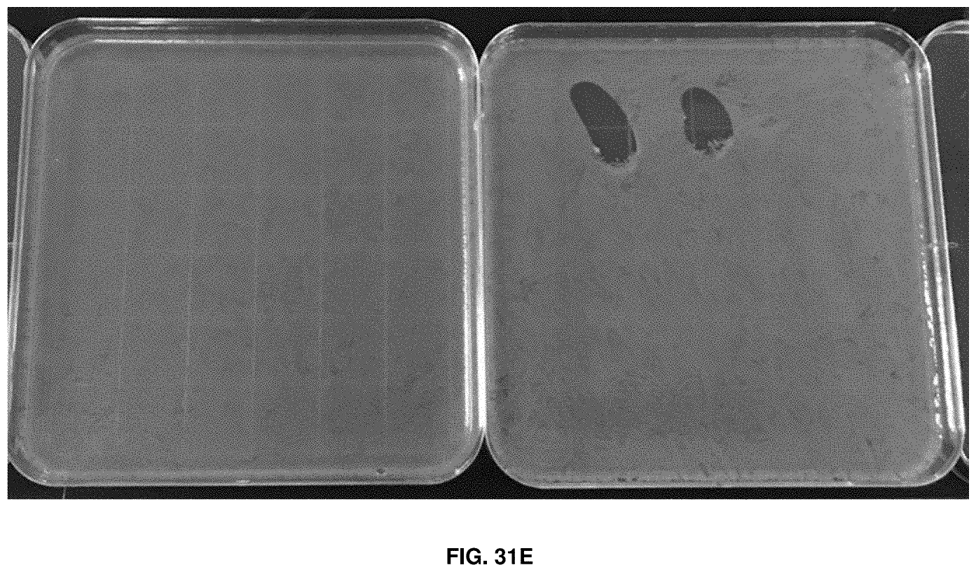

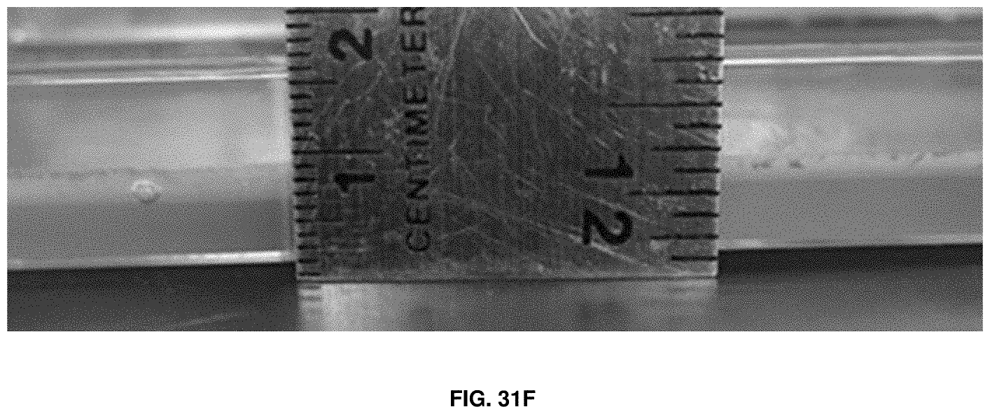

Testing airflow through the filter material was done to make sure the product could stand up to the flow as well as not occlude the air from going through. The filter was used in combination with an airflow system (shown in FIG. 31A) capable of pulling between 18-20 CFM. The airflow was measured throughout, and the filter was checked to see if any of the material had flaked away.

For the first airflow experiment, a bacterial culture of DH5α/pET201 E. coli was prepared using 25 mL of refrigerated culture to 75 mL SB media mix. The bacterial culture was set in a stirring water bath to incubate for approximately 3.5 hours before being used for plating. This strain had a plasmid which provided the bacteria resistance to the antibiotic kanamycin. The main agar plates utilized in this experiment were also prepared with kanamycin (SB50K). This was to prevent the growth of most airborne bacteria, militating against them from substantially influencing the results. If the silver foam produces a significant antibacterial effect, it kills the aerosolized culture as well as airborne microorganisms. In addition, this test also utilized two air control SB plates: one present inside the bottom of the vacuum waste reservoir with no silver filters, and one present inside the bottom of the vacuum waste reservoir with the silver filters.

In order to create a bacterial aerosol, an airbrush was used along with an air compressor. This was to avoid possible effects from propellants found in products, such as canned air for computer dusting, that could have killed the aerosolized culture. When the culture had grown sufficiently, a small amount (roughly 50 mL) of culture was dispensed into the airbrush reservoir and used for spraying 6-12 inches away and directed towards the system intake for approximately 1 second.

The fiberglass filters were manufactured using 630 μL of the M9 (1:4) precursor dilution, which was pipetted on to two separate 3-inch diameter discs cut out of the 0.75 oz fiberglass material. Both samples were baked at 500° C. for about 15 minutes in order to produce activated filters ready for use in the airflow setup.

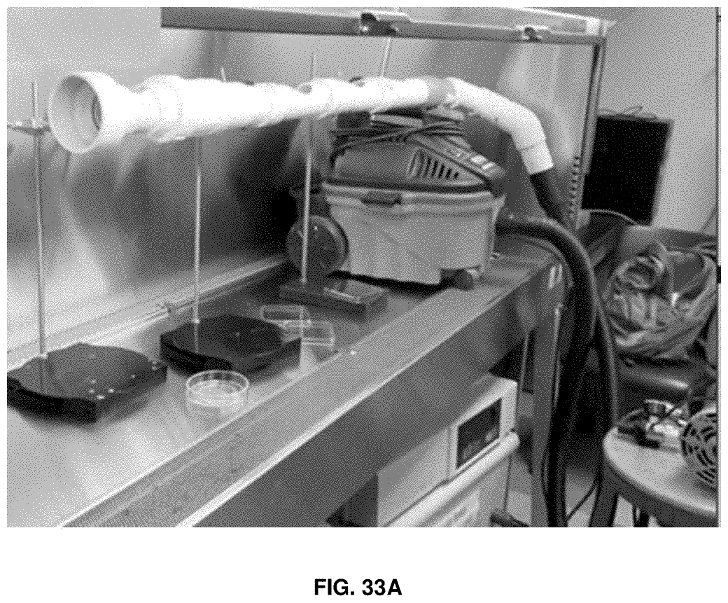

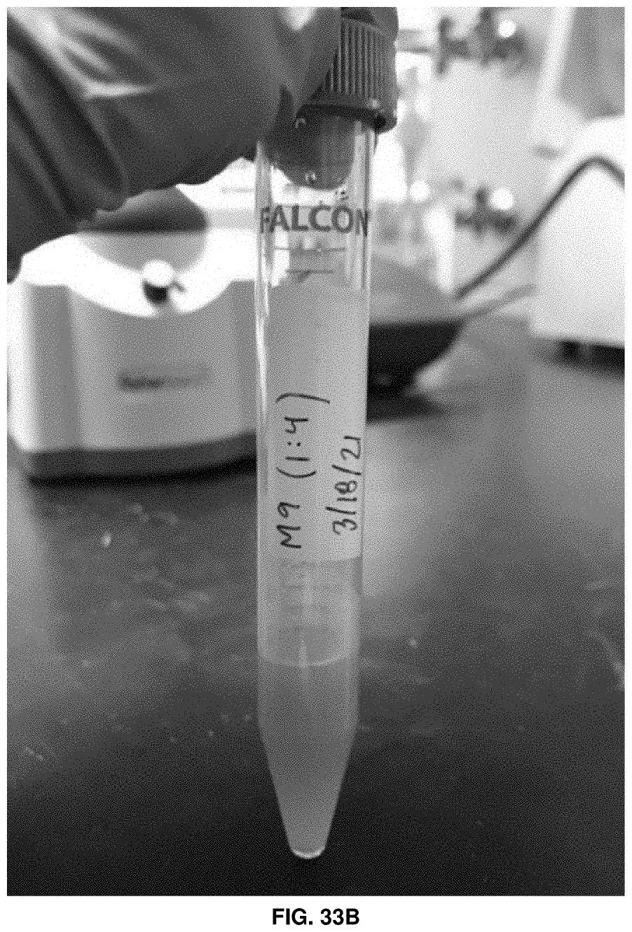

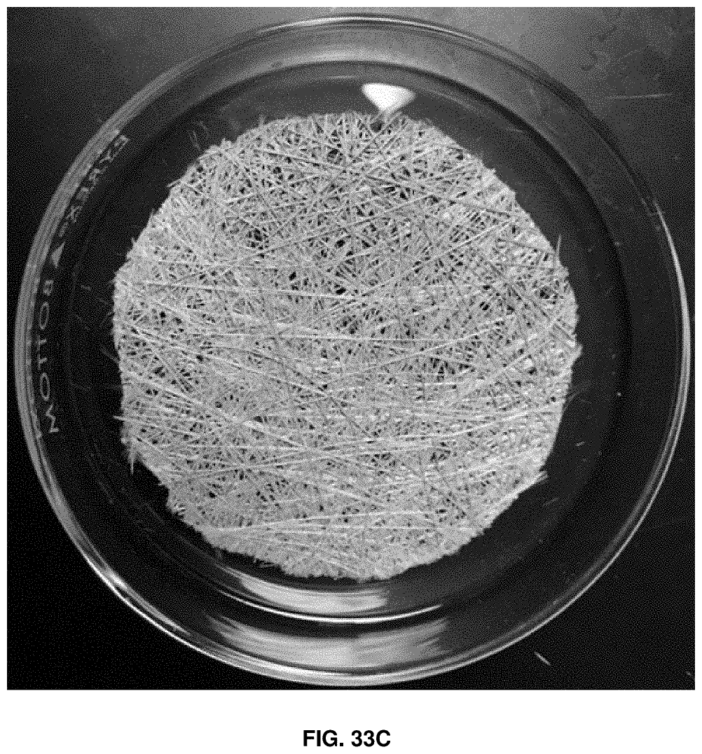

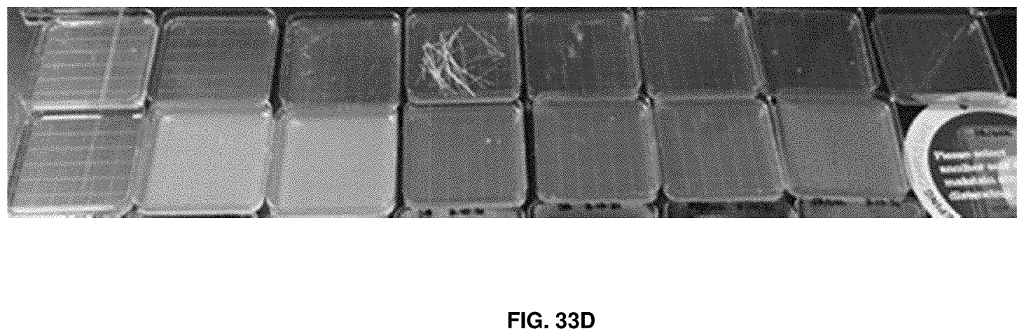

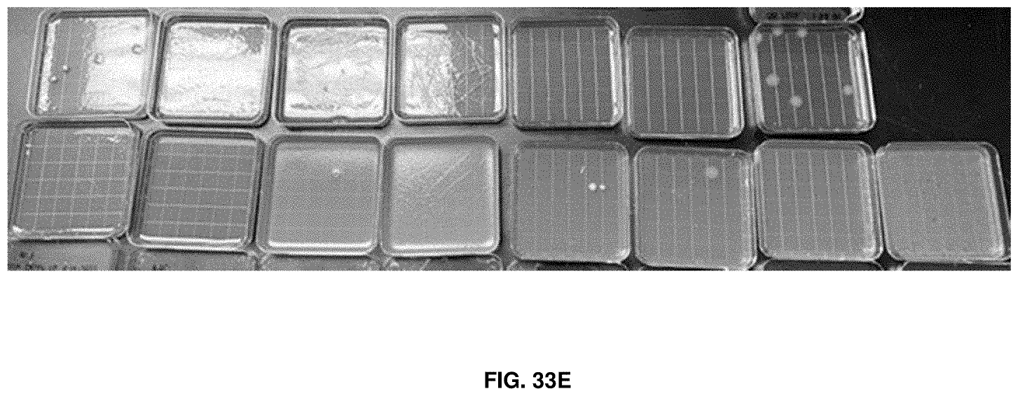

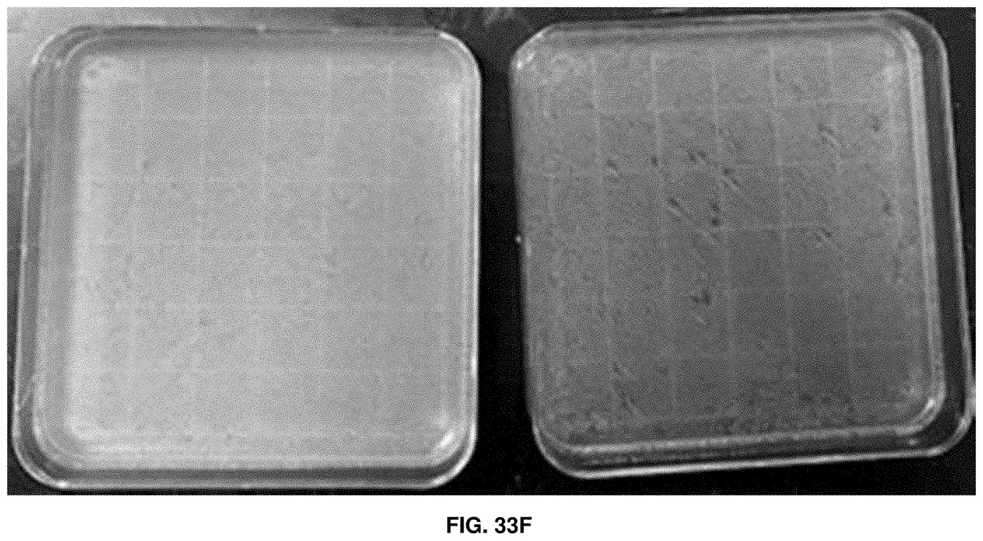

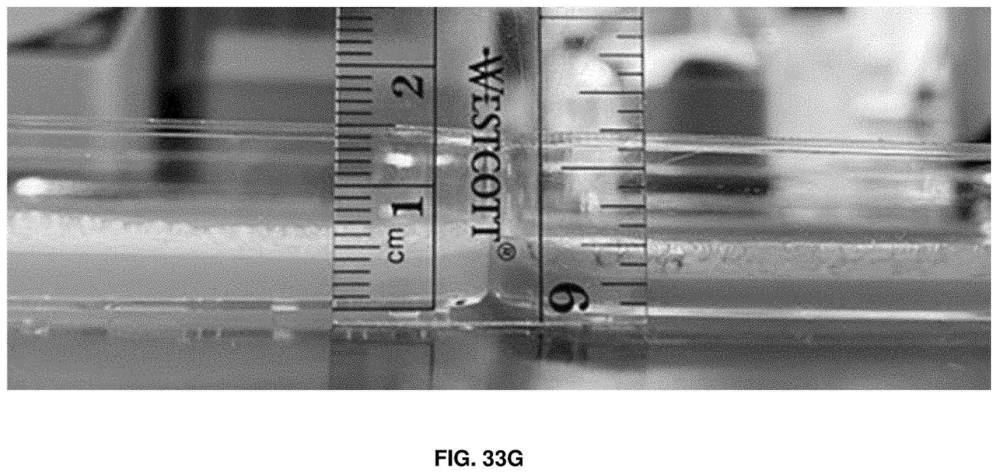

The airflow system included a shop vacuum as a pump. (FIG. 33A) The airflow speed was reduced through a filter cartridge using a series of large holes in the piping between the cartridge and shop vacuum. The shop vacuum was configured to pull about 110 cubic feet of air per minute (CFM). The piping size of the airflow system was two inches in diameter. Per the ratio of pipe diameters (see calculation below), it was determined that approximately 20 CFM needed to flow through the intake cartridge.

$$( \frac{2 inch pipe}{5 inch pipe} ) \times 50 CFM = 20 CFM$$

All parts of the system except for the outside of the shop vac were cleaned with hot soapy water, then wiped with ethanol as needed and allowed to dry before use. The filter cartridge was also a PVC fitting known as a pipe repair adapter. This type of cartridge was utilized due to having space to incorporate multiple layers as well as a screw-on cap with an O-ring seal. To get the correct airflow through the intake of the filter cartridge, the system was assembled with a Bluetooth airflow meter and used different numbers of multiple sizes of holes until the airflow was close to 18-20 CFM. However, the variation in the measured flow rate remained high due to the proximity to the fume hood and normal air circulation. Before adjustment by incorporating different size holes, airflow measurements were on the order of 100 CFM. After adjustments, these airflow measurements were between 17-40 CFM. In addition, the airflow measurements did not appear to be significantly affected by the addition of the two filter layers.

Three different methods were used to determine where bacteria were traveling throughout the system: sterile wet swabbing; dry contact stamping with silver filters (used in Airflow Experiments 2 and 3); and open plates in the vacuum reservoir.

The airflow test used the following technique: 1) plates were loaded into vacuum reservoir, the lids were removed, and the system was closed; 2) the vacuum and compressor were turned on; 3) bacterial aerosol was sprayed approximately 6-12 inches away and directed towards the intake for roughly 1 second; 4) the vacuum was kept on for 90 seconds during post-spray to ensure the aerosol had traveled the length of the system, and the vacuum and compressor were turned off; 5) the plates inside the vacuum were closed as aseptically as possible; and 6) wet swab testing was performed on key areas in the system.

In addition, before the test, one of the air control SB plates was placed inside the vacuum reservoir for the same amount of time without the bacterial aerosol or silver filters. All plates utilized inside the vacuum reservoir were set on the floor of the reservoir and opened for air exposure to capture samples for their allotted time.

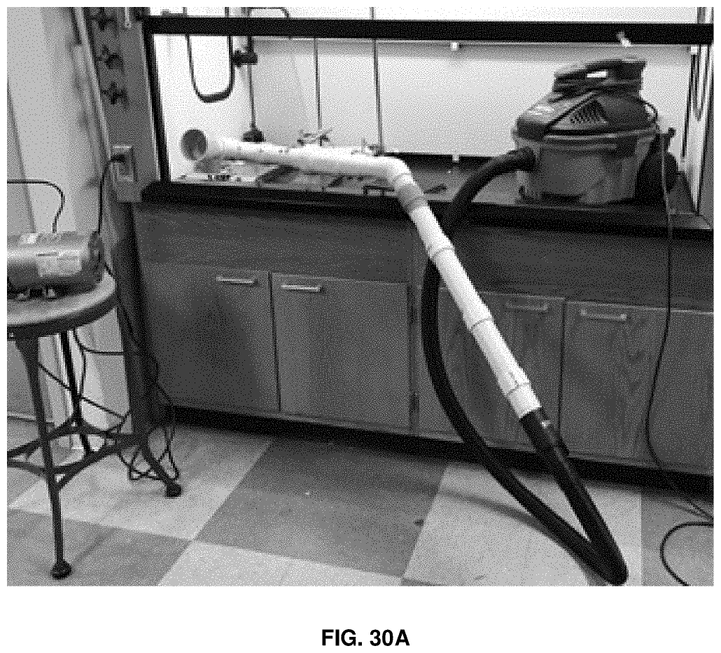

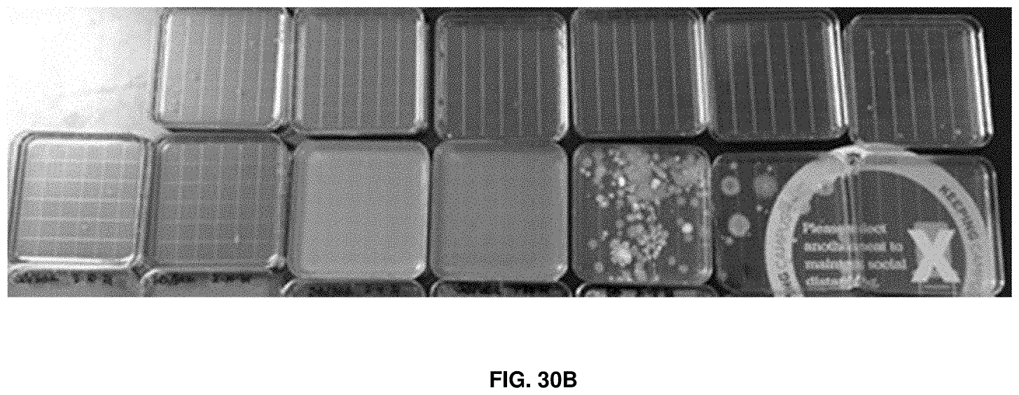

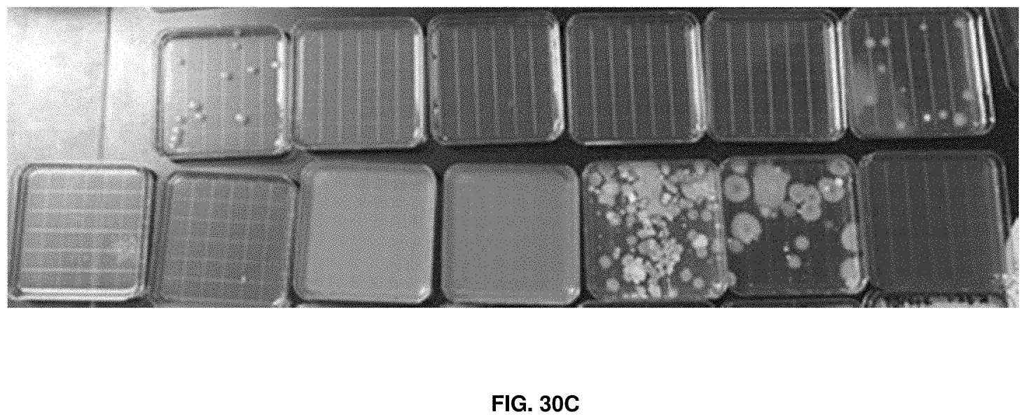

The swabs used in this test also were a single self-contained kit with a bacterial transfer solution. To use each kit, the ampule of bacterial transfer solution was broken, the swab was saturated, then pulled out to take a sample from the system. Each sample of the pipe was thoroughly exposed by moving the swab along the inner pipe circumference through 2 revolutions. Swabs of the filters in this test were performed by rolling the end gently along the entire surface of the filter for 5-10 seconds. After sample collection, each used swab was inserted back into the bacterial transfer solution and agitated thoroughly for 2-5 seconds. 100 μL of the bacterial transfer solution was then pipetted on to each SB50K agar plate and bead distributed. Unless specified otherwise, all plates in this experiment were SB50K plates containing kanamycin. After plates were inoculated or prepared, they were transferred to an incubator at 37° C. Growth was checked at 24 hours (FIG. 30B) and 48 hours (FIG. 30C) post-plating.

The shop vac was attached to a series of PVC pipes to create the airflow the system needed. The bacteria were placed in an airbrush to make it airborne. The whole system was kept under a chemical fume hood to ensure the bacteria that did not make it into the system would be eliminated. Various locations throughout the system were checked to determine if the bacteria were present in any of the locations. Table 7 details these locations and how each sample of bacteria was collected.

TABLE 7
First airflow experiment plates

| # | Plate Location | Notes |
|---|---|---|
| 1 | Intake pipe, circumference | Swabbed 2 revolutions |
| 2 | Filter, intake side | Rolled swab gently 5-10 seconds |
| 3 | Filter, output side | Rolled swab gently 5-10 seconds |
| 4 | Pipe past filter, circumference | Swabbed 2 revolutions |
| 5 | Vacuum inner wall | Rolled swab gently 5-10 seconds |
| 6 | Plate inside vacuum | SB50K plate open during test |
| | with filter during test | |
| 7 | Vacuum output, circumference | Swabbed 2 revolutions |
| 8C | Blank control | No bacteria |
| 9C | Airbrush spray | 1 second of bacteria aerosol |
| 10C | Regular plate | 100 μL culture, bead distributed |
| 11C | Air control without filter | SB plate, 90 seconds exposure |
| 12C | Air control with filter during test | SB plate, 90 seconds exposure |
| 13C | Sterile swab liquid | 100 μL sterile bacterial |
| | | transfer solution, bead distributed |

With respect to FIGS. 30B-30C, bacteria results are shown from the various swabbed parts throughout the system. It can be observed that different colonies were growing on plate 11C. Plate 11C was placed in the bottom of the shop vac while air ran through the system with no filter in place and no bacteria sprayed. Thus, plate 11C shows how many different microorganisms were in the air that was being pulled through the system. Plate 12C was placed in the same spot while the air filter was installed, and bacteria was sprayed. As can be observed, plate 12C had significantly less growth than plate 11C. Therefore, the installed air filter was filtering out microorganisms that were not included in the spray. The sprayed bacteria were seen on the plate swabbed at the intake part of the system, but not on any other subsequent plates throughout the system. Desirably, this demonstrates that the sprayed bacteria made it into the system and was filtered out by the air filter. It should be noted that that the growth on the plates that showed up after 24 hours was likely due to contamination when the plates were checked at the 24-hour mark (as shown in FIG. 30C).

Second Airflow Experiment—Biosafety Cabinet

For this experiment, a bacterial culture of DH5α/pET201 E. coli was prepared using 25 mL of refrigerated culture to 75 mL SB media mix and set in a stirring water bath to incubate for approximately 3.5 hours before being used for plating. The plates are shown after 24-hour growth (FIG. 31C) and 48-hour growth (FIG. 31D-31F) post-plating. This strain had a plasmid which gave the bacteria resistance to the common antibiotic kanamycin. All parts and techniques in the second airflow experiment were the same as in the first airflow experiment unless noted otherwise below.

The water bath used to incubate bacteria was replaced with a hotplate. The hot plate contained a small water bath in a beaker and a magnetic stir bar in the Erlenmeyer flask, which contained the culture medium. The stir bar was also disinfected before use by being washed in warm soapy water, then thoroughly saturated with 95% ethanol, and allowed to dry prior to immersion inside the bacterial culture. A thermometer was used inside the water bath to maintain temperature at or below 37° C.

Also, a biosafety cabinet was used in order to reduce airborne bacteria that could influence the test results. In addition, the swabs kits were replaced with flocked cell collection swabs, along with sterile water pipetted into microcentrifuge tubes. The swab sample collection technique and plate inoculation remained the same except for the filters, which were physically stamped (gently pressed, then removed) on to the agar plates (similar to the contact stamping experiment). Further, the intake of the filter was changed to a straight pipe to allow for better bacteria contact with the filter. Lastly, an additional plate was added (14C) which was plated with 100 μL of bacterial culture and bead distributed before being added during the airflow test with the filter. This was to determine if there were possible effects from airborne silver nanoparticles. FIGS. 31A-31B show the HVAC simulation system used in the second airflow experiment.

As shown in the below Table 8, various locations within the system were checked to determine if bacteria were present. Plate 14C was added during this test to determine if any airborne silver particles left the filter and made it to the shop vac. Desirably, the results did not show silver particles on plate 14C, which demonstrates that the filters remained intact and did not break apart with the airflow strength. It should also be noted that plate 14C was accidentally touched (FIGS. 31D-31E), which is why there were two areas on plate 14C (resembling two fingertips, as seen in FIG. 31E) where there was no bacteria growth.

TABLE 8
Second airflow experiment plates

| # | Plate Location | Notes |
|---|---|---|
| 1 | Intake pipe, circumference | Swabbed 2 revolutions |
| 2 | Filter, intake side | Physically stamped on to plate |
| 3 | Filter, output side | Physically stamped on to plate |
| 4 | Pipe past filter, circumference | Swabbed 2 revolutions |
| 5 | Vacuum inner wall | Rolled swab gently 5-10 seconds |
| 6 | Plate inside vacuum with filter | SB50K plate open during test |
| | during test | |
| 7 | Vacuum output, circumference | Swabbed 2 revolutions |
| 8C | Blank control | No bacteria |
| 9C | Airbrush spray | 1 second of bacteria aerosol |
| 10C | Regular plate | 100 μL culture, bead distributed |
| 11C | Air control without filter | SB plate, 90 seconds exposure |
| 12C | Air control with filter during test | SB plate, 90 seconds exposure |
| 13C | Sterile swab liquid | 100 μL sterile bacterial transfer |
| | | solution, bead distributed |
| 14C | Regular plate inside vacuum with | 100 μL culture, bead distributed |
| | filter during test | |

Swab Method Testing

The swab methods used in the first airflow experiment and the second airflow experiment were compared in order to see if they had affected any of the results. A bacterial culture of DH5α/pET201 E. coli was prepared using 25 mL of refrigerated culture to 75 mL SB50K media mix (containing kanamycin) and set in a stirring water bath to incubate for approximately 4 hours before being used for plating. After the bacterial culture had grown sufficiently, a small amount was used to fill the airbrush reservoir. A blank petri dish containing no agar was then directly sprayed with the airbrush for 2-3 seconds. Each method was tested by swabbing half of the plate thoroughly with each swab type: the self-contained swab kit used in the first airflow experiment, and a sterile flocked swab with sterile filtered water in a microcentrifuge tube. After the samples were taken, the swabs were put back into their respective solutions and agitated for 5-10 seconds. Then, 100 μL of the inoculated solution was pipetted on to agar plates and bead distributed. A standard control plate was inoculated with 100 μL of the bacterial culture itself. After all plates were inoculated, they were transferred to an incubator at 37° C. and checked for growth at 24 and 48 hours post-plating. The swab method testing plates are listed in Table 9 below.

TABLE 9
Swab method testing plates

| Name | Type/Method | Notes |
|---|---|---|
| SW | Sterile water, flocked swab | 100 μL inoculated swab solution, |
| | | bead distributed |
| SK | Swab kit | 100 μL inoculated swab solution, |
| | | bead distributed |
| C | Control | 100 μL culture, bead distributed |

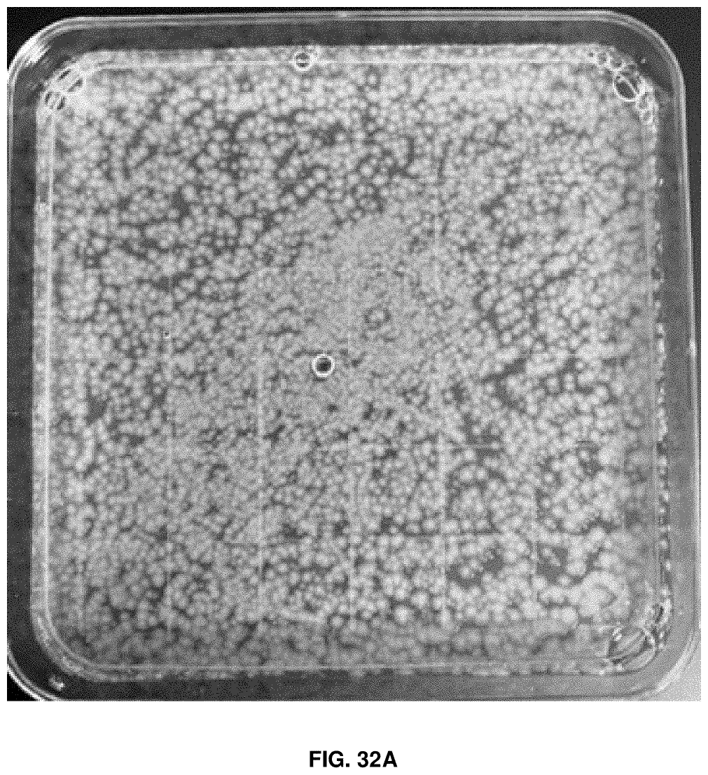

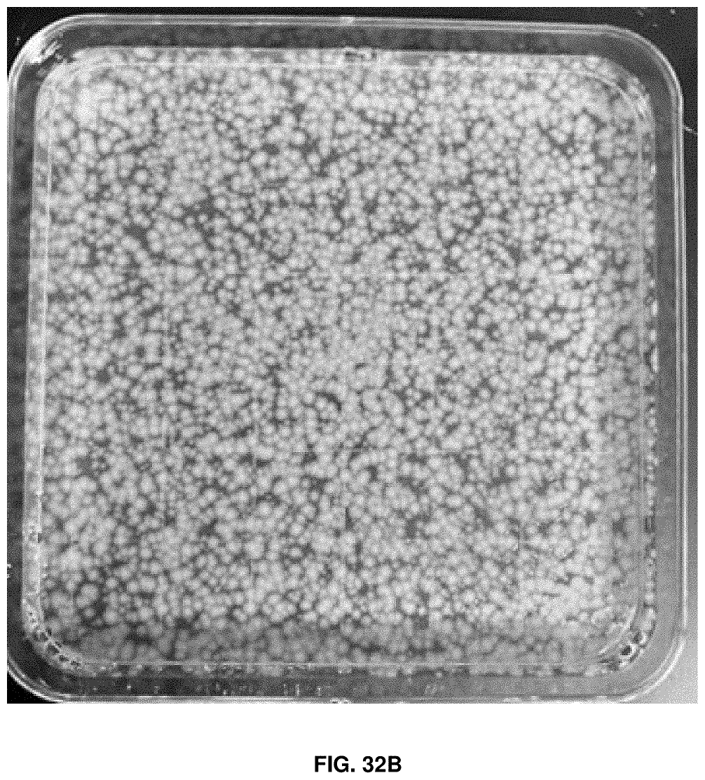

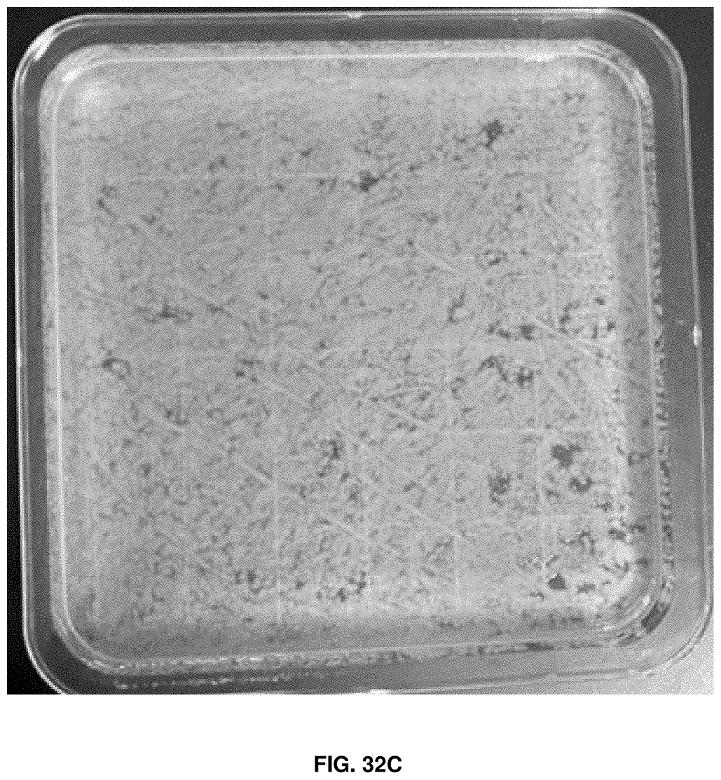

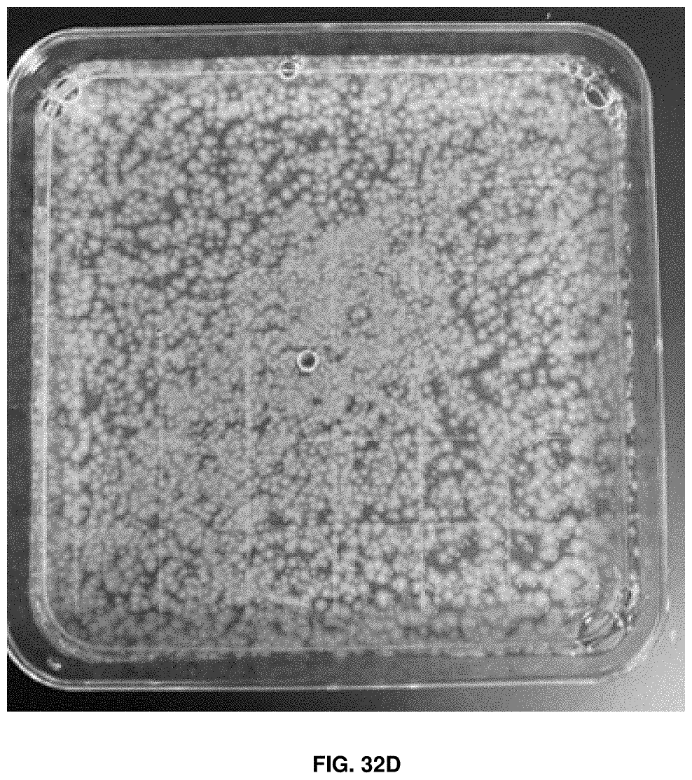

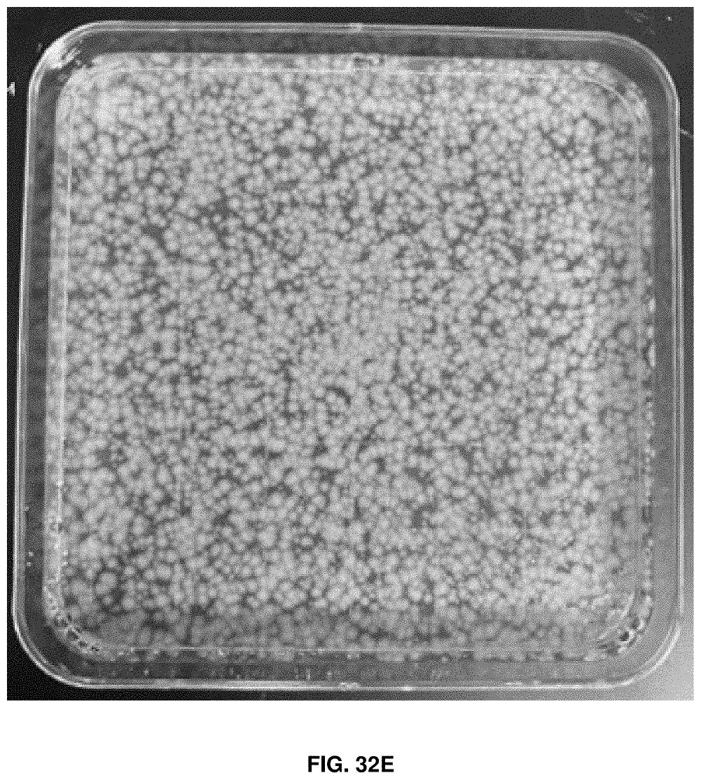

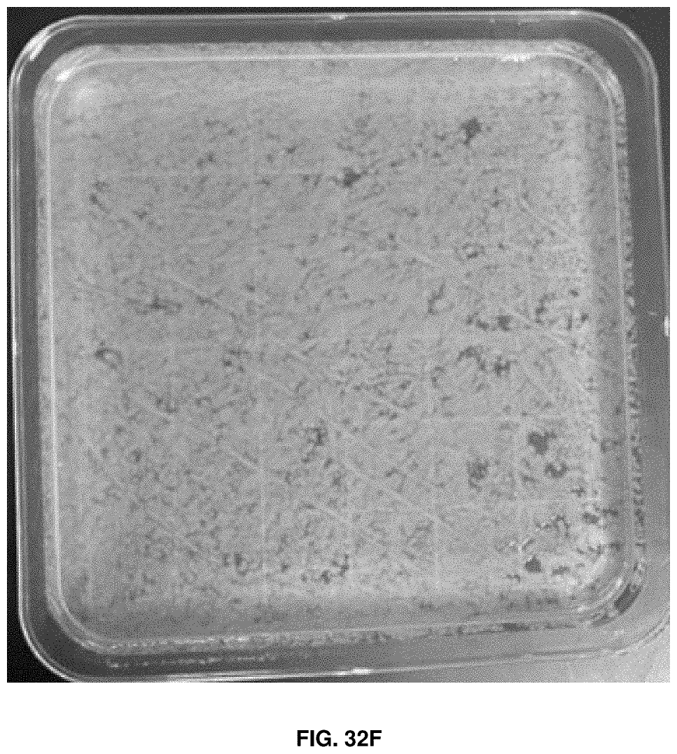

These plates were checked at 24-hour growth (FIGS. 32A-32C) and 48-hour growth (FIGS. 32D-32F). As seen in FIGS. 32A-32F, there was significant growth of bacteria. This shows that the swabbing method collects any bacteria that may be present on the area swabbed.

Third Airflow Experiment—Biosafety Cabinet

A bacterial culture of DH5α/pET201 E. coli was prepared using 25 mL of refrigerated culture to 75 mL SB50K media mix and set in a stirring water bath to incubate for approximately 3.5 hours before being used for plating. This was the same strain used in previous experiments that had resistance to the common antibiotic kanamycin. All parts and techniques in the third airflow experiment were the same as in the second airflow experiment unless noted otherwise below.

The duration for spraying with the airbrush was increased to two seconds from one second. This allowed more bacteria to enter the intake. In addition, the intake was divided into two sections, the outermost part of the intake cone and the innermost part of the intake. The innermost part of the intake was roughly 3-4 inches in where the pipe decreased to its 2-inch diameter. This was used to determine where the bacteria were contacting the intake. Finally, in this experiment, more M9 (1:4) precursor mix (FIG. 33B) was used on 3-inch diameter filters. In particular, 1140 μL of the M9 (1:4) precursor mix was used on to each of the 3-inch diameter discs, which were cut out of the 0.75 oz fiberglass material. Both samples were baked at 500° C. for 15 minutes in order to produce activated filters ready for use in the airflow setup. FIG. 33C shows a single layer sample of a silver-infiltrated fiberglass filter. The swab technique included the flocked swab with sterile water. Filter plate samples were collected using the contact stamping technique noted earlier in the second airflow experiment. FIG. 33A shows the HVAC simulation system used in the third airflow experiment. Various locations throughout the system were checked to determine if the bacteria were present in any of the locations.

Table 10 details these locations.

TABLE 10
Third airflow experiment plates

| # | Plate Location | Notes |
|---|---|---|
| 1A | Outer intake pipe, | Swabbed 1 revolution on the outermost |
| | circumference | part of intake |
| 1B | Inner intake pipe, | Swabbed 2 revolutions 3-4 inches into the |
| | circumference | intake before the filter (same location as |
| | | plate #1 on previous airflow experiments) |
| 2 | Filter, intake side | Physically stamped on to plate |
| 3 | Filter, output side | Physically stamped on to plate |
| 4 | Pipe past filter, circumference | Swabbed 2 revolutions |
| 5 | Vacuum inner wall | Rolled swab gently 5-10 seconds |
| 6 | Plate inside vacuum with filter | SB50K plate open during test |
| | during test | |
| 7 | Vacuum output, circumference | Swabbed 2 revolutions |
| 8C | Blank control | No bacteria |
| 9C | Airbrush spray | 1 second of bacteria aerosol |
| 10C | Regular plate | 100 μL culture, bead distributed |
| 11C | Air control without filter | SB plate, 90 seconds exposure |
| 12C | Air control with filter | SB plate, 90 seconds exposure |
| | during test | |
| 13C | Sterile swab liquid | 100 μL sterile bacterial transfer solution, |
| | | bead distributed |
| 14C | Regular plate inside | 100 μL culture, bead distributed |
| | vacuum with filter during test | |

At the conclusion of airflow testing, resistance measurements of the 3-inch diameter silver filters used in all of the airflow experiments were captured. Each measurement was taken across the diameter of the silver filter. These measurements are listed below in Table 11.

TABLE 11
Diameter resistance measurements of 3-inch silver filters

| Experiment, | | Perpendicular | |
|---|---|---|---|
| Filter | Measurement | Measurement | Notes |
| 1, A | 15 Ω | Not taken | Infiltrated with 630 μL M9 |
| | | | (1:4) mix precursor |
| 1, B | 9 Ω | Not taken | Infiltrated with 630 μL M9 |
| | | | (1:4) mix precursor |
| 2, A | 30 Ω | Not taken | Infiltrated with 630 μL M9 |
| | | | (1:4) mix precursor |
| 2, B | N/A | N/A | Infiltrated with 630 μL M9 (1:4) mix |
| | | | precursor, unable to get good contact |
| | | | for resistance measurement |
| 3, A | 14 Ω | 7 Ω | Infiltrated with 1140 μL M9 |
| | | | (1:4) mix precursor |
| 3, B | 16 Ω | 5 Ω | Infiltrated with 1140 μL M9 |
| | | | (1:4) mix precursor |

During this test, the bacteria was sprayed for roughly 2-3 seconds. The intake area was also swabbed on the outer most and inner most areas of the cone shape that led into the system. This could be used to determine if the bacteria were getting to the intake area.

In addition, the filters were also tested to determine if the filters could be conductive for possible electrostatic properties purposes. The fiberglass itself is an insulator. However, when the filters were measured for conductance, they ranged from 9Ω to 30Ω. Therefore, the silver present in the foam allows them to be conductive. Each of the 3-inch disc filters had approximately 0.1 g of silver. So, the measured conductive values help show how uniformly the precursor/foam was coated over each 3-inch disc filter.

Advantageously, the mixes, foams, and filters described herein can capture and deactivate microorganisms. In addition, silver was found to be effective, even in lower amounts, increasing the cost-effective factor for use in a filter. It should be further appreciated that the aforementioned mixes, foams, and filters may be applicable to other filtration applications, such as liquid filtration. Non-limiting examples can include filters for food, drink, and septic systems.

Certain embodiments of the compositions, devices, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A filter comprising:
an antimicrobial metallic foam on a substrate, wherein the antimicrobial metallic foam is capable of deactivating microorganisms.

2. The filter of claim 1, wherein the antimicrobial metallic foam comprises silver.

3. The filter of claim 1, wherein antimicrobial metallic foam includes a metal selected from the group consisting of copper, silver, and a combination thereof.

4. The filter of claim 1, wherein the antimicrobial metallic foam includes a metal selected from the group consisting of cadmium, cobalt, iron, manganese, platinum, titanium, aluminum, antimony, arsenic, barium, bismuth, boron, copper, gold, lead, mercury, nickel, silver, thallium, tin, zinc, and combinations thereof.

5. The filter of claim 1, wherein the antimicrobial metallic foam includes a metal alloy.

6. The filter of claim 5, wherein the metal alloy is selected from the group consisting of brass, bronze, and a combination thereof.

7. The filter of claim 1, wherein the antimicrobial metallic foam includes a metal oxide.

8. The filter of claim 7, wherein the metal oxide comprises a copper oxide or a silver oxide.

9. The filter of claim 1, wherein the substrate is a fluid permeable substrate.

10. The filter of claim 1, wherein the substrate comprises fiberglass.

11. The filter of claim 1, wherein the substrate comprises a fabric.

12. The filter of claim 1, wherein the substrate comprises activated carbon.

13. The filter of claim 1, wherein the substrate is coated or infiltrated with the antimicrobial metallic foam.

14. The filter of claim 1, wherein the filter is an air filter configured for use in an air filtration system.

15. The filter of claim 1, wherein the filter is a cassette configured for use in personal protection equipment.

16. The filter of claim 1, wherein the filter is a layer in a multilayer cassette filter.

17. The filter of claim 1, wherein the filter is in a facemask.

18. A method of preparing an antimicrobial filter, the method comprising:
applying a metallic precursor to a fluid permeable substrate to produce a coated or infiltrated substrate; and
heating the coated or infiltrated substrate to transform the metallic precursor into an antimicrobial metallic foam, thereby forming an antimicrobial filter.

19. The method of claim 18, wherein the metallic precursor comprises silver nitrate or copper nitrate.

20. A facemask comprising a cassette filter with an antimicrobial metallic foam, wherein the cassette filter comprises:
an activated carbon layer configured to filter volatile organic compounds and having a coating of the antimicrobial metallic foam thereon; and
a plurality of other layers.
